(19) United States
(12) Patent Application Publication
(10) Pub. No.: US 2026/0156243 A1
(43) Pub. Date: Jun. 4, 2026

(54) ENCODING METHOD, DECODING METHOD, CODE STREAM, ENCODER, DECODER, AND STORAGE MEDIUM

(71) Applicant: GUANGDONG OPPO MOBILE TELECOMMUNICATIONS CORP., LTD., Dongguan (CN)

(72) Inventors: Junyan HUO, Dongguan (CN); Yanzhuo MA, Dongguan (CN); Fuzheng YANG, Dongguan (CN); Hongqing DU, Dongguan (CN); Ming LI, Dongguan (CN)

(73) Assignee: GUANGDONG OPPO MOBILE TELECOMMUNICATIONS CORP., LTD., Dongguan (CN)

(21) Appl. No.: 19/258,347

(22) Filed: Jul. 2, 2025

Related U.S. Application Data
(63) Continuation of application No. PCT/CN2023/070562, filed on Jan. 4, 2023.

(51) Int. Cl. H04N 19/105; H04N 19/176

(52) U.S. Cl. CPC H04N 19/105; H04N 19/176

(57) ABSTRACT

Disclosed in embodiments of the present application are an encoding method, a decoding method, a code stream, an encoder, a decoder, and a storage medium. The decoding method comprises: an encoder determines a first template corresponding to a current block; determines, according to the first template, one or more block vectors corresponding to the current block; determines one or more reference blocks of the current block according to the one or more block vectors, and determines a predicted value of the current block according to the one or more reference blocks; and determines a reconstruction value of the current block according to the predicted value of the current block.

### CROSS-REFERENCE TO RELATED APPLICATIONS

This application is a continuation of International Application No. PCT/CN2023/070562, filed on Jan. 4, 2023, the disclosure of which is hereby incorporated by reference in its entirety.

### TECHNICAL FIELD

Embodiments of this application relate to the field of video coding technologies, and in particular to a coding method, a bitstream, an encoder, a decoder, and a storage medium.

### BACKGROUND

According to an Intra Template Matching Prediction (Intra TMP) technology, a matching template with the smallest cost is searched for in a predefined search range of a current picture for a template of an encoding block, according to a preset cost function, and an optimal matching reconstructed block corresponding to the matching template is used as a predicted block of a current encoding block.

In an actual encoding process, a reconstructed sample of the optimal matching reconstructed block is directly used as a predicted sample of the current encoding block in the related technology. A large deviation may be caused in some scenarios, resulting in low prediction accuracy.

### SUMMARY

Embodiments of this application provide a coding method, a bitstream, an encoder, a decoder, and a storage medium, so as to improve prediction accuracy and obtain an optimal prediction effect.

Technical solutions of embodiments of this application may be implemented as follows.

According to a first aspect, an embodiment of this application provides a decoding method, applied to a decoder. The method includes:
determining a first template corresponding to current block;
determining, according to the first template, one or more block vectors corresponding to the current block;
determining one or more reference blocks of the current block according to the one or more block vectors, and determining predicted values of the current block according to the one or more reference blocks; and
determining a reconstructed value of the current block according to the predicted value of the current block.

According to a second aspect, an embodiment of this application provides an encoding method, applied to an encoder. The method includes:
determining a first template corresponding to a current block;
determining, according to the first template, one or more block vectors corresponding to the current block; and
determining one or more reference blocks of the current block according to the one or more block vectors, and determining predicted values of the current block according to the one or more reference blocks.

According to a third aspect, an embodiment of this application provides a bitstream, where the bitstream is generated by performing bit encoding on to-be-encoded information, and the to-be-encoded information at least includes at least one of: a prediction difference of a current block, a preset quantity N, or one or more block vectors.

According to a fourth aspect, an embodiment of this application provides an encoder. The encoder includes a first determining unit, where
the first determining unit is configured to: determine a first template corresponding to a current block; determine, according to the first template, one or more block vectors corresponding to the current block; determine one or more reference blocks of the current block according to the one or more block vectors, and determine predicted values of the current block according to the one or more reference blocks.

According to a fifth aspect, an embodiment of this application provides an encoder. The encoder includes a first memory and a first processor, where
the first memory is configured to store a computer program runnable on the first processor; and
the first processor is configured to run the computer program to execute the method according to the second aspect.

According to a sixth aspect, an embodiment of this application provides a decoder. The decoder includes a second determining unit, where
the second determining unit is configured to determine a first template corresponding to a current block; determine, according to the first template, one or more block vectors corresponding to the current block; determine one or more reference blocks of the current block according to the one or more block vectors, and determine predicted values of the current block according to the one or more reference blocks; and determine a reconstructed value of the current block according to the predicted value of the current block.

According to a seventh aspect, an embodiment of this application provides a decoder. The decoder includes a second memory and a second processor, where
the second memory is configured to store a computer program that is runnable on the second processor; and
the second processor is configured to execute the method according to the first aspect when running the computer program.

According to an eighth aspect, an embodiment of this application provides a computer-readable storage medium storing a computer program. The computer program is executed to implement the method according to the first aspect, or the method according to the second aspect.

Embodiments of this application provides a coding method, an encoder, a decoder, and a storage medium. The encoder determines a first template corresponding to a current block; determines, according to the first template, one or more block vectors corresponding to the current block; determines one or more reference blocks of the current block according to the one or more block vectors, and determines predicted values of the current block according to the one or more reference blocks; and determines a reconstructed value of the current block according to the predicted value of the current block. The decoder determines a first template corresponding to the current block; determines, according to the first template, one or more block vectors corresponding to the current block; determines one or more reference blocks of the current block according to the one or more block vectors, and determines predicted values of the current block according to the one or more reference blocks. It can be learned that, in embodiments of this application, an Intra TMP Fusion prediction manner is proposed. In which, at least one block vector of the current block may be determined, and the predicted value of the current block may be obtained by using at least one reference block corresponding to the at least one block vector.

### BRIEF DESCRIPTION OF DRAWINGS

FIG. 1 is a schematic diagram of Intra TMP prediction;

FIG. 2 is a schematic diagram of a prediction procedure based on an IntraTMP technology;

FIG. 3 is a schematic diagram of a template type of an Intra TMP technology;

FIG. 4 is a schematic diagram of a search procedure based on an IntraTMP technology;

FIG. 5 is a schematic diagram of parameter definition of a current block and a template and the current block;

FIG. 6 is a schematic diagram of a template search area;

FIG. 7 is a schematic diagram of different sub-area division in a search area;

FIG. 8 is a first schematic diagram of a process of determining a search area;

FIG. 9 is a schematic diagram of a search process;

FIG. 10A is a schematic diagram of a structure of an encoder;

FIG. 10B is a schematic diagram of a structure of an encoder;

FIG. 11 is a schematic diagram of a network architecture of a decoding system;

FIG. 12 is a schematic flowchart of a decoding method according to an embodiment of this application;

FIG. 13 is a second schematic diagram of a process of determining a search area;

FIG. 14 is a third schematic diagram of a process of determining a search area;

FIG. 15 is a schematic flowchart of an encoding method according to an embodiment of this application;

FIG. 16 is a schematic diagram of a structure of an encoder;

FIG. 17 is a schematic diagram of a hardware structure of an encoder;

FIG. 18 is a schematic diagram of a structure of a decoder;

FIG. 19 is a schematic diagram of a hardware structure of a decoder; and

FIG. 20 is a schematic diagram of a structure of a coding system.

### DESCRIPTION OF EMBODIMENTS

To understand features and technical content of embodiments of this application in more detail, the following describes implementation of embodiments of this application in detail with reference to the accompanying drawings. The accompanying drawings are merely used for description, and are not intended to limit embodiments of this application.

Unless otherwise defined, all technical and scientific terms used in this specification have the same meaning as commonly understood by those skilled in the technical field of this application. The terms used herein are merely for the purpose of describing embodiments of this application, but are not intended to limit this application.

In the following description, the term “some embodiments” describe a subset of all possible embodiments, and it should be understood that “some embodiments” may be the same subset or different subsets of all possible embodiments, and may be combined with each other in the case of no conflicts. It should also be noted that the term “first/second/third” used in embodiments of this application is merely used to distinguish between similar objects and does not represent a specific order of objects. It may be understood that “first/second/third” may be interchanged in a specific order or sequence if allowed, so that the embodiments of this application described herein may be implemented in a sequence other than the sequence illustrated or described herein.

The nouns and terms used in embodiments of this application are described before providing detailed description of embodiments of this application. The nouns and terms used in embodiments of this application are applicable to the following explanations:
coding block (CB);
block matching (BM);
coding unit (CU);
block vector (BV);
sum of absolute difference (SAD);
sum of absolute transformed difference (SATD);
mean square error (MSE);
Sum of Squared Differences (SSD);
Mean absolute deviation (MAD);
mean square differences (MSD);
Normalized correlation coefficient (NCC);
H.266/versatile video coding (VVC);
VVC reference software test platform (VVC Test Model, VTM);
Intra Template Matching Prediction (Intra TMP);
reference software test platform Beyond VVC (Enhanced Compression Model, ECM).

It should be noted that, in a video picture, a first color component, a second color component, and a third color component are generally used to represent a coding block. The three color components are respectively one luma component, one blue chroma component, and one red chroma component. Specifically, the luma component is generally represented by a symbol Y, the blue chroma component is generally represented by a symbol Cb or U, and the red chroma component is generally represented by a symbol Cr or V. In this way, the video picture may be represented in a YCbCr format, or may be represented in a YUV format.

It may be understood that Intra TMP is a special intra prediction mode. In the Intra TMP, both an encoder and a decoder search a predefined search range of a current picture for a matching template (T_BEST) with the smallest cost according to a preset cost function, for a template (T) of a coding block. An offset of the best matching template relative to the current coding block template is the best block vector (BV_BEST), and then a reconstructed block (Ref Block) corresponding to the matching template is used as a prediction block of the current coding block (Cur Block). The template of the coding block usually uses an adjacent reconstructed area of the current coding block.

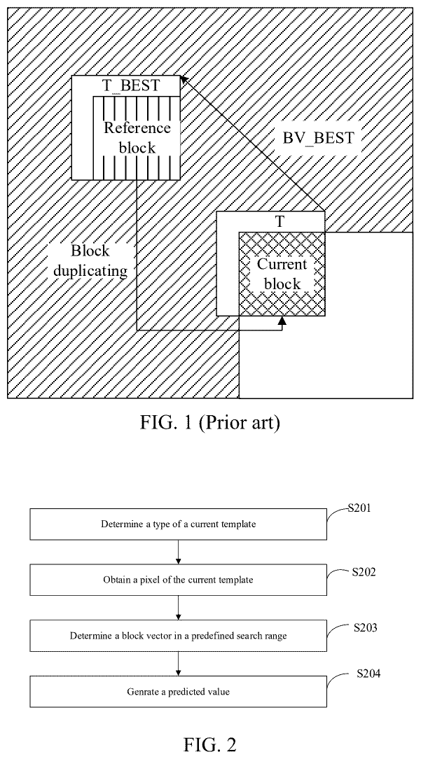

For example, an adjacent reconstructed area of the current block is used as an example. FIG. 1 is a schematic diagram of Intra TMP prediction. As shown in FIG. 1, a dark-filled area represents a reconstructed area, a grid-filled block represents the current block, and an adjacent area of the current block is a first template (T). A block filled with oblique lines is a reference block, and an adjacent area of the reference block is a second template (that is, a best matching template, T_BEST). An offset of the second template relative to the first template is the best block vector (BV_BEST). In this case, the reference block may be copied as a predicted block of the current block.

In embodiments of this application, the preset cost function may be SAD, SATD, MSE, SSD, MAD, MSD, NCC, or the like, which is not limited herein.

For example, sum of absolute difference SAD is used as an example. In this case, the cost function is shown as follows:

$$SAD ( {T}_{i} ) = {\sum }_{m = 0}^{M - 1} \vert {T}_{i , m} - {T}_{m} \vert , m = 0 , 1 , … , M - 1 \qquad ( 1 )$$

In which, Tᵢ represents a template in a search process, and M represents a quantity of samples in the template.

The following describes in detail a prediction process of the Intra TMP technology in the related technologies.

Input of IntraTMP: a location of the current block (xTbCmp, yTbCmp), a width nTbW of the current block, a height nTbH of the current block.

Output of IntraTMP: a predicted value of the current block predSamples[x][y], where x=0, . . . , nTbW−1, y=0, . . . , nTbH−1.

Specifically, the prediction process of the IntraTMP technology may include four steps: determining a current template type, obtaining a current template reconstructed sample, determining a block vector within a predefined search range, and generating a predicted value. The predicted value of the current block may be obtained by performing the foregoing process. It should be noted that the Intra TMP technology may be used to predict the luma component, or may be used to predict the chroma component, which is not limited herein.

FIG. 2 shows a schematic diagram of a prediction procedure based on an IntraTMP technology. As shown in FIG. 2, the procedure may include the following steps 201 to 204.

In step S201, a current template type is determined.

It should be noted that, according to the Intra TMP technology, a matching template is searched for in a predefined search area by using an adjacent reconstructed sample of the current block as a template. The adjacent reconstructed sample may be an upper reference sample, an upper left reference sample, an upper right reference sample, a left reference sample, a lower left reference sample, or the like of the current block. Therefore, the template may be classified and a corresponding template type may be determined according to whether the adjacent reconstructed sample is available.

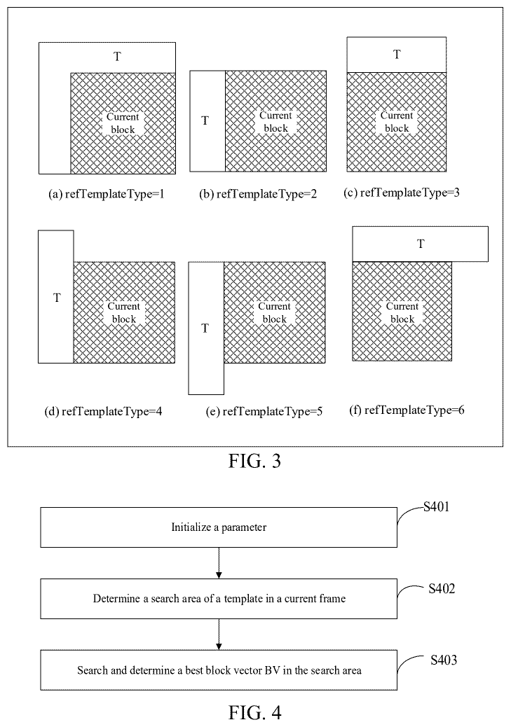

It should be further noted that refTemplateType may be used to represent the template type. FIG. 3 shows a schematic diagram of the template type of the Intra TMP technology. As shown in FIG. 3, a grid-filled block represents a current block, and an adjacent area of the current block is a template T. Six template types are shown herein.

Schematically, the six template types are as follows.

When a left upper reference sample, an upper reference sample, and a left reference sample are all available, a value of refTemplateType is 1, and a template shape is shown by (a) in FIG. 3.

When only the left reference sample is available, the value of refTemplateType is 2, and the template shape is shown by (b) in FIG. 3.

When only the upper reference sample is available, the value of refTemplateType is 3, and the template shape is shown by (c) in FIG. 3.

When only the left reference sample and the upper left reference sample are available, the value of refTemplateType is 4, and the template shape is shown by (d) in FIG. 3.

When only the left reference samples and the lower left reference samples are available, the value of refTemplateType is 5, and the template shape is shown by (e) in FIG. 3;

When only the upper reference sample and the upper right reference sample are available, the value of refTemplateType is 6, and the template shape is shown by (f) in FIG. 3.

In step S202, a current template sample is obtained.

It should be noted that the template of the Intra TMP technology may include reconstructed samples of one or more areas located at an upper side, an upper right side, a left side, a lower left side, and an upper left side of the current block. In addition, the template size may be preset. For example, when the template on the left side is obtained, the template width templateW_size may be set to 4. When the template on the upper side is acquired, the template height templateH_size may be set to 4.

It should be further noted that which reconstructed samples may be obtained according to the value of refTemplateType. For example, when the value of refTemplateType is 1, reconstructed samples on the left side, the upper left side, and the upper side of the current block are obtained. When the value of refTemplateType is 2, only four columns of reconstructed samples on the left side of the current block are obtained. Alternatively, when the value of refTemplateType is 3, only four rows of reconstructed samples on the upper side of the current block are obtained.

In step S203, a block vector is determined within a predefined search range.

It should be noted that a search process of the Intra TMP technology mainly includes an initialization process, determining a search area of a template in a current frame, and searching and determining the beset block vector in the search area.

It should be further noted that the best matching template may be searched for in the search area by using the following searching strategies: a search policy of performing coarse searching first and then performing fine searching, or a search strategy of performing only fine searching, or a search strategy of performing only coarse searching, which is not limited herein.

In this embodiment of this application, the coarse searching herein may include: determining the best coarse matching template in the search area by using a first preset step size (for example, 2), or determining the best coarse matching template in the search area by using a template that is downsampled (for example, a downsampled factor is 2).

In embodiments of this application, the fine searching herein may include: determining the best fine matching template in the search area by using a second preset step size (for example, 1), or determining the best fine matching template near the best coarse matching template after the coarse searching is completed.

FIG. 4 shows a schematic diagram of a search procedure based on the IntraTMP technology according to an embodiment of this application. As shown in FIG. 4, the procedure may include the following steps S401 to S403.

In S401, parameters are initialized.

It should be noted that uiPatchWidth is initialized into nTbW+templateW_size, and uiPatchHeight is initialized into nTbH+templateH_size. In which, templateW_size and templateH_size may be fixed constants, or may be dynamically adjusted according to a size of the current block. In addition, templateW_size and templateH_size may be equal or not. For example, templateW_size=4, templateH_size=4; Alternatively, when a width of the current block is greater than 8, templateW_size is set to 4; when the width of the current block is less than or equal to 8, templateW_size is set to 2; when the height of the current block is greater than 8, templateH_size is set to 4; and when the height of the current block is less than or equal to 8, templateH_size is set to 2.

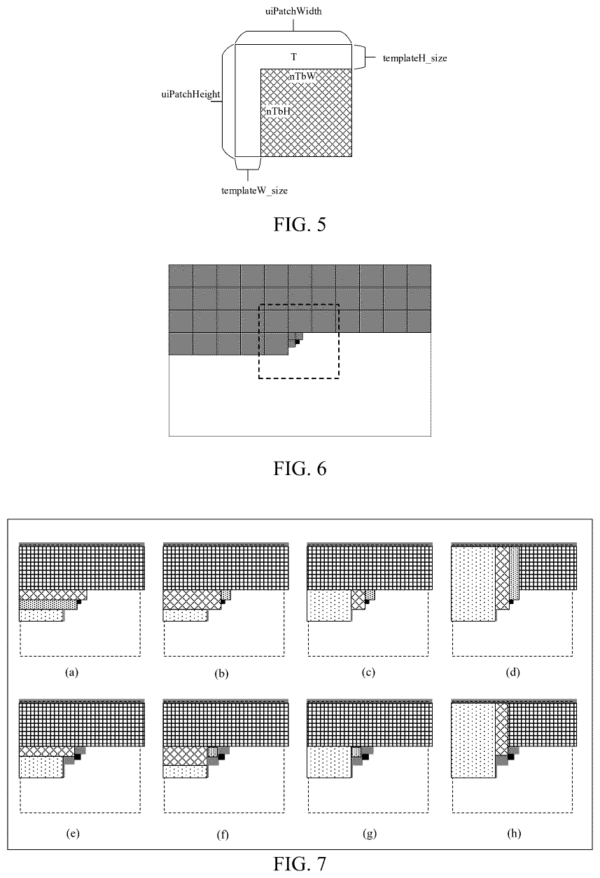

FIG. 5 shows a schematic diagram of parameter definition of a current block and a template of the current block. As shown in FIG. 5, specific meanings of parameters are as follows: nTbW and nTbH represent sizes of the current block, templateW_size and templateH_size represent template sizes, and uiPatchWidth and uiPatchHeight represent sizes of a block that includes the current block and a template of the current block.

Further, a cost threshold between initialization templates is represented by diffThreshold. For example, when the cost function is SAD, the threshold may be diffThreshold=((1<<bitDepth)>>2)×(uiPatchHeight×uiPatchWidth−nTbH×nTbW). When a picture bit depth bitDepth is 10, diffThreshold indicates that a maximum distortion of each sample in the template area is 256.

Further, a location ctbRsX, ctbRsY of a coding tree block CTB, where the current block CB is located, is initialized.

Further, a location offset of the current block CB within a current CTB is initialized:

$$offsetLCBY = yTbCmp - ctbRsY , offsetLCBX = xTbCmp - ctbRsX .$$

Further, iTemplateSizeH is initialized into templateH_size and iTemplateSizeW is initialized into templateW_size.

Further, iBvShift is initialized, and iBvShift represents block vector BV accuracy. For example, the accuracy of the BV may be integer sample precision, and in this case, iBvShift is 0. The BV accuracy may also be sub-sample accuracy. For example, when iBvShift is 1, it indicates ½ sample accuracy; and when iBvShift is 2, it indicates ¼ sample accuracy. This is not limited herein.

Further, a preset search range of the template is initialized, and the preset search range of the template may be set to a fixed size, or the search range may be dynamically adjusted according to a coding block size. For example, searchRangeWidth=TMP_SEARCH_RANGE_MULT_FACTOR×nTbW, searchRangeHeight=TMP_SEARCH_RANGE_MULT_FACTOR×nTbH. A value of TMP_SEARCH_RANGE_MULT_FACTOR may be a preset value, for example, is set to 5.

In step S402, a search area of a template in a current frame is determined.

It should be noted that a search area of the Intra TMP technology is a reconstructed part of the current picture, and is limited by a size of a search range. FIG. 6 is a schematic diagram of a template search area. As shown in FIG. 6, a background area filled with a dark color is a reconstructed area, a background block filled with black is the current block, and a dashed line box is a search range window. Therefore, the search area of the IntraTMP technology is not greater than an overlapping part of the reconstructed area represented by the dark color and the region represented by the dashed line box.

It can be learned that the search area of the current block template may be a reconstructed part of a CTB in which the current block is located, or may be another reconstructed CTB area. The search area herein is actually a set of all search points. The search area cannot be represented by a single rectangular region generally. In specific implementation, a search may be performed in multiple rectangular regions, and the best matching block and the best block vector are obtained according to search results of different regions.

For example, FIG. 7 shows a schematic diagram of different sub-area division of a search area. As shown in FIG. 7, eight different sub-area division manners are shown herein. A background block filled with black is the current block; in (a), (b), (c), (d), and (f), the search area is divided into four sub-search areas; and in (e), (g), and (h), the search area is divided into three sub-search areas. Herein, different patterns represent different sub-search areas.

In FIG. 7, for (a), (b), (c), and (d), all available search ranges are considered; and for (e), (f), (g), and (h), no search is performed in upper area and the left area of the current block.

For example, it is assumed that different sub-search areas are represented by using a regionId. Since a template sample of the current block needs to be obtained from a picture reconstructed area and a reconstructed block sample corresponding to the template also needs to be obtained from the reconstructed area, locations that can be found in the sub-search areas represented by different regionIds are determined according to a location (xTbCmp, yTbCmp) of the current block, a size (nTbW, nTbH) of the current block, a size (picWidth, picHeight) of the current picture, a size (CtbSizeW, CtbSizeH) of a CTB in which the current block is located, a preset search range (search RangeWidth, searchRangeHeight) of the template, and a location offset (offsetLCBY, offsetLCBX) of the current block in the current CTB, thereby determining a block vector BV. Specifically, iVerMin and iVerMax are respectively used to represent a minimum absolute coordinate and a maximum absolute coordinate than can be found in a vertical direction, and iHorMin and iHorMax are respectively used to represent a minimum absolute coordinate and a maximum absolute coordinate that can be found in a horizontal direction. Values of iVerMin, iVerMax, iHorMin, and iHorMax are different in search areas represented by different regionIds.

As shown by (f) in FIG. 7 for example, the search area is divided into four sub-search areas. An implementation manner of the sub-search area is as follows.

When regionId is equal to 0, iVerMin, iVerMax, iHorMin, and iHorMax may be calculated as follows:

$${iHorMax}_{0} = min ( xTbCmp + searchRangeWidth ) ≪ iBvShift , ( picWidth - nTbW ) ≪ iBvShift ) ;$$

$${iHorMin}_{0} = max ( ( iTemplateSizeW ) ≪ iBvShift , ( xTbCmp - searchRangeWidth ) ≪ iBvShift ) ;$$

$${iVerMax}_{0} = ( yTbCmp - nTbH - offsetLCBY ) ≪ iBvShift ;$$

$${iVerMin}_{0} = max ( ( ( iTemplateSizeH ) ≪ iBvShift ) , ( ( yTbCmp - searchRangeHeight ) ≪ iBvShift ) ) .$$

When regionID is equal to 1, iVerMin, iVerMax, iHorMin, and iHorMax may be

$${iHorMin}_{1} = max ( ( iTemplateSizeW ) ≪ iBvShift , ( xTbCmp - searchRangeWidth ) ≪ iBvShift ) ;$$

$${iHorMax}_{1} = ( xTbCmp - offsetLCBX - nTbW ) ≪ iBvShift ;$$

$${iVerMin}_{1} = ( yTbCmp + 1 ) ≪ iBvShift ;$$

$${iVerMax}_{1} = min ( picHeight - nTbH , ( yTbCmp - offsetLCBY + CtbSizeH - nTbH ) ≪ iBvShift ) .$$

When regionId is equal to 2, iVerMin, iVerMax, iHorMin, an iHorMax may be calculated as follows:

$${iHorMax}_{2} = ( xTbCmp - offsetLCBX - nTbW ) ≪ iBvShift ;$$

$${iHorMin}_{2} = max ( ( iTemplateSizeW ) ≪ iBvShift , ( xTbCmp - searchRangeWidth ) ≪ iBvShift ) ;$$

$${iVerMin}_{2} = max ( ( iTemplateSizeH ) ≪ iBvShift , ( yTbCmp - nTbH - offsetLCBY ) ≪ iBvShift ) ;$$

$${iVerMax}_{2} = ( yTbCmp ) ≪ iBvShift .$$

When regionId is equal to 3, iVerMin, iVerMax, iHorMin, and iHorMax may be calculated as follows:

$${iHorMin}_{3} = max ( ( iTemplateSizeW ) ≪ iBvShift , ( xTbCmp - offsetLCBX - nTbW + 1 ) ≪ iBvShift ) ;$$

$${iHorMax}_{3} = ( xTbCmp - nTbW ) ≪ iBvShift ;$$

$${iVerMin}_{3} = max ( ( ( iTemplateSizeH ) ≪ iBvShift ) , ( yTbCmp - offsetLCBY - nTbH + 1 ) ≪ iBvShift ) ;$$

$${iVerMax}_{3} = ( yTbCmp - nTbH ) ≪ iBvShift .$$

In actual application, iHorMinre_{gionId}, iHorMax_{regionId}, iVerMin_{regionId}, and iVerMax_{regionId} herein respectively represent left edges, right edges, upper edges, and lower edges of different sub-search areas.

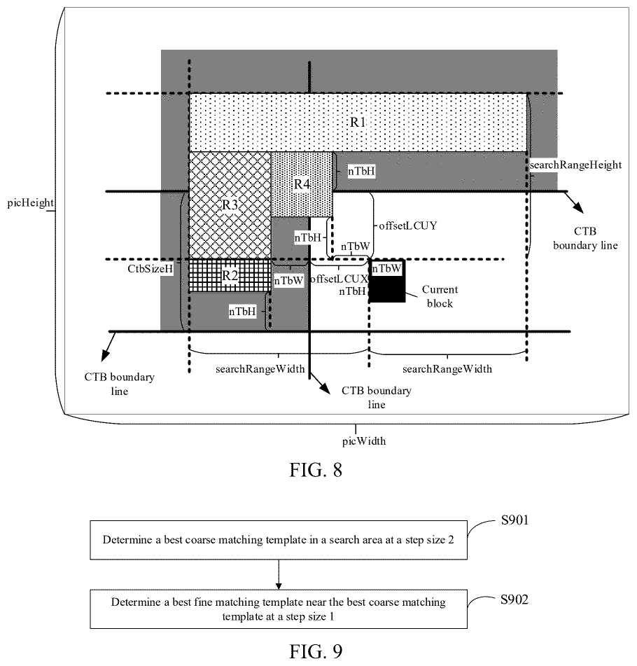

To intuitively describe different sub-search areas corresponding to different regionIds, FIG. 8 shows a schematic diagram of a process for determining a search area. As shown by FIG. 8, R1, R2, R3, and R4 represent four different sub-search areas. It should be noted that FIG. 8 shows a sample range in which upper left corner samples of the block may be aligned.

In step S403, searching is performed in the search area to determine the best block vector BV.

It should be noted that bvXMins and bvXMaxs respectively represent a minimum offset and a maximum offset of the block vector in a horizontal direction, and bvYMins and bvYMaxs respectively represent a minimum offset and a maximum offset of the block vector in a vertical direction.

In which, bvXMins_{regionId}, bvXMaxs_{regionId}, bvYMins_{regionId}, and bvYMaxs_{regionId} may be calculated by using iVerMin_{regionId}, iVerMax_{regionId}, iHorMinre_{gionId}, and iHorMax_{regionId} determined in step S402:

$${bvXMins}_{regionId} = {iHorMin}_{regionId} - xTbCmp ;$$

$${bvXMaxs}_{regionId} = {iHorMax}_{regionId} - xTbCmp ;$$

$${bvYMins}_{regionId} = {iVerMin}_{regionId} - yTbCmp ;$$

$${bvYMaxs}_{regionId} = {iVerMax}_{regionId} - yTbCmp .$$

In which, bvXMins_{regionId}, bvXMaxs_{regionId}, bvYMins_{regionId}, and bvYMaxs_{regionId} determine a horizontal and vertical offset range of the search point relative to the current block, that is, a range of the block vector BV.

It should be further noted that, by traversing a searching point (iPosHor, iPoxVer) in each search area, each block vector BV (including a horizontal component and a vertical component: (PX, pY)) is determined, where pX=iPosHor−xTbCmp and pY=iPosVer−yTbCmp, pX is between bvXMins and bvXMaxs, and pY is between bvYMins and bvYMaxs. In this way, a matching reconstructed block of the current block may be found in the reconstructed area, and an adjacent reconstructed sample of the matching reconstructed block is a matching template (that is, the foregoing second template). Therefore, a matching cost value of the adjacent template of the current block and the adjacent template of the matching reconstructed block is calculated, which is denoted as pDiff.

Further, all search points in all search ranges (regionId=0, 1, 2, and 3) are traversed, to obtain a search point with a minimum matching cost value pDiff by comparison. For obtained serach point, a corresponding matching cost value is indicated by pDiff_BEST, a corresponding block vector BV is indicated by a best block vector BV_BEST (pX_BEST, pY_BEST), and a corresponding matching template is indicated by a best matching template T_BEST.

In a possible implementation, if the search policy is to perform only coarse search, specific implementation is as follows.

In each area, in a search range in which pX is between bvXMins_{regionId} and bvXMaxs_{regionId}, and pY is between bvYMins_{regionId} and bvYMaxs_{regionId}, and a coarse search is performed at a step size greater than 1. For example, a corse search is performed at a step size 2, a best matching cost value obtained by performing template matching is recorded as pDiff_BEST, and a corresponding block vector BV is indicated as a best block vector BV_BEST (pX_BEST, pY_BEST).

In another possible implementation, if the search policy is to perform only fine search, specific implementation is as follows.

In each area, in a search rang in which pX is between bvXMins_{regionId} and bvXMaxs_{regionId} and pY is between bvYMins_{regionId} and bvYMaxs_{regionId}, for example, a fine search is performed at a step size 1, a best matching cost value obtained by performing template matching is recorded as pDiff_BEST, and a corresponding block vector BV is indicated as a best block vector BV_BEST (pX_BEST, pY_BEST).

In still another possible implementation, if the search policy is to perform a coarse search first and then perform a fine search. FIG. 9 is a schematic diagram of a search process. As shown in FIG. 9. The search process includes steps S901 and S902:

In step S901, a best coarse matching template is determined in a search area by using a step size 2.

In step S902, a best fine matching template is determined near the best coarse matching template by using a step size 1.

It should be noted that, for step S901, in a coarse search stage:
in each area, in a search range in which pX is between bvXMins_{regionId} and bvXMaxs_{regionId}, and pY is between bvYMins_{regionId} and bvYMaxs_{regionId}, and a coarse search is performed at a step size greater than 1. For example, a corse search is performed at a step size 2, a best matching cost value obtained by performing template matching is recorded as pDiff1_BEST, and a corresponding block vector BV is indicated as a best block vector BV1_BEST (pX1_BEST, pY1_BEST). A search area in which the best matching search point is located is indicated by bestRegionalID.

It should be further noted that, for step S902, in a fine seach stage:
further search is performed near the best block vector BV1_BEST obtained by rough search. Specifically, a refined search range TmpRefineRange is first determined. The refined search range may have a fixed size, or may be related to a current block size, for example, may be set to min (nTbW, nTbH)/2. Then, a position of the optimal matching reconstructed block obtained by coarse search is calculated as a reference position of the fine search area: BestPosX=xTbCmp+pX1_BEST, BestPosY=yTbCmp+pY1_BEST.

First, calculated values of iVerMin_{bestRegionId}, iVerMax_{bestRegionId}, iHorMin_{bestRegionId}, and iHorMax_{bestRegionId} is obtained according to a value of bestRegionId, and then a new search range iVerMin_{refine}, iVerMax_{refine}, iHorMin_{refine}, and iHorMax_{refine} is obtained according to the optimal matching block location obtained by coarse search. An obtaining method is as follows:

$${iHorMin}_{refine} = max ( {iHorMin}_{bestRegionId} , BestPosX - TmpRefineRange ) ;$$

$${iHorMax}_{refine} = min ( {iHorMax}_{bestRegionId} , BestPosX + TmpRefineRange ) ;$$

$$i {VerMin}_{refine} = max ( i {VerMin}_{bestRegionId} , BestPosY - TmpRefineRange ) ;$$

$$i {VerMax}_{refine} = min ( i {VerMax}_{bestRegionId} , BestPosY + TmpRefineRange ) .$$

Then, an adjusted block vector BVbvXMins, bvXMaxs, bvYMins, and bvYMaxs may be calculated by using iVerMin_{refine}, iVerMax_{refine}, iHorMin_{refine}, and iHorMax_{refine}:

$$bvXMins = {iHorMin}_{refine} - xTbCmp ;$$

$$bvXMaxs = {iHorMax}_{refine} - xTbCmp ;$$

$$bvYMins = {iVerMin}_{refine} - yTbCmp ;$$

$$bvYMaxs = {iVerMax}_{refine} - yTbCmp .$$

In this way, the fine search is performed in a range in which pX is between bvXMins_{refine} and bvXMaxs_{refine} and pY is between bvYMins_{refine} and bvYMaxs_{refine}. For example, search is performed by using a step of 1. A beset matching cost obtained by template matching is recorded as pDiff_BEST, and a corresponding block vector BV is indicated as a best block vector BV_BEST (pX_BEST, pY_BEST).

After the foregoing operations are completed, the best block vector BV_BEST (pX_BEST, pY_BEST) can be obtained. In which, pX_BEST and pY_BEST respectively represent the horizontal offset and the vertical offset of the best matching template relative to the current block template, and pX_BEST and pY_BEST also respectively represent the horizontal offset and the vertical offset of the best matching reconstructed block relative to the current block.

In step S204, a predicted value is generated.

Here, the above process may be implemented by a simple translation and copying. A specific operation is as follows:

$$For x = 0 , … , nTbW - 1 , y = 0 , … , nTbH - 1 ; \qquad ( 2 )$$

$$predSamples [ x ] [ y ] = recSamples [ x + pX\_BEST ] [ y + pY\_BEST ] .$$

IN which, recSamples represents a reconstructed sample of a current frame.

Briefly, in a related technology, according to the Intra TMP technology, by using a template of the current block, a matching template with a smallest cost is searched for in a predefined search range of a current picture according to a preset cost function, and a best matching reconstructed block (Ref Block) corresponding to the matching template is used as a predicted block of the current block (Cur Block). The template of the current block generally uses adjacent reconstructed areas of the current block.

However, in an actual encode process, directly using the reconstructed sample of the best matching reconstructed block as the predicted sample of the current block in the related technology is not the optimal solution. If illumination intensities are different or sample noise distributions are different in different areas in the frame, a difference between the reproduced reconstructed block and an encoding block of the current area is very large, resulting in decrease in prediction accuracy. If the template matching cost function cannot actually reflect a difference between a current encoding block template and a matching template in a search process, the obtained matching template with the smallest cost is used as the best matching template, resulting in that a best candidate block finally obtained is not the best candidate block. Therefore, valid reference information is limited, resulting in reducing of the prediction accuracy.

In conclusion, in a common coding method, a prediction value may have a relatively large deviation, resulting in low prediction accuracy and failing to achieve an optimal prediction effect.

To resolve the foregoing problem, an embodiment of this application provides a coding method, an encoder, a decoder, and a storage medium. The encoder determines a first template corresponding to a current block; determines, according to the first template, one or more block vectors corresponding to the current block; determines one or more reference blocks of the current block according to the one or more block vectors, and determines predicted values of the current block according to the one or more reference blocks; and determines a reconstructed value of the current block according to the predicted value of the current block. The decoder determines a first template corresponding to the current block; determines, according to the first template, one or more block vectors corresponding to the current block; determines one or more reference blocks of the current block according to the one or more block vectors, and determines predicted values of the current block according to the one or more reference blocks. It can be learned that, in embodiments of this application, an Intra TMP Fusion prediction manner is proposed. In which, at least one block vector of the current block may be determined, and the predicted value of the current block may be obtained by using at least one reference block corresponding to the at least one block vector. Therefore, according to the coding method proposed in embodiments of this application, the current block is predicted according to different importance of reconstruction block information corresponding to different matching templates in a search process, so that prediction accuracy can be improved, thereby obtaining an optimal prediction effect.

The following describes the embodiments of this application in detail with reference to the accompanying drawings.

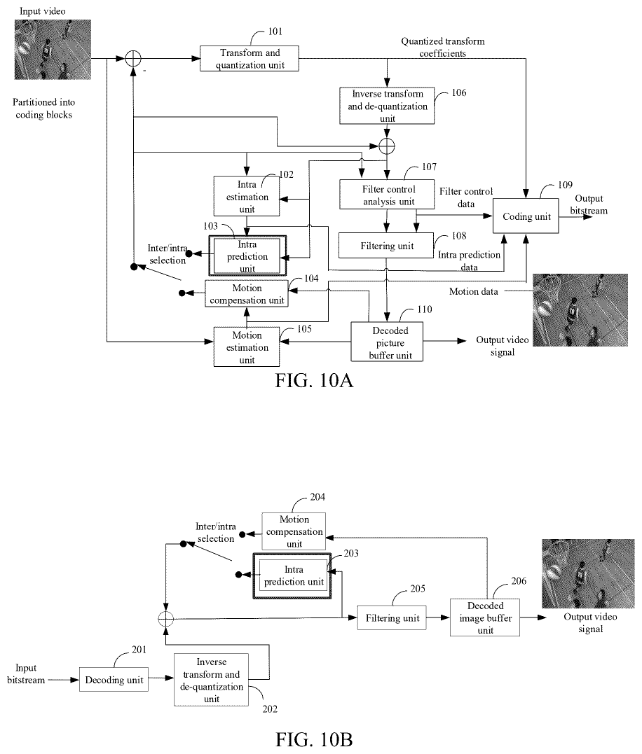

FIG. 10a shows a schematic diagram of a structure of an encoder according to an embodiment of this application. As shown in FIG. 10a, an encoder (specifically “video encoder”) 100 may include a transform and quantization unit 101, an intra estimation unit 102, an intra prediction unit 103, a motion compensation unit 104, a motion estimation unit 105, an inverse transform and dequantization unit 106, a filter control analysis unit 107, a filtering unit 108, an encoding unit 109, a decoded picture buffer unit 110, and the like. The filtering unit 108 may implement deblocking filtering and Sample Adaptive Offset (SAO) filtering, and the encoding unit 109 may implement header information encoding and context-based adaptive binary arithmetic coding (CABAC). An input original video signal is divided to obtain a video encoding block by using a coding tree unit (CTU), and residual sample information obtained after performing intra or inter prediction on the video coding block is transformed by using the transform and quantization unit 101, including transforming the residual information from a sample field to a transform field, and performing quantizing on the obtained transform coefficient, so as to further reduce a bit rate. The intra estimation unit 102 and the intra prediction unit 103 are configured to perform intra prediction on the video coding block. Specifically, the intra estimation unit 102 and the intra prediction unit 103 are configured to determine an intra prediction mode for encoding the video coding block. The motion compensation unit 104 and the motion estimation unit 105 are configured to perform inter prediction encoding on the received video encoding block relative to one or more blocks in one or more reference frames, to provide time prediction information. The motion estimation executed by the motion estimation unit 105 is a process of generating a motion vector, and the motion vector may estimate a motion of the video coding block. Then, the motion compensation unit 104 performs motion compensation based on the motion vector determined by the motion estimation unit 105. After determining the intra prediction mode, the intra prediction unit 103 is further configured to provide the selected intra prediction data to the encoding unit 109, and the motion estimation unit 105 transmits the calculated motion vector data to the encoding unit 109. In addition, the inverse transform and dequantization unit 106 is configured to reconstruct the video encoding block and reconstruct a residual block in a sample field. Blocking effect artifact is removed for the reconstructed residual block by the filter control analysis unit 107 and the filtering unit 108, and then the reconstructed residual block is added to a prediction block in a frame of the decoded picture buffer unit 110, to generate a reconstructed video coding block. The encoding unit 109 is configured to encode various encoding parameters and quantized transform coefficients. In a CABAC-based encoding algorithm, context content may be encoded based on an adjacent block, and may be encoded to indicate information of the determined intra prediction mode, to output a bitstream of the video signal. The decoded picture buffer unit 110 is configured to store the reconstructed video coding block for prediction reference. As encoding of the video picture proceeds, a new reconstructed video encoding block is continuously generated, and these reconstructed video coding blocks are stored in the decoded picture buffer unit 110.

FIG. 10b shows a schematic diagram of a structure of a decoder according to an embodiment of this application. As shown in FIG. 10b, a decoder (specifically “video decoder”) 200 includes a decoding unit 201, an inverse transform and dequantization unit 202, intra prediction unit 203, a motion compensation unit 204, a filtering unit 205, a decoded picture buffer unit 206, and the like. The decoding unit 201 may decode header information and CABAC, and the filtering unit 205 may implement deblocking filtering and SAO filtering. After the input video signal is processed by the encoding shown in FIG. 10a, a bitstream of the video signal is output. The bitstream is input to the decoder 200. The decode unit 201 decodes the bitstream to obtain a decoded transform coefficient. The transform coefficient is processed by the inverse transform and dequantization unit 202, so as to generate a residual block in the sample domain. The intra prediction unit 203 may be configured to generate prediction data of the current video decoding block based on the determined intra prediction mode and data of a previously decoded block from the current frame or picture. The motion compensation unit 204 is configured to determine prediction information for the video decoding block by parsing a motion vector and other associated syntax element, and generate a predictive block of the video decoding block being currently decoded by using the prediction information. The decoded video block is formed by adding the residual block from the inverse transformation and dequantization unit 202 and the corresponding predictive block generated by the intra prediction unit 203 or the motion compensation unit 204. Blocking effect artifact is removed for the decoded video signal through the filtering unit 205, thereby improving video quality. Then, the decoded video block is stored in the decoded picture buffer unit 206. The decoded picture buffer unit 206 is configured to store the reference picture for subsequent intra prediction or motion compensation, and is further configured to output the video signal. That is, a recovered original video signal is obtained.

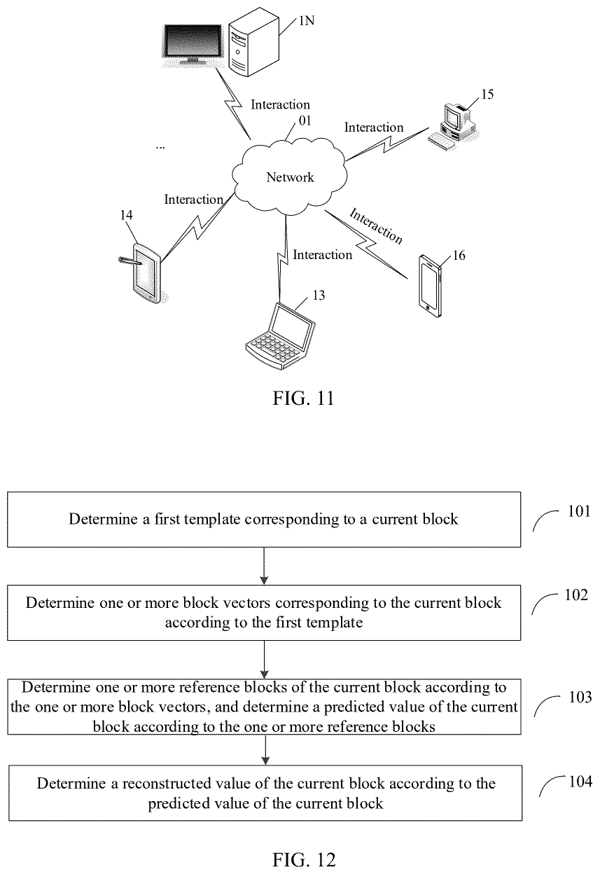

Further, an embodiment of this application further provides a network architecture of a coding system that includes an encoder and a decoder. FIG. 11 shows a schematic diagram of a network architecture of a coding system according to an embodiment of this application. As shown in FIG. 11, the network architecture includes one or more electronic devices 13 to 1N and a communications network 01, where the electronic devices 13 to 1N may perform video interaction by using the communications network 01. The electronic device may be implemented as various types of devices that have a video coding function. For example, the electronic device may include a smartphone, a tablet computer, a personal computer, a personal digital assistant, a navigator, a digital telephone, a video telephone, a television, a sensing device, a server and so on. This is not specifically limited in this embodiment of this application. Herein, the decoder or the encoder described in embodiments of this application may be the foregoing electronic device.

It should be noted that the method in embodiments of this application is mainly applied to the intra prediction unit 103 shown in FIG. 10a and the intra prediction unit 203 shown in FIG. 10b. That is, embodiments of this application may be applied to the encoder, may be applied to the decoder, or may even be applied to both the encoder and the decoder. Applications of embodiments of this application are not limited.

It should be further noted that when the embodiments are applied to the intra prediction unit 103, “the current block” specifically refers to an encoding block on which intra prediction is to be performed currently; and when the embodiments are applied to the intra prediction unit 203, “the current block” specifically refers to a decoding block on which intra prediction is to be performed currently.

An embodiment of this application provides a decoding method. The decoding method is applied to a decoder. FIG. 12 is a schematic flowchart of a decoding method according to an embodiment of this application. As shown in FIG. 12, the decoding method performed by the decoder may include the following steps S101 to S104.

In step 101, a first template corresponding to a current block is determined.

In embodiments of this application, the first template corresponding to the current block may be first determined. The process of determining the first template may include: determining a template type corresponding to the current block, and determining the first template corresponding to the current block according to the template type.

It should be noted that the decoding method in embodiments of this application is applied to the decoder. In addition, the decoding method may include an intra prediction method, and more specifically, a color component prediction method. The video picture may be divided into multiple decoding block, and each decoding block may include a first color component, a second color component, and a third color component. In embodiments of this application, the current block refers to a decoding block on which intra prediction is to be currently performed in the video picture.

Herein, when the first color component needs to be predicted, the to-be-predicted component is the first color component; when second color component needs to be predicted, the to-be-predicted component is second color component; and when the third color component needs to be predicted, the to-be-predicted component is the third color component. In addition, assuming that a first color component is precited for the current block, and the first color component is luma component, that is, the to-be-predicted component is luma component, the current block may also be referred to as a luma block. Alternatively, assuming that a second color component is predicted for the current block, and the second color component is chroma component, that is, the to-be-predicted component is chroma component, the current block may also be referred to as a chroma block.

It should be further noted that in embodiments of this application, the reference sample (Reference Sample) of the current block may be a reference sample adjacent to the current block. The term adjacent herein may refer to being adjacent spatially, but is not limited thereto. For example, the adjacent may be adjacent in a time domain, or adjacent in space and the time domain. The reference sample of the current block may be a reference sample obtained by performing some types of processing on the reference sample which is adjacent spatially, adjacent in the time domain, or adjacent in space and the time domain with the current block, which is not limited in embodiments of this application.

Further, in embodiments of this application, the template type of the current block may be determined according to the reference sample of the current block. The reference sample of the current block includes at least one of: a left adjacent reference sample of the current block, an upper adjacent reference sample of the current block, an upper left adjacent reference sample of the current block, a lower left adjacent reference sample of the current block, or an upper right adjacent reference sample of the current block.

It may be understood that in embodiments of this application, the reference sample of the current block may include an adjacent reconstructed sample of the current block, that is, the adjacent reconstructed sample of the current block may be selected as a template to search for a matching template in a predefined search area.

It should be noted that in embodiments of this application, the reference sample of the current block, that is, the adjacent reconstructed sample of the current block may include: an upper reference sample, an upper left reference sample, an upper right reference sample, a left reference sample, and a lower left reference sample of the current block.

It may be understood that, in embodiments of this application, the process of determining the template type of the current block by using the reference sample of the current block includes: classifying the template and determining the template type according to whether the adjacent reference sample is available.

Further, in embodiments of this application, the process of determining the template type of the current block according to the reference sample of the current block may include: if the left adjacent reference sample of the current block, the upper adjacent reference sample of the current block, and the upper left adjacent reference sample of the current block are all available, determining the template type of the current block as a first value; if the left adjacent reference sample of the current block is available, determining the template type of the current block a second value; if the upper adjacent reference sample of the current block is available, determining the template type of the current block as a third value; if both the left adjacent reference sample of the current block and the upper left adjacent reference sample of the current block are available, determining the template type of the current block as a fourth value; if both the left adjacent reference sample of the current block and the lower left adjacent reference sample of the current block are available, determining the template type of the current block as a fifth value; and if both the upper adjacent reference sample of the current block and the upper right adjacent reference sample of the current block are available, determining the template type of the current block as a sixth value.

It should be noted that, in embodiments of this application, the first value, the second value, the third value, the fourth value, the fifth value, and the sixth value may be any value, which is not specifically limited in this application. For example, values of the first value, the second value, the third value, the fourth value, the fifth value, and the sixth value may be respectively 1, 2, 3, 4, 5, and 6.

For example, in embodiments of this application, refTemplateType may be used to represent a template type. Correspondingly, as shown in FIG. 3, block that is filled with a grid is the current block, and an adjacent area of the current block is a template T. Six template types are shown herein.

For example, the six template types are as follows. When the upper left reference sample, the upper reference sample, and the left reference sample are all available, a value of refTemplateType is 1, and a template shape is shown by (a) in FIG. 3. When only the left reference sample is available, the value of refTemplateType is 2, and the template shape is shown by (b) in FIG. 3. When only the upper reference sample is available, the value of refTemplateType is 3, and the template shape is shown by (c) in FIG. 3. When only the left reference sample and the upper left reference sample are available, the value of refTemplateType is 4, and the template shape is shown by (d) in FIG. 3; when only the left reference sample and the lower left reference sample are available, the value of refTemplateType is 5, and the template shape is shown by (e) in FIG. 3; and when only the upper reference sample and the upper right reference sample are available, the value of refTemplateType is 6, and the template shape is shown by (f) in FIG. 3.

Further, in embodiments of this application, the process of determining the first template corresponding to the current block according to the template type may include: determining a template reference sample of the current block according to the template type and a template size corresponding to the template type; and determining the first template of the current block according to the template reference sample.

It should be noted that in embodiments of this application, the first template of the current block may include the template reference sample of the current block. The template reference sample of the current block may be determined according to the template type of the current block and the template size corresponding to the template type.

It should be noted that in embodiments of this application, the first template of the current block may be formed by a reconstructed sample located in the following one or more areas of the current block: an upper area, an upper right area, a left area, a lower left area, or an upper left area, that is, may be formed by the reference sample of the current block.

It should be noted that in embodiments of this application, the template size corresponding to the template type may be preset. For example, when the left template is acquired, the template width templateW_size may be set to 4; and when the upper template is acquired, the template height templateH_size may be set to 4.

Correspondingly, in embodiments of this application, with reference to the value of the template type refTemplateType of the current block and the template size corresponding to the refTemplateType, reconstructed samples to be obtained as template reference samples of the current block can be determined, thereby determining a corresponding first template.

For example, in embodiments of this application, when a value of refTemplateType is 1, left, upper left, and upper reconstructed samples of the current block may be selected. When the value of refTemplateType is 2, only four columns of reconstructed samples on left of the current block are obtained. When the value of refTemplateType is 3, only four rows of reconstructed samples above the current coding block are obtained.

Certainly, the preset value of the template size may be any integer greater than 0, and is not limited to 4. This is not specifically limited in this application.

It may be understood that, in embodiments of this application, with reference to the template type of the current block and the corresponding template size, the template reference sample of the current block determined from the reference samples of the current block may be the first template corresponding to the current block.

In step 102, according to the first template, one or more block vectors corresponding to the current block are determined.

In embodiments of this application, after the first template corresponding to the current block is determined, one or more block vectors corresponding to the current block may be further determined according to the first template.

It should be noted that in embodiments of this application, a search process of the block vector may include: an initialization process, determining a search area of the first template in a current frame, and performing searching and determining one or more best block vectors in the search area. Therefore, when performing search processing, an initialization operation needs to be completed first.

For example, as shown in FIG. 5, nTbW and nTbH represent sizes of the current block, templateW_size and templateH_size represent template sizes, and uiPatchWidth and uiPatchHeight represent sizes of a block that include the current block and a template of the current block.

Correspondingly, during the initialization, uiPatchWidth is initialized to nTbW+templateW_size, and uiPatchHeight is initialized to nTbH+templateH_size. In which, templateW_size and templateH_size may be fixed constants, or may be dynamically adjusted according to encoding block sizes. In which, templateW_size and templateH_size may be equal or not. For example, templateW_size=4 and templateH_size=4. Alternatively, when the width of the coding block is greater than 8, templateW_size is set to 4. When the width of the coding block is less than or equal to 8, templateW_size is set to 2. When the height of the coding block is greater than 8, templateH_size is set to 4. When the height of the coding block is less than or equal to 8, templateH_size is set to 2.

Further, a cost threshold between initialization templates is represented by diffThreshold. For example, when the cost function is SAD, the threshold may be caculated according to diffThreshold=((1<<bitDepth)>>2)×(uiPatchHeight×uiPatchWidth−nTbH×nTbW). When a picture bit depth bitDepth is 10, diffThreshold indicates that a maximum distortion of each sample in the template area is 256.

Further, a location CtbRsX, ctbRsY of an encoding tree block CTB, in which the current block CB is located, is initialized.

Further, a location offset of the current block CB within the current CTB is initialized:

$$OffsetLCBY = yTbCmp - ctbRsY , offsetLCBX = xTbCmp - ctbRsX .$$

Further, iTemplateSizeH is initialized into templateH_size and iTemplateSizeW is initialized into templateW_size.

Further, iBvShift is initialized, and iBvShift represents block vector BV accuracy. For example, the accuracy of the BV may be integer sample accuracy, and in this case, iBvShift is 0. The BV accuracy may also be sub-sample precision. For example, when iBvShift is 1, it indicates ½ sample accuracy; and when iBvShift is 2, it indicates ¼ sample accuracy. This is not specifically limited herein.

Further, a preset search range of the template is initialized, and the preset search range of the template may be set to a fixed size, or the search range may be dynamically adjusted according to a coding block size. For example, searchRangeWidth=TMP_SEARCH_RANGE_MULT_FACTOR×nTbW, searchRangeHeight=TMP_SEARCH_RANGE_MULT_FACTOR×nTbH. A value of TMP_SEARCH_RANGE_MULT_FACTOR may be a preset value, for example, is set to 5.

Further, in embodiments of this application, the process of determining the one or more block vectors corresponding to the current block according to the first template may include: determining the preset search area according to the first template, and performing a search in a preset search area to determine the one or more block vectors.

It should be noted that, in embodiments of this application, the search area is a reconstructed part of the current picture, and is limited by a size of a search range. As shown in FIG. 6, a background area filled with a dark color is a reconstructed area, a background block filled with black is the current block, and a dashed line box is a search range window. Therefore, the search area of the IntraTMP technology is not greater than an overlapping part of the reconstructed area represented by the dark color and the area represented by the dashed line box.

It can be learned that the search area of the current block template may be a reconstructed part of a CTB in which the current block is located, or may be another reconstructed CTB area. The search area herein is actually a set of all search points. The search area cannot be represented by a single rectangular area generally. In specific implementation, a search may be performed in multiple rectangular areas, and the best matching block and the best block vector are obtained according to search results of different regions.

For example, as shown in FIG. 7, eight different sub-area division manners are shown herein. A background block filled with black is the current block; in (a), (b), (c), (d), and (f), the search area is divided into four sub-search areas; and in (e), (g), and (h), the search area is divided into three sub-search areas. Herein, different patterns represent different sub-search areas.

In FIG. 7, for (a), (b), (c), and (d), all available search ranges are considered; and for (e), (f), (g), and (h), no search is performed in upper area and the left area of the current block.

For example, it is assumed that different sub-search areas are represented by using a regionId. Since a template sample of the current encoding block needs to be obtained from a picture reconstructed area and a reconstructed block sample corresponding to the template also needs to be obtained from the reconstructed area, locations that can be found in the search areas represented by different regionIds are determined according to a location (xTbCmp, yTbCmp) of the current block, a size (nTbW, nTbH) of the current encoding block, a size (picWidth, picHeight) of the current picture, a size (CtbSizeW, CtbSizeH) of a CTB in which the current block is located, a preset search range (search RangeWidth, searchRangeHeight) of the template, and a location offset (offsetLCBY, offsetLCBX) of the current block in the current CTB, thereby determining a block vector BV. Specifically, iVerMin and iVerMax are respectively used to represent a minimum absolute coordinate and a maximum absolute coordinate than can be found in a vertical direction, and iHorMin and iHorMax are respectively used to represent a minimum absolute coordinate and a maximum absolute coordinate that can be found in a horizontal direction. Values of iVerMin, iVerMax, iHorMin, and iHorMax are different in search areas represented by different regionIds.

As shown by (f) in FIG. 7 for example, the search area is divided into four sub-search areas. An implementation manner of the sub-search area is as follows.

When regionId is equal to 0, iVerMin, iVerMax, iHorMin, and iHorMax may be calculated as follows:

$${iHorMax}_{0} = min ( ( xTbCmp + searchRangeWidth ) << iBvShift , ( picWidth - nTbW ) << iBvShift ) ;$$

$${iHorMin}_{0} = max ( ( iTemplateSizeW ) << iBvShift , ( xTbCmp - searchRange Width ) << iBvShift ) ;$$

$$i {VerMax}_{0} = ( yTbCmp - nTbH - offsetLCBY ) << iBvShift ;$$

$$i {VerMin}_{0} = max ( ( ( iTemplateSizeH ) << iBvShift ) , ( ( yTbCmp - searchRangeHeight ) << iBvShift ) ) .$$

When regionId is equal to 2, iVerMin, iVerMax, iHorMin, and iHorMax may be calculated as follows:

$${iHorMin}_{1} = max ( ( iTemplateSizeW ) << iBvShift , ( xTbCmp - searchRangeWidth ) << iBvShift ) ;$$

$${iHorMax}_{1} = ( xTbCmp - offsetLCBX - nTbW ) << iBvShift ;$$

$${iVerMin}_{1} = ( yTbCmp + 1 ) << iBvShift ;$$

$${iVerMax}_{1} = min ( picHeight - nTbH , ( yTbCmp - offsetLCBY + CtbSizeH - nTbH ) << iBvShift )$$

$${iHorMax}_{2} = ( xTbCmp - offsetLCBX - nTbW ) << iBvShift ;$$

$${iHorMin}_{2} = max ( ( iTemplateSizeW ) << iBvShift , ( xTbCmp - searchRangeWidth ) << iBvShift ) ;$$

$${iVerMin}_{2} = max ( ( iTemplateSizeH ) << iBvShift , ( yTbCmp - nTbH - offsetLCBY ) << iBvShift ) ;$$

$${iVerMax}_{2} = ( yTbCmp ) << iBvShift .$$

When regionId is equal to 3, iVerMin, iVerMax, iHorMin, and iHorMax may be calculated as follows:

$${iHorMin}_{3} = max ( ( iTemplateSizeW ) << iBvShift , ( xTbCmp - offsetLCBX - nTbW + 1 ) << iBvShift ) ;$$

$${iHorMax}_{3} = ( xTbCmp - nTbW ) << iBvShift ;$$

$$i {VerMin}_{3} = max ( ( ( iTemplateSizeH ) << iBvShift ) , ( yTbCmp - offsetLCBY - nTbH + 1 ) << iBvShift ) ;$$

$${iVerMax}_{3} = ( yTbCmp - nTbH ) << iBvShift .$$

In actual application, iHorMinre_{gionId}, iHorMax_{regionId}, iVerMin_{regionId}, and iVerMax_{regionId} herein respectively represent left edges, right edges, upper edges, and lower edges of different sub-search areas.

To intuitively describe different sub-search areas corresponding to different regionIds, as shown by FIG. 8, R1, R2, R3, and R4 represent four different sub-search areas. It should be noted that FIG. 8 shows a sample range in which upper left corner samples of the block may be aligned.

In some embodiments, as shown by (a) in FIG. 7 for example, the search area is divided into four sub-search areas. An implementation manner of the sub-search area is as follows.

When regionId is equal to 0, iVerMin, iVerMax, iHorMin, and iHorMax may be calculated as follows:

$${iHorMax}_{0} = min ( ( xTbCmp + searchRange Width ) << iBvShift , ( ( picWidth - nTbW ) << iBvShift ) )$$

$${iHorMin}_{0} = max ( ( iTemplateSizeW ) << iBvShift , ( xTbCmp - searchRangeWidth ) << iBvShift )$$

$${iVerMax}_{0} = ( yTbCmp - nTbH - offsetLCBY ) << iBvShift$$

$$i {VerMin}_{0} = max ( ( ( iTemplateSizeH ) << iBvShift ) , ( ( yTbCmp - searchRangeHeight ) << iBvShift ) )$$

When regionId is equal to 1, iVerMin, iVerMax, iHorMin, and iHorMax may be calculated as follows:

$${iHorMin}_{1} = max ( ( iTemplateSizeW ) << iBvShift , ( xTbCmp - searchRangeWidth ) << iBvShift )$$

$${iHorMax}_{1} = ( xTbCmp - offsetLCBX - nTbW ) << iBvShift ;$$

$${iVerMin}_{1} = ( yTbCmp + 1 ) << iBvShift ;$$

$${iVerMax}_{1} = min ( picHeight - nTbH , ( yTbCmp - offsetLCBY + CtbSizeH - nTbH ) << iBvShift ) .$$

When regionId is equal to 2, iVerMin, iVerMax, iHorMin, and iHorMax may be calculated as follows.

$${iHorMax}_{2} = ( xTbCmp - nTbW ) << iBvShift ;$$

$${iHorMin}_{2} = max ( ( iTemplateSizeW ) << iBvShift , ( xTbCmp - searchRange Width ) << iBvShift ) ;$$

$${iVerMin}_{2} = max ( ( iTemplateSizeH ) << iBvShift , ( yTbCmp - nTbH ) << iBvShift ) ;$$

$${iVerMax}_{2} = ( yTbCmp ) << iBvShift .$$

When regionId is equal to 3, iVerMin, iVerMax, iHorMin, and iHorMax may be calculated as follows:

$${iHorMin}_{3} = max ( ( iTemplateSizeW ) << iBvShift , ( xTbCmp - searchRangeWidth ) << iBvShift ) ;$$

$${iHorMax}_{3} = ( xTbCmp ) << iBvShift ;$$

$${iVerMin}_{3} = max ( ( ( iTemplateSizeH ) << iBvShift ) , ( yTbCmp - offsetLCBY - nTbH + 1 ) << iBvShift ) ;$$

$${iVerMax}_{3} = ( yTbCmp - nTbH ) << iBvShift .$$

In actual applications, iHorMin_{regionId}, iHorMax_{regionId}, iVerMin_{regionId}, and iVerMax_{regionId} herein respectively represent left edges, right edges, upper edges, and lower edges of different sub-search areas.

To intuitively describe different sub-search areas corresponding to different regionIds, as shown by FIG. 8, R1, R2, R3, and R4 represent four different sub-search areas. It should be noted that FIG. 8 shows a sample range in which upper left corner samples of the block may be aligned.

In some embodiments, as shown by (b) in FIG. 7 for example, the search area is divided into four sub-search areas. An implementation manner of the sub-search area is as follows.

When regionId is equal to 0, iVerMin, iVerMax, iHorMin, and iHorMax may be calculated as follows:

$$iHorMax 0 = min ( ( xTbCmp + searchRangeWidth ) << iBvShift , ( ( picWidth - nTbW ) << iBvShift ) )$$

$$iHorMi n 0 = max ( ( iTemplateSizeW ) << iBvShift , ( xTbCmp - searchRangeWidth ) << iBvShift )$$

$$i VerMax 0 = ( yTbCmp - nTbH - offsetLCBY ) << iBvShift$$

$$iVerMin 0 = max ( ( ( iTemplateSizeH ) << iBvShift ) , ( ( yTbCmp - searchRangeHeight ) << iBvShift ) ) .$$

When regionId is equal to 1, iVerMin, iVerMax, iHorMin, and iHorMax may be calculated as follows:

$$iHorMin 1 = max ( ( iTemplateSizeW ) << iBvShift , ( xTbCmp - searchRangeWidth ) << iBvShift )$$

$$iHorMax 1 = ( xTbCmp - offsetLCBX - nTbW ) << iBvShift ;$$

$$iVerMin 1 = ( yTbCmp + 1 ) << iBvShift ;$$

$$iVerMax 1 = min ( picHeight - nTbH , ( yTbCmp - offsetLCBY + CtbSizeH - nTbH ) << iBvShift ) .$$

When regionId is equal to 2, iVerMin, iVerMax, iHorMin, and iHorMax may be calculated as follows:

$$iHorMax 2 = ( xTbCmp - nTbW ) << iBvShift ;$$

$$iHorMin 2 = max ( ( iTemplateSizeW ) << iBvShift , ( xTbCmp - searchRangeWidth ) << iBvShift ) ;$$

$$iVerMin 2 = max ( ( iTemplateSizeH ) << iBvShift , ( yTbCmp - nTbH - offsetLCBY ) << iBvShift ) ;$$

$$iVerMax 2 = ( yTbCmp ) << iBvShift .$$

When regionId is equal to 3, iVerMin, iVerMax, iHorMin, and iHorMax may be calculated as follows:

$$iHor Min 3 = max ( ( iTemplateSizeW ) << iBvShift , ( xTbCmp - nTbW + 1 ) << iBvShift ) ;$$

$$iHor Max 3 = ( xTbCmp ) << iBvShift ;$$

$$iVer Min 3 = max ( ( iTemplateSizeH ) << iBvShift ) , ( yTbCmp - offsetLCBY - nTbH + 1 ) << iBvShift ) ;$$

$$iVer Max 3 = ( yTbCmp - nTbH ) << iBvShift .$$

In actual application, iHorMin_{regionId}, iHorMax_{regionId}, iVerMin_{regionId}, and iVerMax_{regionId} herein respectively represent left edges, right edges, upper edges, and lower edges of different sub-search areas.

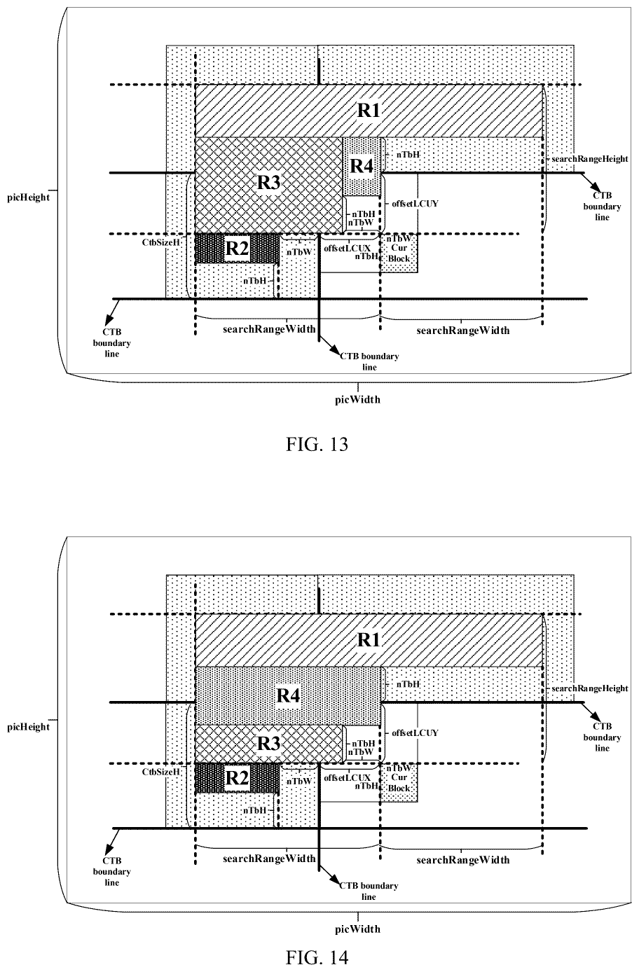

To intuitively describe different sub-search areas corresponding to different regionIds, FIG. 13 shows a schematic diagram of a process of determining a search area. As shown by FIG. 13, R1, R2, R3, and R4 represent four different sub-search areas. It should be noted that FIG. 13 shows a sample range in which upper left corner samples of the block may be aligned.

Further, in embodiments of this application, the process of performing a search in a preset search area to determine one or more block vectors may include: traversing a search point in the preset search area, and determining a matching cost value between a matching template corresponding to the search point in the preset search area and a first template according to a preset matching criterion; and determining one or more block vectors and one or more candidate templates corresponding to the one or more block vectors according to the matching cost value.

It should be noted that, in embodiments of this application, a quantity of block vectors determined by searching may be one or more. For example, N block vectors of the current block may be determined, where N is an integer greater than 0.

Correspondingly, in embodiments of this application, the process of performing a search in a preset search area to determine one or more block vectors may include: determining a preset quantity N corresponding to the candidate template; traversing a search point in the preset search area, and determining, according to the preset matching criterion, a matching cost value between the matching template corresponding to the search point in the preset search area and the first template; and determining N block vectors and N candidate templates corresponding to the N block vectors according to the matching cost value.

That is, in embodiments of this application, the process of performing a search in the preset search area and determining the N block vectors corresponding to the N matching templates that is, the process of performing a search in the search area (the preset search area) and determining the block vectors BV corresponding to the N matching templates may include: determining a value of a quantity N of candidate templates, determining a matching template comparison criterion, and recording N block vectors BV corresponding to the N matching templates (the N selected candidate templates).

It may be understood that, in embodiments of this application, the process of determining the preset quantity N corresponding to the candidate template may include: decoding a bitstream to determine N; determining N according to a first preset value; or determining N according to a preset value range.

That is, in embodiments of this application, a value of N needs to be first determined. N herein may be preset as a constant, for example, N is 4. N may also be in a specific value range, for example, N may be any integer in [2, 8]. A range of the N is preset, and an optimal N value may be determined at an encoding side in a manner in which coarse selection is performed at cost 1, coarse selection is performed at cost 2, coarse selection is performed at cost 3, or fine selection is performed at cost 4, and the optimal N value is transmitted to a decoding side via a bitstream. The costs 1, 2, 3, and 4 may be a cost function for estimating a mode, such as SAD, SATD, MSE, MAD, or RDO. A manner of determining N is not specifically limited in this application.

It should be noted that in embodiments of this application, the preset matching criterion includes any one the following functions for estimating a mode: sum of absolute difference SAD, sum of absolute transformed difference SATD, difference square sum SSE, mean absolute derivation MAD, mean absolute error MAE, mean square error MSE, a normalized correlation coefficient NCC, and the like.

Further, in embodiments of this application, the process of determining the N block vectors and the N candidate templates corresponding to the N block vectors according to the matching cost value, that is, the process of determining the one or more block vectors and the one or more candidate templates corresponding to the one or more block vectors may include: determining N minimum matching cost values from the matching cost value between the matching template corresponding to the search point in the preset search area and the first template; and determining N block vectors and N candidate templates corresponding to the N minimum matching cost values.

It should be noted that in embodiments of this application, for any block vector of the N block vectors, bvXMins and bvXMaxs may respectively represent a minimum offset and a maximum offset of the block vector in a horizontal direction; and bvYMins and bvYMaxs may respectively represent a minimum offset and a maximum offset of the block vector in a vertical direction.

In which, bvXMinsregionId, bvXMaxsregionId, bvYMinsregionId, and bvYMaxsregionId may be calculated by using the determined iVerMinregionId, iVerMaxregionId, iHorMinregionId, and iHorMaxregionId:

$$bvX Min sregionId = iHor Min regionID - xTbCmp ;$$

$$bvX Max sregionId = iHor Max regionID - xTbCmp ;$$

$$bvY Min sregionId = iVer Min regionID - yTbCmp ;$$

$$bvY Max sregionId = iVer Max regionID - yTbCmp .$$

In which, bvXMinsregionId, bvXMaxsregionId, bvYMinsregionId, and bvYMaxsregionId determine a horizontal and vertical offset range of the search point relative to the current block, that is, a range of the block vector BV.

It should be further noted that, by traversing a searching point (iPosHor, iPoxVer) in each search area, each block vector BV (including a horizontal component and a vertical component: (PX, pY)) is determined, where pX=iPosHor−xTbCmp and pY=iPosVer−yTbCmp, pX is between bvXMins and bvXMaxs, and pY is between bvYMins and bvYMaxs. In this way, one or more matching reconstructed blocks of the current block may be found in the reconstructed area, and an adjacent reconstructed sample of the one or more matching reconstructed blocks is a matching template. Therefore, a matching cost of the adjacent template of the current block and the adjacent template of the one or more matching reconstructed blocks is calculated, which is denoted as pDiff.

Further, all search points in all search ranges (regionId=0, 1, 2, and 3) are traversed, to obtain a search point with a minimum matching cost value pDiff by comparison. For the obtained serach point, a corresponding matching cost value is indicated by pDiff_BEST, one or more corresponding block vectors BV are indicated by a best block vector BV_BEST (pX_BEST, pY_BEST), and one or more corresponding matching templates are indicated by a best matching template T_BEST. That is, one or more candidate templates are obtained.

It may be understood that in embodiments of this application, after the value of the quantity N of candidate templates is determined, N block vectors BV corresponding to the N candidate templates with a relatively high matching degree need to be selected according to a comparison criterion. That is, different from a common related technology of searching for a matching template and recording a block vector BV, technical solutions of this application are as follows. Multiple block vectors BVₙ are selected and recorded; a matching template is obtained according to the block vector BVₙ (that is, according to the template offsets pXₙ and the pYₙ), a cost of the matching template is calculated, N BVs corresponding to N matching templates whose costs are relatively low are recoded. Herein, the N matching templates are referred to as N candidate templates. The template matching cost (a preset matching criterion) may be one of the following cost functions for estimating a mode: SAD, SATD, MSE, MAD, RDO, a correlation coefficient and so on.

Exemplarily, in embodiments of this application, when the matching cost comparison criterion (the preset matching criterion) is Mean Absolute Difference (Mean Absolute Difference, MAD), a calculation formula is as follows:

$$MAD ( refT ) = \frac{1}{M} {\sum }_{m = 0}^{M - 1} \vert {refT}_{m} - c u r {T}_{m} \vert . \qquad ( 3 )$$

In which, refT represents a matching template in a search process, curT represents a current encoding block template (a first template of the current block), M is a quantity of samples of the current encoding block template, and MAD (refT) represents mean absolute difference between the current encoding block template curT and the found matching template.

Correspondingly, in embodiments of this application, the MAD-based screening criterion is: determining by comparing and recording N block vectors BV corresponding to the N matching templates with the lowest MAD cost.

For example, for the N candidate templates, MAD between the n-th candidate template and the current encoding block template is given as follows:

$$MAD ( {refT}_{n} ) = \frac{1}{M} {\sum }_{m = 0}^{M - 1} \vert {refT}_{n , m} - c u r {T}_{m} \vert . \qquad ( 4 )$$

In which, refTₙ represents the n-th candidate template, MADrefTₙ(refTₙ) represents the mean absolute difference between the current encoding block template curT and the n-th candidate template, n=0, . . . , N−1.

Exemplarily, in embodiments of this application, when the matching cost comparison criterion (preset match criterion) is the SAD, a calculation formula is as follows:

$$S AD ( refT ) = {\sum }_{m = 0}^{M - 1} \vert {refT}_{n , m} - c u r {T}_{m} \vert . \qquad ( 5 )$$

The SAD (refT) represents sum of absolute difference between a current encoding block template (a first template of the current block) curT and the found matching template.

Correspondingly, in embodiments of this application, the SAD-based screening criterion is: determining by comparing and recording N block vectors BV corresponding to N matching templates with a relatively low SAD cost.

For example, for the N candidate templates, a SAD between the n-th candidate template and the current encoding block template is given as follows:

$$SAD ( {refT}_{n} ) = {\sum }_{m = 0}^{M - 1} \vert {refT}_{n , m} - c u r {T}_{m} \vert . \qquad ( 6 )$$

In which, SAD(refTₙ) represents sum of absolute difference between a current encoding block template and the n-th candidate template.

For example, in embodiments of this application, comparison is performed by using the NCC normalized correlation coefficient as a template matching criterion, and a calculation formula is as follows:

$$R ( refT ) = \frac{{Σ}_{m = 0}^{M - 1} \vert {refT}_{m} - {refT}_{Avg} \vert * \vert {curT}_{m} - {curT}_{Avg} \vert}{\sqrt{{{Σ}_{m = 0}^{M - 1} ( {refT}_{m} - {refT}_{Avg} )}^{2}} * \sqrt{{{Σ}_{m = 0}^{M - 1} ( {curT}_{m} - {curT}_{Avg} )}^{2}}} . \qquad ( 7 )$$

In which, refT represents a matching template in a search process, curT represents a current encoding block template (a first template of the current block), M represents a quantity of samples of the current encoding block template, refT_{Avg} represents a sample average value of the found matching template, curT_{Avg} represents a sample average value of the current encoding block template, and R(refT) represents a correlation coefficient between the current encoding block template and the found matching template.

Correspondingly, in embodiments of this application, the comparison criterion based on NCC includes: ranking ad recording N block vectors BV corresponding to N matching templates with greater correlation coefficients R.

For the N candidate templates, a correlation coefficient between the n-th candidate template and the current encoding block template is calculated as follows:

$$R ( {refT}_{n} ) = \frac{{Σ}_{m = 0}^{M - 1} \vert {refT}_{n , m} - {refT}_{{n}_{Avg}} \vert * \vert {curT}_{m} - {curT}_{Avg} \vert}{\sqrt{{{Σ}_{m = 0}^{M - 1} ( {refT}_{n , m} - {refT}_{{n}_{Avg}} )}^{2}} * \sqrt{{{Σ}_{m = 0}^{M - 1} ( {curT}_{m} - {curT}_{Avg} )}^{2}}} . \qquad ( 8 )$$

In which, refTₙ_{_{Avg}} represents a sample average value of the n-th candidate template, R(refTₙ) represents a correlation coefficient between the current encoding block template and the n-th candidate template. It should be noted that a range of the NCC normalized correlation coefficient R is [−1, 1], and a larger R indicates a stronger correlation.

It should be noted that, in embodiments of this application, when searching is performed, a search policy that may be used may include but is not limited to a search manner based on different search step sizes. For example, a coarse search manner based on a first search step size and/or a fine search manner based on a second search step size may be used, where the first search step size is greater than the second search step size.

Further, in embodiments of this application, the block vector and the candidate template may be determined by traversing the search point in the preset search area according to the first search step size. Alternatively, the block vector and the candidate template may be determined by traversing the search point in the preset search area according to the second search step size.

Further, in embodiments of this application, the search point in the preset search area may be traversed first according to the first search step size to determine an initial block vector and an initial matching template corresponding to the initial block vector. Then a first search area is determined according to the initial matching template. The first search area is less than a preset search area. Finally, the search point in the first search area is traversed according to the second search step size to determine the block vector and the candidate template. The first search step size is greater than the second search step size.

That is, in embodiments of this application, the best matching template may be searched for in the search area by using the following search strategy: a search strategy of performing coarse searching first and then fine searching, or performing only fine searching or performing only coarse searching.

For example, in embodiments of this application, the coarse search may include: determining a best coarse matching template in a search area by using a first preset step size (that is, a first search step size, for example, 2), that is, obtaining a final candidate template; or determining a best coarse matching template in a search area by using a template that is downsampled (for example, a downsampling factor is 2), that is, obtaining a final candidate template.

For example, in embodiments of this application, the fine search may include: determining the best fine matching template in the search area by using a second preset step size (that is, a second search step size, for example, 1), that is, obtaining the final candidate template; or determining the best fine matching template near the best coarse matching template after completing the coarse search, that is, obtaining the final candidate template.

For example, in embodiments of this application, if the search policy is to perform only coarse search, coarse search may be performed in a range of each region in which pX is between bvXMinsregionId and bvXMaxsregionId and pY is between bvYMinsregionId and bvYMaxsregionId, by using a step size greater than 1. For example, coarse search is performed at a step of 2 (that is, a first search step is 2), one or more best matching costs obtained by performing template matching are recorded as pDiff_BEST, and one or more corresponding block vectors BV are indicated by a best block vector BV_BEST (pX_BEST, pY_BEST). That is, one or more block vectors corresponding to the current block are obtained by performing searching in the preset search area, and the one or more matching templates corresponding to one or more best matching costs may be used as the final one or more candidate templates.

For example, in embodiments of this application, if the search policy is to perform only fine search, fine search may be performed in a range of each region in which pX is between bvXMinsregionId and bvXMaxsregionId and pY is between bvYMinsregionId and bvYMaxsregionId, by using a step size 1 (that is, the second search step size is 1), for example. One or more best matching costs obtained by performing template matching are recorded as pDiff_BEST, and one or more corresponding block vectors BV are indicated by a best block vector BV_BEST (pX_BEST, pY_BEST). That is, one or more block vectors corresponding to the current block are obtained by performing searching in the preset search area, and the one or more matching templates corresponding to one or more best matching costs may be used as the final one or more candidate templates.

For example, in embodiments of this application, if the search policy is to perform coarse search first and then perform fine search, as shown in FIG. 10. A coarse search may be performed with a step size 2 (that is, the first search step of 2). Then, a best coarse matching template (an initial matching template) obtained by performing template matching is recorded. Then, a best fine matching template may be determined near the best coarse matching template by using a step size 1 (that is, the second search step size is 1). That is, a final candidate template is obtained.

In the coarse search stage, coarse searching may be performed in a range of each area in which pX is between bvXMinsregionId and bvXMaxsregionId and pY is between bvYMinsregionId and bvYMaxsregionId, by using a step size greater than 1. For example, coarse searching is performed by using a step size 2, a best matching cost obtained by performing template matching is recoded as pDiff1_BEST, and a corresponding block vector BV is indicated by a best block vector BV1_BEST (pX1_BEST, pY1_BEST), that is, an initial block vector. A matching template corresponding to the initial block vector is an initial matching template. In this case, a search area in which the best matching search point is located is indicated by bestRegionId.

Subsequently, in the fine search stage, a search may be performed near the best block vector BV1_BEST (initial block vector) obtained by coarse search. That is, a search is performed in the first search area. Therefore, the refined search range TmpRefineRange needs to be determined first, that is, the first search area TmpRefineRange needs to be determined. The refined search range (the first search area TmpRefineRange) may be of a fixed size, or may be related to a current block size. For example, the refined search range may be set to min (nTbW, nTbH)/2, and then a position of a best matching reconstructed block obtained by coarse search is calculated as a reference position of the fine search area: BestPosX=xTbCmp+pX1_BEST, BestPosY=yTbCmp+pY1_BEST.

In embodiments of this application, calculated values of iVerMinbestRegionId, iVerMaxbestRegionId, iHorMinbestRegionId, and iHorMaxbestRegionId may be first obtained according to a value of bestRegionId, and then a new search range iVerMinrefine, iVerMax refine, iHorMinrefine, and iHorMax refine is obtained according to the location of the best matching block obtained by coarse search. An obtaining method is as follows:

$$iHor Min refine = max ( iHor Min BestRegionId , BestPosX - TmpRefineRange )$$

$$iHor Max refine = min ( iHor Max BestRegionId , BestPosX + TmpRefineRange )$$

$$iVer Min refine = max ( iVer Min BestRegionId , BestPosY - TmpRefineRange )$$

$$iVer Max refine = min ( iVer Max BestRegionId , BestPosY + TmpRefineRange ) .$$

Then, the adjusted block vector BVbvXMins, bvXMaxs, bvYMins, and bvYMaxs may be calculated by using iVerMinrefine, iVerMax refine, iHorMinrefine, and iHorMax refine:

$$bvX Min s = iHor Min refine - xTbCmp ;$$

$$bvX Max s = iHor Max refine - xTbCmp ;$$

$$bvY Min s = iVer Min refine - yTbCmp ;$$

$$bvY Max s = iVer Max refine - yTbCmp .$$

The fine search is performed in a block vector range in which pX is between bvXMinsrefine and bvXMaxsrefine and pY is between bvYMinsrefine and bvYMaxsrefine. For example, a search is performed by using a step size 1, a best matching cost obtained by template matching is recoded as pDiff_BEST, and a corresponding block vector BV is indicated as a best block vector BV_BEST (pX_BEST, pY_BEST), that is, a finally determined block vector of the current block. A corresponding matching template is a candidate template of the current block.

After the foregoing operations are completed, the best block vector BV_BEST (pX_BEST, pY_BEST) may be obtained. In which, pX_BEST and pY_BEST respectively represent a horizontal direction offset and a vertical direction offset of the best matching template relative to the current encoding block template, and pX_BEST and pY_BEST also respectively represent a horizontal direction offset and a vertical direction offset of the best matching reconstructed block relative to the current encoding block.

It can be learned that, in embodiments of this application, the process of searching and determining one or more block vectors in a search area may be performed by using three types of search strategies: performing only coarse search, performing only fine search, and performing coarse search first and then fine search. Correspondingly, if the search policy is to perform only coarse search, N block vectors BV corresponding to the N matching templates are determined only in a coarse search process, and the corresponding N matching templates are used as the N candidate templates. If the search policy is to perform only fine search, only N block vectors BV corresponding to the N matching templates are determined in a fine search process, and the corresponding N matching templates are used as the N candidate templates. If the search policy is coarse search first and then fine search, K block vectors BV corresponding to K preliminary matching templates (initial matching templates) may be first determined in a coarse search process, where K is an integer greater than or equal to N. N block vectors BV corresponding to the final N matching templates are determined based on the K preliminary matching templates in the fine search process, and the corresponding N matching templates are used as N candidate templates.

Further, in embodiments of this application, when the search processing is performed, the search point in the sub-search area in the preset search area may be traversed according to the first search step size to determine an initial vector corresponding to the sub-search area and a second search area corresponding to the initial block vector. Multiple target sub-search areas are determined in the sub-search area according to the initial block vector and the second search area. Search points in the multiple target sub-search areas are traversed according to a second search step size, to determine a block vector and a candidate template. The first search step size is greater than the second search step size.

It may be understood that, in embodiments of this application, the process of determining the multiple target sub-search areas in the sub-search area according to the initial block vector and the second search area may include: determining multiple target sub-search areas to be used in a subsequent search process, according to a best block vector of each sub-search area, that is, the initial block vector, and a corresponding second search area.

In embodiments of this application, for a search policy of performing coarse search first and then fine search, a fine search may be performed across different search areas. After a coarse search process is completed, a method of crossing boundaries of different areas may be performed in a fine search process.

Exemplarily, in embodiments of this application, as shown by (a) in FIG. 7, the search area is divided into four sub-search areas. An implementation manner of the sub-search area is as follows.

When regionId is equal to 0, iVerMin, iVerMax, iHorMin, and iHorMax may be calculated as follows:

$$iHor {Max}_{0} = min ( ( xTbCmp + searchRangeWidth ) << iBvShift , ( ( picWidth - nTbW ) << iBvShift ) )$$

$$iHor {Min}_{0} = max ( ( iTemplateSizeW ) << iBvShift , ( xTbCmp - searchRangeWidth ) << iBvShift )$$

$$iVer {Max}_{0} = ( yTbCmp - nTbh - offsetLCBY ) << iBvShift$$

$$iVer {Min}_{0} = max ( ( ( iTemplateSizeH ) << iBvShift ) , ( ( yTbCmp - searchRangeHeight ) << iBvShift ) ) .$$

When regionId is equal to 1, iVerMin, iVerMax, iHorMin, and iHorMax may be calculated as follows:

$$iHor {Min}_{1} = max ( ( iTemplateSizeW ) << iBvShift , ( xTbCmp - searchRangeWidth ) << iBvShift )$$

$$iHor {Max}_{1} = ( xTbCmp - offsetLCBX - nTbW ) << iBvShift ;$$

$$iVer {Min}_{1} = ( yTnCmp + 1 ) << iBvShift ;$$

$$iVer {Max}_{1} = min ( picHeight - nTbh , ( yTbCmp - offsetLCBY + CtbSizeH - nTbH ) << iBvShift ) .$$

When regionId is equal to 2, iVerMin, iVerMax, iHorMin, and iHorMax may be calculated as follows:

$$iHor {Max}_{2} = ( xTbCmp - nTbW ) << iBVShift ;$$

$$iHor {Min}_{2} = max ( ( iTemplateSizeW ) << iBvShift , ( xTbCmp - searchRangeWidth ) << iBvShift ) ;$$

$$iVer {Min}_{2} = max ( ( iTemplateSizeH ) << iBvShift , ( yTbCmp - nTbH ) << iBvShift ) ;$$

$$iVer {Max}_{2} = ( yTbCmp ) << iBvShift .$$

When regionId is equal to 3, iVerMin, iVerMax, iHorMin, and iHorMax may be calculated as follows:

$$iHor {Min}_{3} = max ( ( iTemplateSizeW ) << iBvShift , ( xTbCmp - searchRangeWidth ) << iBvShift ) ;$$

$$iHor {Max}_{3} = ( xTbCmp ) << iBvShift ;$$

$$iVer {Min}_{3} = max ( ( ( iTemplateSizeH ) << iBvShift ) , ( yTbCmp - offsetLCBY - nTbH + 1 ) << iBvShift ) ;$$

$$iVer {Max}_{3} = ( yTbCmp - nTbH ) << iBvShift .$$

In actual applications, iHorMin_{regionId}, iHorMax_{regionId}, iVerMin_{regionId}, and iVerMax_{regionId} herein respectively represent left edges, right edges, upper edges, and lower edges of different sub-search areas.

To intuitively describe different sub-search areas corresponding to different regionIds, FIG. 14 shows a schematic diagram of a process of determining a search area. As shown by FIG. 14, R1, R2, R3, and R4 represent four different sub-search areas. It should be noted that FIG. 14 shows a sample range in which upper left corner samples of the block may be aligned.

In the fine search stage, a search may be performed near the block vector obtained by the coarse search: Further, a search may be performed near the best block vector BV1_BESTk obtained by the coarse search. Specifically, a refined search range TmpRefineRange is first determined, and the refined search range may be of a fixed size, or may be related to a size of the current block. For example, the refined search range may be set to min (nTbW, nTbH)/2. Then, a location of the best matching reconstructed block obtained by coarse search is calculated as a reference location of the fine search area: BestPosXk=xTbCmp+pX1_BESTk, BestPosYk=yTbCmp+pY1_BESTk.

In some embodiments, the fine search according to each BestPosXk may be performed across multiple areas, i.e., the fine search may be performed by crossing boundaries of different search areas. The value of bestRegionId that participates in the operation may be first determined. For regionId=0, 1, 2, and 3, the following determination is performed. If BestPosYk−TmpRefineRange>=iVerMinregionId, and BestPosYk−TmpRefineRange<=iVerMaxregionId,
or BestPosYk+TmpRefineRange>=iVerMinregionId, and BestPosYk+TmpRefineRange<=iVerMaxregionId,
or BestPosYk−TmpRefineRange<=iVerMinregionId, and BestPosYk+TmpRefineRange>=iVerMaxregionId,
the corresponding bestSearchFlagregionId to set to 1.

For a search area whose bestSearchFlagregionId value is 1, a regionId of the search area is set to bestRegionId, and the following fine search is performed. First, calculated values of iVerMinbestRegionId, iVerMaxbestRegionId, iHorMinbestRegionId, and iHorMaxbestRegionId are obtained according to a value of bestRegionId, and then a new search range iVerMinrefine, iVerMaxrefine, iHorMinrefine, and iHorMaxrefine is obtained according to a location of the best matching block obtained by coarse search. The obtaining method is as follows:

$$iHor Min refine = max ( iHor Min bestRegionId , BestPosX - TmpRefineRange )$$

$$iHor Max refine = min ( iHor Max bestRegionId , BestPosX + TmpRefineRange )$$

$$iVer Min refine = max ( iVer Min bestRegionId , BestPosY - TmpRefineRange )$$

$$iVer Max refine = min ( iVer Max bestRegionId , BestPosY + TmpRefineRange ) .$$

Then, the adjusted block vector BVbvXMins, bvXMaxs, bvYMins, and bvYMaxs may be calculated by using iVerMinrefine, iVerMaxrefine, iHorMinrefine, and iHorMaxrefine:

$$\begin{matrix}bvXMins = iHorMinrefine - xTbCmp ; \\ bvXMaxs = iHorMaxrefine - xTbCmp ; \\ bvYMins = iVerMinrefine - yTbCmp ; \\ bvyMaxs = iVerMaxrefine - yTbCmp .\end{matrix}$$

In this way, the fine search is performed in a block vector range in which pX is between bvXMinsrefine and bvXMaxsrefine and pY is between bvYMinsrefine and bvYMaxsrefine. For example, search is performed by using a step size 1, a beset matching cost obtained by template matching is recoded as pDiff_BEST, and a corresponding block vector BV is indicated as a best block vector BV_BEST (pX_BEST, pY_BEST).

A total best block vector for the multiple search areas is obtained.

After the foregoing search operation is completed, the best block vector BV_BEST (pX_BEST, pY_BEST) may be obtained. In which, pX_BEST and pY_BEST respectively represent a horizontal direction offset and a vertical direction offset of the best matching template relative to the current encoding block template, and pX_BEST and pY_BEST also respectively represent a horizontal direction offset and a vertical direction offset of the best matching reconstructed block relative to the current encoding block.

In step 103, one or more reference blocks of the current block are determined according to the one or more block vectors, and a predicted value of the current block is determined according to the one or more reference blocks.

In embodiments of this application, after the one or more block vectors corresponding to the current block are determined according to the first template, the one or more reference blocks of the current block may be further determined according to the one or more block vectors, and then the predicted value of the current block may be determined according to the one or more reference blocks.

It should be noted that in embodiments of this application, the one or more reference blocks of the current block may include a first reference block and/or a second reference block. Both the first reference block and the current block belong to the current picture, and the second reference block belongs to the reference picture of the current picture corresponding to the current block.

In embodiments of this application, the one or more reference blocks of the current block may include only a first reference block in the current picture obtained by performing intra prediction, or may include only a second reference block in the reference picture of the current picture obtained by performing inter prediction, or may include both the first reference block and the second reference block.

Correspondingly, in embodiments of this application, the process of obtaining the second reference block may include: decoding a bitstream to determine one or more block vectors; and performing searching in the reference picture of the current picture to determine a second reference block corresponding to the one or more block vectors.

In embodiments of this application, template matching searching may be performed in the current picture by using an intra template matching manner to determine one or more reference blocks corresponding to the current block, that is, the first reference block. Alternatively, template matching search may be performed in one or more inter-frame reference pictures of the current picture by using an inter template matching manner to determine one or more reference blocks corresponding to the current block, that is, the second reference block. Alternatively, template matching search may be separately performed in the current picture and the one or more inter-frame reference pictures by using the intra template matching manner and the inter template matching manner, to determine one or more reference blocks corresponding to the current block, including the first reference block and the second reference block.

Further, in embodiments of this application, the process of determining the one or more reference blocks corresponding to the current block according to the one or more block vectors may include: determining one or more initial reconstructed blocks corresponding to the current block according to the one or more block vectors; and modifying one or more initial reconstructed blocks to determine the one or more reference blocks.

In embodiments of this application, N candidate reconstructed blocks (reference blocks) may be obtained in another manner. For example, the initial reconstructed block corresponding to the obtained candidate template is modified, and then a corresponding reference block is determined.

Correspondingly, after N candidate reconstructed blocks (reference blocks) are obtained by copying matching reconstructed blocks (initial reconstructed blocks) corresponding to N BVs, the N candidate reconstructed blocks may be directly weighted to obtain a predicted value of the current block. Alternatively, matching reconstructed blocks (initial reconstructed blocks) corresponding to N BVs are modified to obtain the candidate reconstructed blocks (reference blocks), and then weighting is performed on the candidate reconstructed blocks to obtain a predicted value of the current block.

Further, in embodiments of this application, the process of modifying the one or more initial reconstructed blocks to determine the one or more reference blocks may include: performing filtering processing on the one or more initial reconstructed blocks to determine the one or more reference blocks.

Further, in embodiments of this application, the process of modifying the one or more initial reconstructed blocks to determine the one or more reference blocks may include: determining one or more modification parameter vectors according to one or more candidate templates corresponding to the one or more block vectors; and modifying the one or more initial reconstructed blocks according to the one or more modification parameter vectors to determine the one or more reference blocks.

Further, in embodiments of this application, the process of determining one or more modification parameter vectors according to one or more candidate templates corresponding to the one or more block vectors may include: determining an autocorrelation matrix corresponding to the candidate template according to a sample value in the candidate template; determining a cross-correlation vector according to a sample value in the first template and the sample value in the candidate template; and determining the modification parameter vector according to the autocorrelation matrix and the cross-correlation vector.

It may be understood that, in embodiments of this application, the process of modifying the initial reconstructed block may include: directly performing filtering processing on the initial reconstructed block. A filtering method used in performing filtering processing may include: a conventional filtering method, such as bilateral filtering or mean filtering; or neural network-based filtering enhancement.

It may be understood that, in embodiments of this application, the process of modifying the initial reconstructed block may include: modifying the matching reconstructed block (initial reconstructed block) by using matching template information (candidate template).

For example, in embodiments of this application, the process of modifying the matching reconstructed block by using the matching template information may include: for each candidate template refTₙ and a corresponding candidate reconstructed block (initial reconstructed block) RefBlockₙ, calculating a modification parameter vector Cₙ by using the candidate template refTₙ and the current encoding block template (a first template of the current block) curT, performing weighted fusion on the modification parameter vector Cₙ and the candidate reconstructed block RefBlockₙ to obtain a finally modified reconstructed block RefBlock ′n, that is, obtaining the reference block RefBlock ′n of the current block.

In some embodiments, the modification parameter vector Cₙ may be derived by minimizing the MSE between the reconstructed value of the candidate template refTₙ and a sample value of a template to be predicted.

It may be understood that, in embodiments of this application, the modification parameter vector Cₙ may be considered as an L-tap filter.

In some embodiments, when the modification parameter vector Cₙ is calculated, for each candidate template refTₙ, n=0, 1 . . . , N−1, the process of minimizing the MSE may include: inputting an autocorrelation matrix of the candidate template sample refT, and a cross-correlation vector between the candidate template sample refT and an adjacent template sample curT of the current encoding block, to output the weight of the candidate reconstructed block corresponding to the current candidate template.

Schematically, in embodiments of this application, the MSE is calculated as follows:

$$MSE = \frac{1}{K} {\sum }_{k = 0}^{K - 1} {( {refpredT}_{k} - curT )}^{2} = \frac{1}{K} {\sum }_{k = 0}^{K - 1} {( {\sum }_{l = 0}^{L - 1} {c}_{l} \cdot {refT}_{k} - curT )}^{2} . \qquad ( 9 )$$

For convenience of representing the calculation formula of MSE, E represents mean squared error MSE, that is:

$$MSE = E [ {( {refpredT}_{k} - {curT}_{k} )}^{2} ] = E [ {( {\sum }_{l = 0}^{L - 1} {c}_{l} * {refT}_{k} - {curT}_{k} )}^{2} ] , \qquad ( 10 )$$

$$k = 0 , 1 , … , K - 1 , l = 0 , … , L - 1.$$

where K represents a quantity of samples in the template.

In some embodiments, the process of deriving a weight C₁ of candidate reconstructed block corresponding to candidate template refT by minimizing the MSE may include the following steps:
(1) First, a partial derivative of C₁ is calculated and let the partial derivative to be 0:

$$\frac{\partial MSE}{\partial {c}_{l}} = E [ 2 ( {\sum }_{l = 0}^{L - 1} {c}_{l} * {refT}_{k} - {curT}_{k} ) * {refT}_{k} ] , l = 0 , 1 , … , L - 1 \qquad ( 11 )$$

$$E [ 2 ( {\sum }_{l = 0}^{L - 1} {c}_{l} * {refT}_{k} - {curT}_{k} ) * {refT}_{k} ] = 0 \qquad ( 12 )$$

the following formula (13) is obtained by induction from formulars (11) and (12):

$${\sum }_{l = 0}^{L - 1} {c}_{l} * E ( {refT}_{k} * {refT}_{k} ) = E ( {curT}_{k} * {refT}_{k} ) . \qquad ( 13 )$$

(2) After the candidate template area refTₙ is determined, the equation obtained in step (1) is expanded into a matrix form:

$$( \begin{matrix}{\sum }_{k ∈ refT ( n )} ( refT [ k ] [ 0 ] \cdot refT [ k ] [ 0 ] ) & {\sum }_{k ∈ refT ( n )} ( refT [ k ] [ 1 ] \cdot refT [ k ] [ 0 ] ) & ⋯ & {\sum }_{k ∈ refT ( n )} ( refT [ k ] [ L - 1 ] \cdot refT [ k ] [ 0 ] ) \\ {\sum }_{k ∈ refT ( n )} ( refT [ k ] [ 0 ] \cdot refT [ k ] [ 1 ] ) & {\sum }_{k ∈ refT ( n )} ( refT [ k ] [ 1 ] \cdot refT [ k ] [ 1 ] ) & ⋯ & {\sum }_{k ∈ refT ( n )} ( refT [ k ] [ L - 1 ] \cdot refT [ k ] [ 1 ] ) \\ ⋮ & ⋮ & ⋱ & ⋮ \\ {\sum }_{k ∈ refT ( n )} ( refT [ k ] [ 0 ] \cdot refT [ k ] [ L - 1 ] ) & {\sum }_{k ∈ refT ( n )} ( refT [ k ] [ 1 ] \cdot refT [ k ] [ L - 1 ] ) & ⋯ & {\sum }_{k ∈ refT ( n )} ( refT [ k ] [ L - 1 ] \cdot refT [ k ] [ L - 1 ] )\end{matrix} ) \cdot$$

$$[ \text{} \begin{matrix}{c}_{0} \\ {c}_{1} \\ ⋮ \\ {c}_{L - 1}\end{matrix} \text{} ] = [ \text{} \begin{matrix}{\sum }_{k ∈ refT ( n )} ( curT [ k ] \cdot refT [ k ] [ 0 ] \\ {\sum }_{k ∈ refT ( n )} ( curT [ k ] \cdot refT [ k ] [ 1 ] \\ ⋮ \\ {\sum }_{k ∈ refT ( n )} ( curT [ k ] \cdot refT [ k ] [ L - 1 ]\end{matrix} \text{} )$$

(3) Both the autocorrelation matrix and the cross-correlation vector in step (2) are known, and a weight coefficient c0, . . . c_{L-1} of the filter may be obtained by solving the linear equation set in step (2), that is, a filter coefficient of a candidate reconstructed block in the modification parameter vector Cₙ.

Correspondingly, for x=0, . . . , nTbW−1, y=0, . . . , nTbH−1, the modified candidate reconstructed block RefBlock ′n is:

$${RefBlock}_{n , x , y}^{′} = {\sum }_{l = 0}^{L - 1} {c}_{l} * {RefBlock}_{n , x , y} . \qquad ( 14 )$$

It should be noted that in embodiments of this application, after N block vectors BV corresponding to the N candidate templates of the current block are determined, N candidate reconstructed blocks (that is, N reference blocks) may be obtained by N BVs, and then weighted fusion is performed on the N candidate reconstructed blocks to obtain a predicted block (that is, a predicted value of the current block) of the current block. The process of generating a final prediction value may include: obtaining N candidate reconstructed blocks (N reference blocks), determining a corresponding weighted fusion weight (weight value), and performing weighted fusion processing to generate the predicted value of the current block.

It may be understood that, in embodiments of this application, the process of determining one or more reference blocks of the current block according to one or more block vectors may include: for N block vectors BVₙ corresponding to the N obtained candidate templates, obtaining N candidate reconstructed blocks (that is, reference blocks) RefBlockₙ from the current picture and/or the reference picture according to the BVₙ, where a horizontal offset of the BVₙ is pXₙ, and a vertical offset of the BVₙ is pYₙ, where n=0, 1, . . . , N−1.

For example, in embodiments of this application, the one or more reference blocks of the current block may be determined by simple translation and copying. A specific operation is as follows: for x=0, . . . , nTbW−1 and y=0, . . . , nTbH−1, a reconstructed sample of a current frame (that is, the reference block of the current block) is determined by using a formula:

$${RefBlock}_{n} [ x ] [ y ] = recSamples [ x + {pX}_{n} ] [ y + {pY}_{n} ] . \qquad ( 15 )$$

Further, in embodiments of this application, the process of determining the predicted values of the current block according to the one or more reference blocks may include: determining one or more weight values corresponding to the one or more reference blocks; and performing weighted fusion processing on the one or more reference blocks by using the one or more weight values to determine a predicted value of the current block.

It should be noted that in embodiments of this application, after the N candidate reconstructed blocks RefBlock (that is, the reference block of the current block) are obtained, weights W for weighted fusion of N candidate reconstructed blocks need to be calculated. The weight value corresponding to the reference block may be determined in multiple manners. For example, the weight may be a predefined value (such as a second preset value), or may be a value obtained by performing adaptive calculation by using a cost value, a sample value, or the like.

In an embodiment, one or more weight values may be determined according to a second preset value. The second preset value may include N values greater than 0. For different reference blocks of the N reference blocks, corresponding weight values may be the same, or may be different, which is not specifically limited in this application.

In an embodiment, one or more weight values may be determined according to one or more candidate templates corresponding to one or more block vectors. Specifically, an autocorrelation matrix corresponding to the candidate template may be determined according to a sample value in the candidate template. Then, a cross-correlation vector may be determined according to a sample value in the first template and the sample value in the candidate template. Further, the weight value may be determined according to the autocorrelation matrix and the cross-correlation vector.

In some embodiments, the weighted fusion weight (weight value) may be derived by minimizing the MSE between the reconstructed value of the candidate template refTₙ and a sample value of a template (first template) refpredTₙ to be predicted.

It should be noted that, to derive the weight more flexibly, a non-linear term and an offset term may be added to a process of deriving the weighted fusion weight.

For example, in embodiments of this application, when the weighted fusion weight is derived, the nonlinear term NonLinearTerm_T is constructed based on a candidate template. One candidate template whose sequence number is 0 may be selected from the N candidate templates for construction. Correspondingly, for m=0, 1 . . . , and M−1, the nonlinear term is expressed by the following formula:

$${NonLinearTerm\_T}_{n , m} = ( {refT}_{n , m} * {refT}_{n , m} + MidVal ) ≫ bitDepth . \qquad ( 16 )$$

In which, n is 0, 1, . . . , or N−1, indicating any one of the N candidate templates; MidVal is 1<<(bitDepth−1), and bitDepth represents a picture bit depth.

For example, in embodiments of this application, for each of candidate reconstructed blocks (reference block) corresponding to the N candidate templates, when a weighted fusion weight is applied, the nonlinear term NonLinearTerm_Block is constructed based on the candidate reconstructed block. A candidate reconstructed block corresponding to a candidate template whose sequence number is 0 may be selected. Correspondingly, for x=0, 1 . . . , nTbW−1, and y=0, . . . , nTbH−1, the nonlinear term may be expressed in the following formula:

$${NonLinearTerm\_Block}_{n , x , y} = ( {refBlock}_{n , x , y} * {refBlock}_{n , x , y} + MidVal ) ≫ bitDepth . \qquad ( 17 )$$

In which, n is 0, 1, . . . , or N−1, indicating a candidate reconstructed block (reference block) corresponding to any one of the N candidate templates.

The offset value Bias in the process of deriving weights and applying weights may be any constant in a picture sample range [0, (1<<bitDepth)−1], for example, Bias may be set to 1<<(bitDepth−1).

Because BiasTerm is a constant, in an actual calculation process, the BiasTerm needs to expanded in a form of matrix. Specifically,

For each of the N candidate templates:

$$for m = 0 , 1 … , and M - 1: B {iasTerm}_{m} = Bias ;$$

for each candidate reconstructed block corresponding to the N candidate templates,

$$for x = 0 , 1 … , nTbW - 1 , y = 0 , … , nTbH - 1: B {iasTerm}_{x , y} = Bias . \qquad ( 19 )$$

It may be understood that, in embodiments of this application, after a non-linear term and an offset term are added, N+2 weights (weight values) need to be derived. For ease of description, a variable P is used to record a weight quantity, where P=N+2. A matching template sample/a non-linear term sample and an offset term sample are collectively referred to as matching reference samples refT_{N} and refT_{N+1}. Therefore, all reference quantities involved in an operation may be uniformly represented as refTₚ. Similarly, the reconstructed block corresponding to the matching template, the reconstructed block corresponding to the matching template involved in the non-linear term, and the offset term are collectively referred to as candidate reconstructed samples refBlockₚ, where p=0, 1, . . . , and P−1.

For example, in embodiments of this application, in a process of minimizing an MSE, an autocorrelation matrix of the first P matching reference samples refT, and a cross-correlation vector of the first P matching reference samples refT and an adjacent template sample curT of the current encoding block are used are inputted, to output a weight of the reconstructed block corresponding to each matching reference term.

The MSE calculation formula is as follows.

For a sample at a same position of each matching reference template, that is, for m=0, 1, . . . , and M−1:

$$MSE = \frac{1}{P} {\sum }_{p = 0}^{P - 1} {( {refpredT}_{p} - curT )}^{2} = \frac{1}{P} {\sum }_{p = 0}^{P - 1} {( {\sum }_{p = 0}^{P - 1} {w}_{p} * {refT}_{p} - curT )}^{2} . \qquad ( 20 )$$

For convenience of representing the calculation formula of MSE, E represents mean squared error MSE, that is:

$$MSE = E [ {( {refpredT}_{p} - curT )}^{2} ] = E [ {( {\sum }_{p = 0}^{P - 1} {w}_{p} \cdot {refT}_{p} - curT )}^{2} ] . \qquad ( 21 )$$

The process of deriving a weight Wₚ of a reconstructed block corresponding to each matching reference sample by minimizing the MSE includes the following steps:
(1) partial derivative on Wₚ is calculated and let the partial derivative to be 0:

$$\frac{\partial MSE}{\partial {w}_{m}} = E [ 2 ( {\sum }_{p = 0}^{P - 1} {w}_{p} \cdot {refT}_{p} - curT ) \cdot {refT}_{p} ] , m = 0 , 1 , … , P - 1 \qquad ( 22 )$$

$$E [ 2 ( {\sum }_{p = 0}^{P - 1} {w}_{p} \cdot {refT}_{p} - curT ) \cdot {refT}_{p} ] = 0 \qquad ( 23 )$$

the following formula (24) is obtained by induction from formulars (22) and (23):

$${\sum }_{p = 0}^{P - 1} {w}_{p} \cdot E ( {refT}_{p} \cdot {refT}_{p} ) = E ( curT \cdot {refT}_{p} ) . \qquad ( 24 )$$

(2) After the matching reference sample areas refT₀, refT₁, and . . . refTₚ₋₁ are determined, the equation obtained in step (1) is expanded into a matrix form:

$$[ \begin{matrix}{\sum }_{i ∈ {refT}_{0}} ( refT [ i ] [ 0 ] \cdot & {\sum }_{i ∈ {refT}_{0}} ( refT [ i ] [ 1 ] \cdot & … & {\sum }_{i ∈ {refT}_{0}} ( refT [ i ] [ P - 1 ] \cdot \\ refT [ i ] [ 0 ] ) & refT [ i ] [ 0 ] ) & & refT [ i ] [ 0 ] ) \\ {\sum }_{i ∈ {refT}_{1}} ( refT [ i ] [ 0 ] \cdot & {\sum }_{i ∈ {refT}_{1}} ( refT [ i ] [ 1 ] \cdot & … & {\sum }_{i ∈ {refT}_{1}} ( refT [ i ] [ P - 1 ] \cdot \\ refT [ i ] [ 1 ] ) & refT [ i ] [ 1 ] ) & & refT [ i ] [ 1 ] ) \\ ⋮ & ⋮ & ⋱ & ⋮ \\ {\sum }_{i ∈ {refT}_{P - 1}} ( refT [ i ] [ 0 ] \cdot & {\sum }_{i ∈ {refT}_{P - 1}} ( refT [ i ] [ 1 ] \cdot & … & {\sum }_{i ∈ {refT}_{P - 1}} ( refT [ i ] [ P - 1 ] \cdot \\ refT [ i ] [ P - 1 ] ) & refT [ i ] [ P - 1 ] ) & & refT [ i ] [ P - 1 ] )\end{matrix} ] \cdot [ \begin{matrix}{w}_{0} \\ {w}_{1} \\ ⋮ \\ {w}_{P - 1}\end{matrix} ] = [ \begin{matrix}{\sum }_{i ∈ {refT}_{0}} ( curT \cdot refT [ i ] [ 0 ] ) \\ {\sum }_{i ∈ {refT}_{1}} ( curT \cdot refT [ i ] [ 1 ] ) \\ ⋮ \\ {\sum }_{i ∈ {refT}_{P - 1}} ( curT \cdot refT [ i ] [ P - 1 ] )\end{matrix} ] .$$

(3) The autocorrelation matrix and the cross-correlation vector in step (2) are known, and weights w0, . . . , w_{P-1} of a reconstructed sample (reference block) corresponding to each matching reference term may be calculated by solving the linear equation set in step (2).

In embodiments of this application, the process of determining one or more weight values according to one or more candidate templates corresponding to one or more block vectors may include: determining a matching cost value between the first template and the candidate template; and determining the weight value according to the matching cost value.

Further, in embodiments of this application, the weights may also be calculated in another manner. For example, a corresponding weight wₙ may be allocated to each candidate reconstructed block (reference block) RefBlockₙ by using a nonlinear weight model according to costs of N matching candidate templates.

It should be noted that, in embodiments of this application, the weight model may include but is not limited to a non-linear normalization function, a non-linear exponential normalization function, and the like.

Schematically, in embodiments of this application, a weight of each candidate reconstructed block (reference block) may be calculated by using the following nonlinear function. In which, input of the weight model is a matching cost between the current encoding block template curT and the candidate template refTₙ. The matching cost includes but is not limited to SAD (refTₙ), MAD (refTₙ), or a correlation coefficient R (refTₙ) between the current encoding block template curT and the candidate template refTₙ.

In some embodiments, a calculation formula of the weight model is as follows:

$${w}_{n} = \frac{\frac{1}{{MAD}_{{refT}_{n}} + offset}}{{\sum }_{n = 0}^{N - 1} \frac{1}{{MAD}_{{refT}_{n}} + offset}} , n = 0 , 1 , ... , N - 1. \qquad ( 25 )$$

In which, offset represents a preset value, for example, offset is 1.

In some embodiments, when the matching cost is normalized correlation coefficient R (refTₙ), the calculation formula of the weight model is as follows:

$${w}_{n} = \frac{{R}_{{refT}_{n}}}{{\sum }_{n = 0}^{N - 1} {R}_{{refT}_{n}}} , n = 0 , 1 , ... , N - 1. \qquad ( 26 )$$

In some embodiments, the Softmax function may also be used as a weight model, and a calculation formula is as follows:

$${w}_{n} = \frac{{e}^{\frac{- {MAD}_{{refT}_{n}}}{S}}}{{\sum }_{n = 0}^{N - 1} {e}^{\frac{- {MAD}_{{refT}_{n}}}{S}}} , n = 0 , 1 , ... , N - 1. \qquad ( 27 )$$

S is a model control parameter. In a certain condition, the parameter S may be adjusted, so as to adjust the weight model. For example, the parameter S may be related to the current block size or the template type.

In some embodiments, in addition to the foregoing nonlinear weight model, a weight of each candidate reconstructed block may also be directly set to an average value, for example:

$${w}_{n} = \frac{1}{N} , n = 0 , 1 , ... , N - 1. \qquad ( 28 )$$

In some embodiments, the weighted fusion weight (weight value) may also be derived by minimizing the MSE between the reconstructed value of the candidate template refTₙ and the sample value of the template (first template) refpredTₙ to be predicted, without adding a nonlinear term and an offset term.

Schematically, in embodiments of this application, if a non-linear term and an offset term are not added, only N weighted (weight values) need to be derived. In a process of minimizing the MSE, an autocorrelation matrix of the first N candidate template samples refT, and the cross-correlation vector between the first P candidate template samples refT and an adjacent template sample curT of the current encoding block are inputted, to output the weight of the candidate reconstructed block corresponding to each candidate template.

In some embodiments, for samples at the same position of each candidate template that is, for m=0, 1, . . . , M−1, the MSE calculation formula is as follows:

$$MSE = \frac{1}{N} {\sum }_{n = 0}^{N - 1} {( {refpredT}_{n} - curT )}^{2} = \frac{1}{N} {\sum }_{n = 0}^{N - 1} {( {\sum }_{n = 0}^{N - 1} {w}_{n} \cdot {refT}_{n} - curT )}^{2} . \qquad ( 29 )$$

For convenience of representing the calculation formula of MSE, E represents mean squared error MSE, that is:

$$MSE = E [ {( {refpredT}_{n} - curT )}^{2} ] = E [ {( {\sum }_{n = 0}^{N - 1} {w}_{n} \cdot {refT}_{n} - curT )}^{2} ] . \qquad ( 30 )$$

The process of deriving the weight Wₙ of the candidate reconstructed block corresponding to each candidate template by minimizing the MSE includes the following steps:
(1) partial derivative on Wₚ is calculated and let the partial derivative to be 0:

$$\frac{\partial MSE}{\partial {w}_{m}} = E [ 2 ( {\sum }_{n = 0}^{N - 1} {w}_{n} \cdot {refT}_{n} - curT ) \cdot {refT}_{n} ] , m = 0 , 1 , … , N - 1 \qquad ( 31 )$$

$$E [ 2 ( {\sum }_{n = 0}^{N - 1} {w}_{n} \cdot {refT}_{n} - curT ) \cdot {refT}_{n} ] = 0 \qquad ( 32 )$$

the following formular (33) is obtained by induction from formulars (31 and (32):

$${\sum }_{n = 0}^{N - 1} {w}_{n} \cdot E ( {refT}_{n} \cdot {refT}_{n} ) = E ( curT \cdot {refT}_{n} ) . \qquad ( 33 )$$

(2) After the candidate template areas refT₀, refT₁, and . . . refT_{N-1} are determined, the equation obtained in (1) is expanded into a matrix form:

$$[ \begin{matrix}{\sum }_{i ∈ {refT}_{0}} ( refT [ i ] [ 0 ] \cdot & {\sum }_{i ∈ {refT}_{0}} ( refT [ i ] [ 1 ] \cdot & … & {\sum }_{i ∈ {refT}_{0}} ( refT [ i ] [ N - 1 ] \cdot \\ refT [ i ] [ 0 ] ) & refT [ i ] [ 0 ] ) & & refT [ i ] [ 0 ] ) \\ {\sum }_{i ∈ {refT}_{1}} ( refT [ i ] [ 0 ] \cdot & {\sum }_{i ∈ {refT}_{1}} ( refT [ i ] [ 1 ] \cdot & … & {\sum }_{i ∈ {refT}_{1}} ( refT [ i ] [ N - 1 ] \cdot \\ refT [ i ] [ 1 ] ) & refT [ i ] [ 1 ] ) & & refT [ i ] [ 1 ] ) \\ ⋮ & ⋮ & ⋱ & ⋮ \\ {\sum }_{i ∈ {refT}_{N - 1}} ( refT [ i ] [ 0 ] \cdot & {\sum }_{i ∈ {refT}_{N - 1}} ( refT [ i ] [ 1 ] \cdot & … & {\sum }_{i ∈ {refT}_{N - 1}} ( refT [ i ] [ N - 1 ] \cdot \\ refT [ i ] [ N - 1 ] ) & refT [ i ] [ N - 1 ] ) & & refT [ i ] [ N - 1 ] )\end{matrix} ] \cdot [ \begin{matrix}{w}_{0} \\ {w}_{1} \\ ⋮ \\ {w}_{N - 1}\end{matrix} ] = [ \begin{matrix}{\sum }_{i ∈ {refT}_{0}} ( curT \cdot refT [ i ] [ 0 ] ) \\ {\sum }_{i ∈ {refT}_{1}} ( curT \cdot refT [ i ] [ 1 ] ) \\ ⋮ \\ {\sum }_{i ∈ {refT}_{N - 1}} ( curT \cdot refT [ i ] [ N - 1 ] )\end{matrix} ]$$

(3) The autocorrelation matrix and the cross-correlation vector in step (2) are known, and weights w0, . . . , w_{N-1} of the reconstructed sample corresponding to each candidate template may be calculated by solving the linear equation set in step (2).

In some embodiments, the weighted fusion weight (weight value) may also be derived by minimizing the MSE between the reconstructed value of the candidate template refTₙ and the sample value of the template (first template) refpredTₙ to be predicted, by adding only the offset term and not adding non-linear term.

Schematically, in embodiments of this application, if only an offset item is added and no non-linear item is added, N+1 weights (weight values) need to be derived. For ease of description, a variable P is used to record a quantity of weights, where P=N+1. A candidate template sample/offset item sample is collectively referred to as a matching reference sample refT_{N} and refT_{N}+1. Therefore, all reference terms involved in the operation may be uniformly represented as refTₚ. Similarly, a candidate reconstructed block corresponding to the candidate template and an offset term are collectively referred to as candidate reconstructed samples refBlockₚ, where p=0, 1, . . . , and P−1.

In some embodiments, in the process of minimizing the MSE, an autocorrelation matrix of the first P matching reference samples refT, and a cross-correlation vector between the first P matching reference samples refT and an adjacent template sample curT of the current encoding block are inputted, to output the weight of the reconstructed block corresponding to each matching reference term.

In some embodiments, for samples at the same position of each candidate template, that is, for m=0, 1 . . . , M−1, the MSE calculation formula is as follows:

$$MSE = \frac{1}{P} {\sum }_{p = 0}^{P - 1} {( {refpredT}_{p} - curT )}^{2} = \frac{1}{P} {\sum }_{p = 0}^{P - 1} {( {\sum }_{p = 0}^{P - 1} {w}_{p} \cdot {refT}_{p} - curT )}^{2} . \qquad ( 34 )$$

For convenience of representing the calculation formula of MSE, E represents mean squared error MSE, that is:

$$MSE = E [ {( {refpredT}_{p} - curT )}^{2} ] = E [ {( {\sum }_{p = 0}^{P - 1} {w}_{p} \cdot {refT}_{p} - curT )}^{2} ] . \qquad ( 35 )$$

The process of deriving the weight Wₚ of the reconstructed block corresponding to each matching reference sample by minimizing the MSE includes the following steps:
(1) partial derivative on Wₚ is calculated and let the partial derivative to be 0:

$$\frac{\partial MSE}{\partial {w}_{m}} = E [ 2 ( {\sum }_{p = 0}^{P - 1} {w}_{p} \cdot {refT}_{p} - curT ) \cdot {refT}_{p} ] , m = 0 , 1 , … , P - 1 \qquad ( 36 )$$

$$E [ 2 ( {\sum }_{p = 0}^{P - 1} {w}_{p} \cdot {refT}_{p} - curT ) \cdot {refT}_{p} ] = 0 \qquad ( 37 )$$

the following formular (38) is obtained by induction from formulars (36) and (37):

$${\sum }_{p = 0}^{P - 1} {w}_{p} \cdot E ( {refT}_{p} \cdot {refT}_{p} ) = E ( curT \cdot {refT}_{p} ) \qquad ( 38 )$$

(2) After the matching reference template areas refT₀, refT₁, and . . . refTₚ₋₁ are determined, the equation obtained in (1) is expanded into a matrix form:

$$[ \begin{matrix}{\sum }_{i ∈ {refT}_{0}} ( \begin{matrix}refT [ i ] [ 0 ] \cdot \\ refT [ i ] [ 0 ]\end{matrix} ) & {\sum }_{i ∈ {refT}_{0}} ( \begin{matrix}refT [ i ] [ 0 ] \cdot \\ refT [ i ] [ 0 ]\end{matrix} ) & … & {\sum }_{i ∈ {refT}_{0}} ( \begin{matrix}refT [ i ] [ P - 1 ] \cdot \\ refT [ i ] [ 0 ]\end{matrix} ) \\ {\sum }_{i ∈ {refT}_{1}} ( \begin{matrix}refT [ i ] [ 0 ] \cdot \\ refT [ i ] [ 1 ]\end{matrix} ) & {\sum }_{i ∈ {refT}_{1}} ( \begin{matrix}refT [ i ] [ 1 ] \cdot \\ refT [ i ] [ 1 ]\end{matrix} ) & … & {\sum }_{i ∈ {refT}_{1}} ( \begin{matrix}refT [ i ] [ P - 1 ] \cdot \\ refT [ i ] [ 1 ]\end{matrix} ) \\ ⋮ & ⋮ & ⋱ & ⋮ \\ {\sum }_{i ∈ {refT}_{P - 1}} ( \begin{matrix}refT [ i ] [ 0 ] \cdot \\ refT [ i ] [ P - 1 ]\end{matrix} ) & {\sum }_{i ∈ {refT}_{P - 1}} ( \begin{matrix}refT [ i ] [ 1 ] \cdot \\ refT [ i ] [ P - 1 ]\end{matrix} ) & … & {\sum }_{i ∈ {refT}_{P - 1}} ( \begin{matrix}refT [ i ] [ P - 1 ] \cdot \\ refT [ i ] [ P - 1 ]\end{matrix} )\end{matrix} ] \cdot [ \text{} \begin{matrix}{w}_{0} \\ {w}_{1} \\ ⋮ \\ {w}_{P - 1}\end{matrix} ] = [ \begin{matrix}{\sum }_{i ∈ {refT}_{0}} ( \begin{matrix}refT [ i ] [ 0 ] \cdot \\ refT [ i ] [ 0 ]\end{matrix} ) \\ {\sum }_{i ∈ {refT}_{1}} ( \begin{matrix}refT [ i ] [ 0 ] \cdot \\ refT [ i ] [ 1 ]\end{matrix} ) \\ ⋮ \\ {\sum }_{i ∈ {refT}_{P - 1}} ( \begin{matrix}refT [ i ] [ 0 ] \cdot \\ refT [ i ] [ P - 1 ]\end{matrix} )\end{matrix} ]$$

(3) The autocorrelation matrix and the cross-correlation vector in step (2) are known, and weights w0, . . . , w_{P-1} of the reconstructed sample corresponding to each matching reference term may be calculated by solving the linear equation set in step (2).

In step 104: a reconstructed value of the current block is determined according to the predicted value of the current block.

In embodiments of this application, after the one or more reference blocks of the current block is determined according to the one or more block vectors, and the predicted value of the current block is determined according to the one or more reference blocks, the reconstructed value of the current block may be further determined according to the predicted value of the current block.

It should be noted that in embodiments of this application, the bitstream may be decoded first to determine the prediction difference (residual) corresponding to the current block. Then, the reconstructed value of the current block may be further determined according to the residual and the predicted value.

In conclusion, the foregoing decoding method proposed in step 101 to step 104 performs improvement and optimizing on a common Intra TMP technology; and an Intra TMP Fusion prediction manner is proposed by using weighted fusion. In a process of searching for in the search area and determining the block vector BV, at least one block vector of the current block may be determined, that is, multiple block vectors may be determined. In addition, in a process of generating the predicted value, weighted fusion processing is performed on at least one reference block corresponding to the at least one block vector to obtain the predicted value of the current block, thereby determining a reconstructed value of the current block.

That is, embodiments of this application propose an Intra TMP Fusion technology. After N block vectors BV corresponding to the N candidate matching templates with a minimum matching cost are found in a predefined range by using a current encoding block template (a first template of the current block), N candidate reconstructed block (N reference blocks) corresponding to the N candidate matching templates (the N candidate templates) are found by using N BVs, and then weighted fusion is performed on the N candidate reconstructed blocks by using specific weights to obtain a weighting result. The weighting result serves as a predicted block (predicted value) of the current block.

It may be understood that the Intra TMP Fusion method provided in embodiments of this application can improve prediction value accuracy. After N block vectors BV corresponding to the N candidate matching templates with a minimum matching cost are found in a predefined range by using the current encoding block template (the first template of the current block), the N candidate reconstructed blocks (the N reference blocks) corresponding to the N candidate matching templates (the N candidate templates) are found by using the N BVs; and weighted fusion is performed on the candidate reconstructed blocks by using specific weights to obtain a weighting result. The weighting result serves as the predicted block of the current block. In one aspect, reconstructed block information corresponding to different matching templates in a search process is fully considered, instead of merely considering the reconstructed block corresponding to a template with a minimum matching cost. On the other hand, weights are adaptively assigned to candidate reconstructed blocks by matching template information, so that the importance of different reconstructed block information for predicting the current block is fully considered.

It may be understood that in the Intra TMP Fusion method provided in embodiments of this application, candidate reconstructed block information corresponding to different matching templates can be fully utilized in a process of searching for a matching template. In one aspect, reconstructed block information corresponding to different matching templates in a search process is fully utilized, instead of merely considering reconstructed block information corresponding to a template with a minimum matching cost. On the other hand, weights are adaptively assigned to the candidate reconstructed blocks by fully utilizing the matching template information, so that different importance of different reconstructed block information for predicting the current block is fully considered.

It can be learned that the Intra TMP Fusion method provided in embodiments of this application can prevent, to some extent, a decrease in prediction accuracy caused by inaccurate template matching basis or directly copying the reconstructed block as the predicted block.

Compared with a common coding technology, in the Intra TMP Fusion method provided in embodiments of this application, test is conducted in All Intra condition at an interval of 24 frames, a BD-rate change of −0.29%, −0.30%, and −0.39% (that is, an average bit rate change under a same psnr) can be respectively achieved on Y, Cb, and Cr.

Embodiments of this application provide a decoding method. The decoder determines a first template corresponding to the current block; determines, according to the first template, one or more block vectors corresponding to the current block; determines one or more reference blocks of the current block according to the one or more block vectors, and determines predicted values of the current block according to the one or more reference blocks; and determines a reconstructed value of the current block according to the predicted value of the current block. It can be learned that, in embodiments of this application, an Intra TMP Fusion prediction manner is proposed. In which, at least one block vector of the current block may be determined, and the predicted value of the current block may be obtained by using at least one reference block corresponding to the at least one block vector. Therefore, according to the coding method proposed in embodiments of this application, the current block is predicted according to different importance of reconstructed block information corresponding to different matching templates in a search process, so that prediction accuracy can be improved, thereby obtaining an optimal prediction effect.

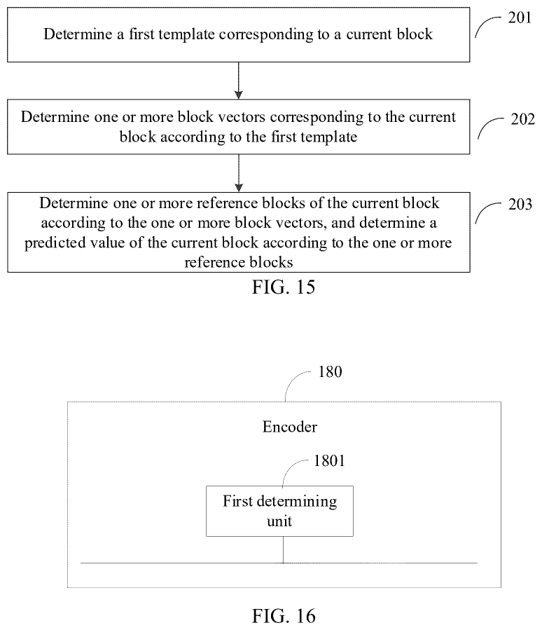

An embodiment of this application provides an encoding method. The encoding method is applied to an encoder. FIG. 15 is a schematic flowchart of an encoding method according to an embodiment of this application. As shown in FIG. 15, the encoding method performed by the encoder may include the following steps S201 to S203.

In step 201, a first template corresponding to a current block is determined.

In embodiments of this application, the first template corresponding to the current block may be first determined. The process of obtaining the first template may include: determining the template type corresponding to the current block, and determining the first template corresponding to the current block according to the template type.

It should be noted that the encoding method in embodiments of this application is applied to the encoder. In addition, the encoding method may include an intra prediction method, and more specifically, a color component prediction method. A video picture may be divided into multiple encoding blocks, and each encoding block may include a first color component, a second color component, and a third color component. In embodiments of this application, the current block refers to an encoding block in a video picture on which intra prediction is to be currently performed.

Herein, when the first color component needs to be predicted, the to-be-predicted component is the first color component; when second color component needs to be predicted, the to-be-predicted component is the second color component; and when the third color component needs to be predicted, the to-be-predicted component is the third color component. In addition, assuming that a first color component is precited for the current block, and the first color component is luma component, that is, the to-be-predicted component is luma component, the current block may also be referred to as a luma block. Alternatively, assuming that a second color component is predicted for the current block, and the second color component is chroma component, that is, the to-be-predicted component is chroma component, the current block may also be referred to as a chroma block.

It should be further noted that in embodiments of this application, the reference sample (Reference Sample) of the current block may be a reference sample adjacent to the current block. The term adjacent herein may refer to being adjacent spatially, but is not limited thereto. For example, the adjacent may be adjacent in a time domain, or adjacent in space and the time domain. The reference sample of the current block may be a reference sample obtained by performing some types of processing on the reference sample which is adjacent spatially, adjacent in the time domain, or adjacent in space and the time domain with the current block, which is not limited in embodiments of this application.

Further, in embodiments of this application, the template type of the current block may be determined according to the reference sample of the current block. The reference sample of the current block includes at least one of: a left adjacent reference sample of the current block, an upper adjacent reference sample of the current block, an upper left adjacent reference sample of the current block, a lower left adjacent reference sample of the current block, or an upper right adjacent reference sample of the current block.

It may be understood that in embodiments of this application, the reference sample of the current block may include an adjacent reconstructed sample of the current block, that is, the adjacent reconstructed sample of the current block may be selected as a template to search for a matching template in a predefined search area.

It should be noted that in embodiments of this application, the reference sample of the current block, that is, the adjacent reconstructed sample of the current block may include: an upper reference sample, an upper left reference sample, an upper right reference sample, a left reference sample, and a lower left reference sample of the current block.

It may be understood that, in embodiments of this application, the process of determining the template type of the current block by using the reference sample of the current block includes: classifying the template and determining the template type according to whether the adjacent reference sample is available.

Further, in embodiments of this application, the process of determining the template type of the current block according to the reference sample of the current block may include: if the left adjacent reference sample of the current block, the upper adjacent reference sample of the current block, and the upper left adjacent reference sample of the current block are all available, determining the template type of the current block as a first value; if the left adjacent reference sample of the current block is available, determining the template type of the current block a second value; if the upper adjacent reference sample of the current block is available, determining the template type of the current block as a third value; if both the left adjacent reference sample of the current block and the upper left adjacent reference sample of the current block are available, determining the template type of the current block as a fourth value; if both the left adjacent reference sample of the current block and the lower left adjacent reference sample of the current block are available, determining the template type of the current block as a fifth value; and if both the upper adjacent reference sample of the current block and the upper right adjacent reference sample of the current block are available, determining the template type of the current block as a sixth value.

It should be noted that, in embodiments of this application, the first value, the second value, the third value, the fourth value, the fifth value, and the sixth value may be any value, which is not specifically limited in this application. For example, values of the first value, the second value, the third value, the fourth value, the fifth value, and the sixth value may be respectively 1, 2, 3, 4, 5, and 6.

For example, in embodiments of this application, refTemplateType may be used to represent a template type. Correspondingly, as shown in FIG. 3, block that is filled with a grid is the current block, and an adjacent area of the current block is a template T. Six template types are shown herein.

For example, the six template types are as follows. When the upper left reference sample, the upper reference sample, and the left reference sample are all available, a value of refTemplateType is 1, and a template shape is shown by (a) in FIG. 3. When only the left reference sample is available, the value of refTemplateType is 2, and the template shape is shown by (b) in FIG. 3. When only the upper reference sample is available, the value of refTemplateType is 3, and the template shape is shown by (c) in FIG. 3. When only the left reference sample and the upper left reference sample are available, the value of refTemplateType is 4, and the template shape is shown by (d) in FIG. 3; when only the left reference sample and the lower left reference sample are available, the value of refTemplateType is 5, and the template shape is shown by (e) in FIG. 3; and when only the upper reference sample and the upper right reference sample are available, the value of refTemplateType is 6, and the template shape is shown by (f) in FIG. 3.

Further, in embodiments of this application, the process of determining the first template corresponding to the current block according to the template type may include: determining a template reference sample of the current block according to the template type and a template size corresponding to the template type; and determining the first template of the current block according to the template reference sample.

It should be noted that in embodiments of this application, the first template of the current block may include the template reference sample of the current block. The template reference sample of the current block may be determined according to the template type of the current block and the template size corresponding to the template type.

It should be noted that in embodiments of this application, the first template of the current block may be formed by a reconstructed sample located in the following one or more areas of the current block: an upper area, an upper right area, a left area, a lower left area, or an upper left area, that is, may be formed by the reference sample of the current block.

It should be noted that in embodiments of this application, the template size corresponding to the template type may be preset. For example, when the left template is acquired, the template width templateW_size may be set to 4; and when the upper template is acquired, the template height templateH_size may be set to 4.

Correspondingly, in embodiments of this application, with reference to the value of the template type refTemplateType of the current block and the template size corresponding to the refTemplateType, reconstructed samples to be obtained as template reference samples of the current block can be determined, thereby determining a corresponding first template.

For example, in embodiments of this application, when a value of refTemplateType is 1, left, upper left, and upper reconstructed samples of the current block may be selected. When the value of refTemplateType is 2, only four columns of reconstructed samples on left of the current block are obtained. When the value of refTemplateType is 3, only four rows of reconstructed samples above the current coding block are obtained.

Certainly, the preset value of the template size may be any integer greater than 0, and is not limited to 4. This is not specifically limited in this application.

It may be understood that, in embodiments of this application, with reference to the template type of the current block and the corresponding template size, the template reference sample of the current block determined from the reference samples of the current block may be the first template corresponding to the current block.

In step 202, according to the first template, one or more block vectors corresponding to the current block are determined.

In embodiments of this application, after the first template corresponding to the current block is determined, one or more block vectors corresponding to the current block may be further determined according to the first template.

It should be noted that in embodiments of this application, a search process of the block vector may include: an initialization process, determining a search area of the first template in a current frame, and performing searching and determining one or more best block vectors in the search area. Therefore, when performing search processing, an initialization operation needs to be completed first.

For example, as shown in FIG. 5, nTbW and nTbH represent sizes of the current block, templateW_size and templateH_size represent template sizes, and uiPatchWidth and uiPatchHeight represent sizes of a block that include the current block and a template of the current block.

Correspondingly, during the initialization, uiPatchWidth is initialized to nTbW+templateW_size, and uiPatchHeight is initialized to nTbH+templateH_size. In which, templateW_size and templateH_size may be fixed constants, or may be dynamically adjusted according to encoding block sizes. In which, templateW_size and templateH_size may be equal or not. For example, templateW_size=4 and templateH_size=4. Alternatively, when the width of the coding block is greater than 8, templateW_size is set to 4. When the width of the coding block is less than or equal to 8, templateW_size is set to 2. When the height of the coding block is greater than 8, templateH_size is set to 4. When the height of the coding block is less than or equal to 8, templateH_size is set to 2.

Further, a cost threshold between initialization templates is represented by diffThreshold. For example, when the cost function is SAD, the threshold may be calculated according to diffThreshold=((1<<bitDepth)>>2)×(uiPatchHeight×uiPatchWidth−nTbH×nTbW). When a picture bit depth bitDepth is 10, diffThreshold indicates that a maximum distortion of each sample in the template area is 256.

Further, a location CtbRsX, ctbRsY of an encoding tree block CTB, in which the current block CB is located, is initialized.

Further, a location offset of the current block CB within the current CTB is initialized:

$$OffsetLCBY = yTbCmp - ctbRsY , offsetLCBX = xTbCmp - ctbRsX .$$

Further, iTemplateSizeH is initialized into templateH_size and iTemplateSizeW is initialized into templateW_size.

Further, iBvShift is initialized, and iBvShift represents block vector BV accuracy. For example, the accuracy of the BV may be integer sample accuracy, and in this case, iBvShift is 0. The BV accuracy may also be sub-sample precision. For example, when iBvShift is 1, it indicates ½ sample accuracy; and when iBvShift is 2, it indicates ¼ sample accuracy. This is not specifically limited herein.

Further, a preset search range of the template is initialized, and the preset search range of the template may be set to a fixed size, or the search range may be dynamically adjusted according to a coding block size. For example, searchRangeWidth=TMP_SEARCH_RANGE_MULT_FACTOR×nTbW, searchRangeHeight=TMP_SEARCH_RANGE_MULT_FACTOR×nTbH. A value of TMP_SEARCH_RANGE_MULT_FACTOR may be a preset value, for example, is set to 5.

Further, in embodiments of this application, the process of determining the one or more block vectors corresponding to the current block according to the first template may include: determining the preset search area according to the first template, and performing a search in a preset search area to determine the one or more block vectors.

It should be noted that, in embodiments of this application, the search area is a reconstructed part of the current picture, and is limited by a size of a search range. As shown in FIG. 6, a background area filled with a dark color is a reconstructed area, a background block filled with black is the current block, and a dashed line box is a search range window. Therefore, the search area of the IntraTMP technology is not greater than an overlapping part of the reconstructed area represented by the dark color and the area represented by the dashed line box.

It can be learned that the search area of the current block template may be a reconstructed part of a CTB in which the current block is located, or may be another reconstructed CTB area. The search area herein is actually a set of all search points. The search area cannot be represented by a single rectangular area generally. In specific implementation, a search may be performed in multiple rectangular areas, and the best matching block and the best block vector are obtained according to search results of different regions.

For example, as shown in FIG. 7, eight different sub-area division manners are shown herein. A background block filled with black is the current block; in (a), (b), (c), (d), and (f), the search area is divided into four sub-search areas; and in (e), (g), and (h), the search area is divided into three sub-search areas. Herein, different patterns represent different sub-search areas.

In FIG. 7, for (a), (b), (c), and (d), all available search ranges are considered; and for (e), (f), (g), and (h), no search is performed in upper area and the left area of the current block.

For example, it is assumed that different sub-search areas are represented by using a regionId. Since a template sample of the current encoding block needs to be obtained from a picture reconstructed area and a reconstructed block sample corresponding to the template also needs to be obtained from the reconstructed area, locations that can be found in the search areas represented by different regionIds are determined according to a location (xTbCmp, yTbCmp) of the current block, a size (nTbW, nTbH) of the current encoding block, a size (picWidth, picHeight) of the current picture, a size (CtbSizeW, CtbSizeH) of a CTB in which the current block is located, a preset search range (search RangeWidth, searchRangeHeight) of the template, and a location offset (offsetLCBY, offsetLCBX) of the current block in the current CTB, thereby determining a block vector BV. Specifically, iVerMin and iVerMax are respectively used to represent a minimum absolute coordinate and a maximum absolute coordinate than can be found in a vertical direction, and iHorMin and iHorMax are respectively used to represent a minimum absolute coordinate and a maximum absolute coordinate that can be found in a horizontal direction. Values of iVerMin, iVerMax, iHorMin, and iHorMax are different in search areas represented by different regionIds.

In some embodiments, as shown by (f) in FIG. 7 for example, the search area is divided into four sub-search areas. An implementation manner of the sub-search area is as follows.

When regionId is equal to 0, iVerMin, iVerMax, iHorMin, and iHorMax may be calculated as follows:

$$iHor {Max}_{0} = min ( ( xTbCmp + searchRangeWidth ) << iBvShift , ( picWidth - nTbW ) << iBvShift ) ;$$

$$iHor {Min}_{0} = max \text{} ( ( iTemplateSizeW ) << iBvShift , ( xTbCmp - searchRangeWidth ) << iBvShift ) ;$$

$$iVer {Max}_{0} = ( yTbCmp - nTbH - offsetLCBY ) << iBvShift ;$$

$$iVer {Min}_{0} = max ( ( ( iTemplateSizeH ) << iBvShift ) , \text{} ( ( yTbCmp - searchRangeHeight ) << iBvShift ) ) .$$

When regionId is equal to 1, iVerMin, iVerMax, iHorMin, and iHorMax may be calculated as follows:

$$iHor {Min}_{1} = max ( ( iTemplateSizeW ) << iBvShift , ( xTbCmp - searchRangeWidth ) << iBvShift ) ;$$

$$iHor {Max}_{1} = ( xTbCmp - offsetLCBX - nTbW ) << iBvShift ;$$

$$iVer {Min}_{1} = ( yTbCmp + 1 ) << iBvShift ;$$

$$iVer {Max}_{1} = min ( picHeight - nTbH , ( yTbCmp - offsetLCBY + CtbSizeH - nTbH ) << iBvShift ) .$$

When regionId is equal to 2, iVerMin, iVerMax, iHorMin, and iHorMax may be calculated as follows:

$$iHor {Max}_{2} = ( xTbCmp - offsetLCBX - nTbW ) << iBvShift ;$$

$$iHor {Min}_{2} = max ( ( iTemplateSizeW ) << iBvShift , ( xTbCmp - searchRangeWidth ) << iBvShift ) ;$$

$$iVer {Min}_{2} = max ( ( iTemplateSizeH ) << iBvShift , ( yTbCmp - nTbH - offsetLCBY ) << iBvShift ) ;$$

$$iVer {Max}_{2} = ( yTbCmp ) << iBvShift .$$

When regionId is equal to 3, iVerMin, iVerMax, iHorMin, and iHorMax may be calculated as follows:

$$iHor {Min}_{3} = max ( ( iTemplateSizeW ) << iBvShift , ( xTbCmp - offsetLCBX - nTbW + 1 << iBvShift ) ;$$

$$iHor {Max}_{3} = ( xTbCmp - nTbW ) << iBvShift ;$$

$$iVer {Min}_{3} = max ( ( ( iTemplateSizeH ) << iBvShift ) , ( yTbCmp - offsetLCBY - nTbH + 1 ) << iBvShift ) ;$$

$$iVer {Max}_{3} = ( yTbCmp - nTbH ) << iBvShift .$$

In actual application, iHorMin_{regionId}, iHorMax_{regionId}, iVerMin_{regionId}, and iVerMax_{regionId} herein respectively represent left edges, right edges, upper edges, and lower edges of different sub-search areas.

To intuitively describe different sub-search areas corresponding to different regionIds, as shown by FIG. 8, R1, R2, R3, and R4 represent four different sub-search areas. It should be noted that FIG. 8 shows a sample range in which upper left corner samples of the block may be aligned.

In some embodiments, as shown by (a) in FIG. 7 for example, the search area is divided into four sub-search areas. An implementation manner of the sub-search area is as follows.

When regionId is equal to 0, iVerMin, iVerMax, iHorMin, and iHorMax may be calculated as follows:

$$iHor {Max}_{0} = min ( ( xTbCmp + searchRangeWidth ) << iBvShift , ( ( picWidth - nTbW ) << iBvShift ) )$$

$$iHor {Min}_{0} = max ( ( iTemplateSizeW ) << iBvShift , ( xTbCmp - searchRangeWidth ) << iBvShift )$$

$$iVer {Max}_{0} = ( yTbCmp - nTbH - offsetLCBY ) << iBvShift$$

$$iVer {Min}_{0} = max ( ( ( iTemplateSizeH ) << iBvShift ) , ( ( yTbCmp - searchRangeHeight ) << iBvShift ) .$$

When regionId is equal to 1, iVerMin, iVerMax, iHorMin, and iHorMax may be calculated as follows:

$$iHor {Min}_{1} = max ( ( iTemplateSizeW ) << iBvShift , ( xTbCmp - searchRangeWidth ) << iBvShift )$$

$$iHor {Max}_{1} = ( xTbCmp - offsetLCBX - nTbW ) << iBvShift ;$$

$$iVer {Min}_{1} = ( yTbCmp + 1 ) << iBvShift ;$$

$$iVer {Max}_{1} = min ( picHeight - nTbH , ( yTbCmp - offsetLCBY + CtbSizeH - nTbH ) << iBvShift ) .$$

When regionId is equal to 2, iVerMin, iVerMax, iHorMin, and iHorMax may be calculated as follows:

$$iHor {Max}_{2} = ( xTbCmp - nTbW ) << iBvShift ;$$

$$iHor {Min}_{2} = max ( ( iTemplateSizeW ) << iBvShift , ( xTbCmp - searchRangeWidth ) << iBvShift ) ;$$

$$iVer {Min}_{2} = max ( ( iTemplateSizeH ) << iBvShift , ( yTbCmp - nTbH ) << iBvShift ) ;$$

$$iVer {Max}_{2} = ( yTbCmp ) << iBvShift .$$

When regionId is equal to 3, iVerMin, iVerMax, iHorMin, and iHorMax may be calculated as follows:

$$iHor {Min}_{3} = max ( ( iTemplateSizeW ) << iBvShift , ( xTbCmp - searchRangeWidth ) << iBvShift ) ;$$

$$iHor {Max}_{3} = ( yTbCmp ) << iBvShift ;$$

$$iVer {Min}_{3} = max ( ( iTemplateSizeH ) << iBvShift , ( yTbCmp - offsetLCBY - nTbH ) + 1 ) << iBvShift ) ;$$

$$iVer {Max}_{3} = ( yTbCmp - nTbH ) << iBvShift .$$

In actual application, iHorMin_{regionId}, iHorMax_{regionId}, iVerMin_{regionId}, and iVerMax_{regionId} herein respectively represent left edges, right edges, upper edges, and lower edges of different sub-search areas.

To intuitively describe different sub-search areas corresponding to different regionIds, as shown by FIG. 8, R1, R2, R3, and R4 represent four different sub-search areas. It should be noted that FIG. 8 shows a sample range in which upper left corner samples of the block may be aligned.

In some embodiments, as shown by (b) in FIG. 7 for example, the search area is divided into four sub-search areas. An implementation manner of the sub-search area is as follows.

When regionId is equal to 0, iVerMin, iVerMax, iHorMin, and iHorMax may be calculated as follows:

$$iHor Max 0 = min ( ( xTbCmp + searchRangeWidth ) << iBvShift , ( ( picWidth - nTbW ) << iBvShift ) )$$

$$iHor Min 0 = max ( ( iTemplateSizeW ) << iBvShift , ( xTbCmp - searchRangeWidth ) << iBvShift )$$

$$iVer Max 0 = ( yTbCmp - nTbH - offsetLCBY ) << iBvShift$$

$$iVer Min 0 = max ( ( ( iTemplateSizeH ) << iBvShift ) , ( ( yTbCmp - searchRangeHeight ) << iBvShift ) ) .$$

When regionId is equal to 1, iVerMin, iVerMax, iHorMin, and iHorMax may be calculated as follows:

$$iHor Min 1 = max ( ( iTemplateSizeW ) << iBvShift , ( xTbCmp - searchRangeWidth ) << iBvShift )$$

$$iHor Max 1 = ( xTbCmp - offsetLCBX - nTbW ) << iBvShift ;$$

$$iVer Min 1 = ( yTbCmp + 1 ) << iBvShift ;$$

$$iVer Max 1 = min ( picHeight - nTbH , ( yTbCmp - offsetLCBY + CtbSizeH - nTbH ) << iBvShift ) .$$

When regionId is equal to 2, iVerMin, iVerMax, iHorMin, and iHorMax may be calculated as follows:

$$iHor Max 2 = ( xTbCmp - nTbW ) << iBvShift ;$$

$$iHor Min 2 = max ( ( iTemplateSizeW ) << iBvShift , ( xTbCmp - searchRangeWidth ) << iBvShift ) ;$$

$$iVer Min 2 = max ( ( iTemplateSizeH ) << iBvShift , ( yTbCmp - nTbH - offsetLCBY ) << iBvShift ) ;$$

$$iVer Max 2 = ( yTbCmp ) << iBvShift .$$

When regionId is equal to 3, iVerMin, iVerMax, iHorMin, and iHorMax may be calculated as follows:

$$iHor Min 3 = max ( ( iTemplateSizeW ) << iBvShift , ( xTbCmp - nTbW + 1 ) << iBvShift ) ;$$

$$iHor Max 3 = ( xTbCmp ) << iBvShift ;$$

$$iVer Min 3 = max ( ( ( iTemplateSizeH ) << iBvShift ) , ( yTbCmp - offsetLCBY - nTbH + 1 ) << iBvShift ) ;$$

$$iVer Max 3 = ( yTbCmp - nTbH ) << iBvShift .$$

In actual application, iHorMin_{regionId}, iHorMax_{regionId}, iVerMin_{regionId}, and iVerMax_{regionId} herein respectively represent left edges, right edges, upper edges, and lower edges of different sub-search areas.

To intuitively describe different sub-search areas corresponding to different regionIds, as shown by FIG. 13, R1, R2, R3, and R4 represent four different sub-search areas. It should be noted that FIG. 13 shows a sample range in which upper left corner samples of the block may be aligned.

Further, in embodiments of this application, the process of performing a search in a preset search area to determine one or more block vectors may include: traversing a search point in the preset search area, and determining a matching cost value between a matching template corresponding to the search point in the preset search area and a first template according to a preset matching criterion; and determining one or more block vectors and one or more candidate templates corresponding to the one or more block vectors according to the matching cost value.

It should be noted that, in embodiments of this application, a quantity of block vectors determined by searching may be one or more. For example, N block vectors of the current block may be determined, where N is an integer greater than 0.

Correspondingly, in embodiments of this application, the process of performing a search in a preset search area to determine one or more block vectors may include: determining a preset quantity N corresponding to the candidate template; traversing a search point in the preset search area, and determining, according to the preset matching criterion, a matching cost value between the matching template corresponding to the search point in the preset search area and the first template; and determining N block vectors and N candidate templates corresponding to the N block vectors according to the matching cost value.

That is, in embodiments of this application, the process of performing a search in the preset search area and determining the N block vectors corresponding to the N matching templates that is, the process of performing a search in the search area (the preset search area) and determining the block vectors BV corresponding to the N matching templates may include: determining a value of a quantity N of candidate templates, determining a matching template comparison criterion, and recording N block vectors BV corresponding to the N matching templates (the N selected candidate templates).

It may be understood that, in embodiments of this application, the process of determining the preset quantity N corresponding to the candidate template may include: determining N according to a preset decision criterion; determining N according to a first preset value; or determining N according to a preset value range.

That is, in embodiments of this application, a value of N needs to be first determined. N herein may be preset as a constant, for example, N is 4. N may also be in a specific value range, for example, N may be any integer in [2, 8]. A range of the N is preset, and N may be determined according to the preset decision criterion at the encoding side. For example, an optimal N value may be determined in a manner in which coarse selection is performed at cost 1, coarse selection is performed at cost 2, coarse selection is performed at cost 3, or fine selection is performed at cost 4, and the optimal N value is transmitted to a decoding side via a bitstream. The costs 1, 2, 3, and 4 may be a cost function for estimating a mode, such as SAD, SATD, MSE, MAD, or RDO. A manner of determining N is not specifically limited in this application.

It should be noted that in embodiments of this application, the preset matching criterion includes any one the following functions for estimating a mode: sum of absolute difference SAD, sum of absolute transformed difference SATD, difference square sum SSE, mean absolute derivation MAD, mean absolute error MAE, mean square error MSE, a normalized correlation coefficient NCC, and the like.

Further, in embodiments of this application, the process of determining the N block vectors and the N candidate templates corresponding to the N block vectors according to the matching cost value, that is, the process of determining the one or more block vectors and the one or more candidate templates corresponding to the one or more block vectors may include: determining N minimum matching cost values from the matching cost value between the matching template corresponding to the search point in the preset search area and the first template; and determining N block vectors and N candidate templates corresponding to the N minimum matching cost values.

It should be noted that in embodiments of this application, for any block vector of the N block vectors, bvXMins and bvXMaxs may respectively represent a minimum offset and a maximum offset of the block vector in a horizontal direction; and bvYMins and bvYMaxs may respectively represent a minimum offset and a maximum offset of the block vector in a vertical direction.

In which, bvXMinsregionId, bvXMaxsregionId, bvYMinsregionId, and bvYMaxsregionId may be calculated by using the determined iVerMinregionId, iVerMaxregionId, iHorMinregionId, and iHorMaxregionId:

$$bvX Min regionId = iHor Min regionId - xTbCmp ;$$

$$bvX Max regionId = iHor Max regionId - xTbCmp ;$$

$$bvY Min regionId = iVer Min regionId - yTbCmp ;$$

$$bvY Max regionId = iVer Max regionId - yTbCmp .$$

In which, bvXMinsregionId, bvXMaxsregionId, bvYMinsregionId, and bvYMaxsregionId determine a horizontal and vertical offset range of the search point relative to the current block, that is, a range of the block vector BV.

It should be further noted that, by traversing a searching point (iPosHor, iPoxVer) in each search area, each block vector BV (including a horizontal component and a vertical component: (PX, pY)) is determined, where pX=iPosHor-xTbCmp and pY=iPosVer−yTbCmp, pX is between bvXMins and bvXMaxs, and pY is between bvYMins and bvYMaxs. In this way, one or more matching reconstructed blocks of the current block may be found in the reconstructed area, and an adjacent reconstructed sample of the one or more matching reconstructed blocks is a matching template. Therefore, a matching cost of the adjacent template of the current block and the adjacent template of the one or more reconstructed blocks is calculated, which is denoted as pDiff.

Further, all search points in all search ranges (regionId=0, 1, 2, and 3) are traversed, to obtain a search point with a minimum matching cost value pDiff by comparison. For the obtained search point, a corresponding matching cost value is indicated by pDiff_BEST, one or more corresponding block vectors BV are indicated by a best block vector BV_BEST (pX_BEST, pY_BEST), and one or more corresponding matching templates are indicated by a best matching template T_BEST. That is, one or more candiate tempaltes are obtained.

It may be understood that in embodiments of this application, after the value of the quantity N of candidate templates is determined, N block vectors BV corresponding to the N candidate templates with a relatively high matching degree need to be selected according to a comparison criterion. That is, different from a common related technology of searching for a matching template and recording a block vector BV, technical solutions of this application are as follows. Multiple block vectors BVₙ are selected and recorded; a matching template is obtained according to the block vector BVₙ (that is, according to the template offsets pXₙ and the pYₙ), a cost of the matching template is calculated, N BVs corresponding to N matching templates whose costs are relatively low are recoded. Herein, the N matching templates are referred to as N candidate templates. The template matching cost (a preset matching criterion) may be one of the following cost functions for estimating a mode: SAD, SATD, MSE, MAD, RDO, a correlation coefficient and so on.

Exemplarily, in embodiments of this application, when the matching cost comparison criterion (the preset matching criterion) is Mean Absolute Difference (Mean Absolute Difference MAD), a calculation formula is as follows:

$$M AD ( refT ) = \frac{1}{M} {\sum }_{m = 0}^{M - 1} \vert {refT}_{m} - c u r {T}_{m} \vert . \qquad ( 3 )$$

In which, refT represents a matching template in a search process, curT represents a current encoding block template (a first template of the current block), M is a quantity of samples of the current encoding block template, and MAD (refT) represents mean absolute difference between the current encoding block template curT and the found matching template.

Correspondingly, in embodiments of this application, the MAD-based screening criterion is: determining by comparing and recording N block vectors BV corresponding to the N matching templates with the lowest MAD cost.

For example, for the N candidate templates, MAD between the n-th candidate template and the current encoding block template is given as follows:

$$M AD ( {refT}_{n} ) = \frac{1}{M} {\sum }_{m = 0}^{M - 1} \vert {refT}_{n , m} - cur {T}_{m} \vert . \qquad ( 4 )$$

In which, refTₙ represents the n-th candidate template, MADrefTₙ(refTₙ) represents the mean absolute difference between the current encoding block template curT and the n-th candidate template, n=0, . . . , N−1.

Exemplarily, in embodiments of this application, when the matching cost comparison criterion (preset match criterion) is the SAD, a calculation formula is as follows:

$$S AD ( refT ) = {\sum }_{m = 0}^{M - 1} \vert {refT}_{m} - c u r {T}_{m} \vert . \qquad ( 5 )$$

The SAD (refT) represents sum of absolute difference between a current encoding block template (a first template of the current block) curT and the found matching template.

Correspondingly, in embodiments of this application, the SAD-based screening criterion is: determining by comparing and recording N block vectors BV corresponding to N matching templates with a relatively low SAD cost.

For example, for the N candidate templates, a SAD between the n-th candidate template and the current encoding block template is given as follows:

$$S AD ( {refT}_{n} ) = {\sum }_{m = 0}^{M - 1} \vert {refT}_{n , m} - cur {T}_{m} \vert . \qquad ( 6 )$$

In which, SAD(refTₙ) represents sum of absolute difference between a current encoding block template and the n-th candidate template.

For example, in embodiments of this application, comparison is performed by using the NCC normalized correlation coefficient as a template matching criterion, and a calculation formula is as follows:

$$R ( refT ) = \frac{{\sum }_{m = 0}^{M - 1} \vert {refT}_{m} - {refT}_{Avg} \vert * \vert {curT}_{m} - {curT}_{Avg} \vert}{\sqrt{{\sum }_{m = 0}^{M - 1} {( {refT}_{m} - {refT}_{Avg} )}^{2}} * \sqrt{{\sum }_{m = 0}^{M - 1} {( {curT}_{m} - {curT}_{Avg} )}^{2}}} . \qquad ( 7 )$$

In which, refT represents a matching template in a search process, curT represents a current encoding block template (a first template of the current block), M represents a quantity of samples of the current encoding block template, refT_{Avg} represents a sample average value of the found matching template, curT_{Avg} represents a sample average value of the current encoding block template, and R(refT) represents a correlation coefficient between the current encoding block template and the found matching template.

Correspondingly, in embodiments of this application, the comparison criterion based on NCC includes: ranking ad recording N block vectors BV corresponding to N matching templates with greater correlation coefficients R.

For the N candidate templates, a correlation coefficient between the n-th candidate template and the current encoding block template is calculated as follows:

$$R ( {refT}_{n} ) = \frac{{\sum }_{m = 0}^{M - 1} \vert {refT}_{n , m} - {refT}_{{n}_{Avg}} \vert * \vert {curT}_{m} - {curT}_{Avg} \vert}{\sqrt{{\sum }_{m = 0}^{M - 1} {( {refT}_{n , m} - {refT}_{{n}_{Avg}} )}^{2}} * \sqrt{{\sum }_{m = 0}^{M - 1} {( {curT}_{m} - {curT}_{Avg} )}^{2}}} . \qquad ( 8 )$$

In which, refTₙ_{_{Avg}} represents a sample average value of the n-th candidate template, R(refTₙ) represents a correlation coefficient between the current encoding block template and the n-th candidate template. It should be noted that a range of the NCC normalized correlation coefficient R is [−1, 1], and a larger R indicates a stronger correlation.

It should be noted that, in embodiments of this application, when searching is performed, a search policy that may be used may include but is not limited to a search manner based on different search step sizes. For example, a coarse search manner based on a first search step size and/or a fine search manner based on a second search step size may be used, where the first search step size is greater than the second search step size.

Further, in embodiments of this application, the block vector and the candidate template may be determined by traversing the search point in the preset search area according to the first search step size. Alternatively, the block vector and the candidate template may be determined by traversing the search point in the preset search area according to the second search step size.

Further, in embodiments of this application, the search point in the preset search area may be traversed first according to the first search step size to determine an initial block vector and an initial matching template corresponding to the initial block vector. Then a first search area is determined according to the initial matching template. The first search area is less than a preset search area. Finally, the search point in the first search area is traversed according to the second search step size to determine the block vector and the candidate template. The first search step size is greater than the second search step size.

That is, in embodiments of this application, the best matching template may be searched for in the search area by using the following search strategy: a search strategy of performing coarse searching first and then fine searching, or performing only fine searching or performing only coarse searching.

For example, in embodiments of this application, the coarse search may include: determining a best coarse matching template in a search area by using a first preset step size (that is, a first search step size, for example, 2), that is, obtaining a final candidate template; or determining a best coarse matching template in a search area by using a template that is downsampled (for example, a downsampling factor is 2), that is, obtaining a final candidate template.

For example, in embodiments of this application, the fine search may include: determining the best fine matching template in the search area by using a second preset step size (that is, a second search step size, for example, 1), that is, obtaining the final candidate template; or determining the best fine matching template near the best coarse matching template after completing the coarse search, that is, obtaining the final candidate template.

For example, in embodiments of this application, if the search policy is to perform only coarse search, coarse search may be performed in a range of each region in which pX is between bvXMinsregionId and bvXMaxsregionId and pY is between bvYMinsregionId and bvYMaxsregionId, by using a step size greater than 1. For example, coarse search is performed at a step of 2 (that is, a first search step is 2), one or more best matching costs obtained by performing template matching are recorded as pDiff_BEST, and one or more corresponding block vectors BV are indicated by a best block vector BV_BEST (pX_BEST, pY_BEST). That is, one or more block vectors corresponding to the current block are obtained by performing searching in the preset search area, and the one or more matching templates corresponding to one or more best matching costs may be used as the final one or more candidate templates.

For example, in embodiments of this application, if the search policy is to perform only fine search, fine search may be performed in a range of each region in which pX is between bvXMinsregionId and bvXMaxsregionId and pY is between bvYMinsregionId and bvYMaxsregionId, by using a step size 1 (that is, the second search step size is 1), for example. One or more best matching costs obtained by performing template matching are recorded as pDiff_BEST, and one or more corresponding block vectors BV are indicated by a best block vector BV_BEST (pX_BEST, pY_BEST). That is, one or more block vectors corresponding to the current block are obtained by performing searching in the preset search area, and the one or more matching templates corresponding to one or more best matching costs may be used as the final one or more candidate templates.

For example, in embodiments of this application, if the search policy is to perform coarse search first and then perform fine search, as shown in FIG. 10. A coarse search may be performed with a step size 2 (that is, the first search step of 2). Then, a best coarse matching template (an initial matching template) obtained by performing template matching is recorded. Then, a best fine matching template may be determined near the best coarse matching template by using a step size 1 (that is, the second search step size is 1). That is, a final candidate template is obtained.

In the coarse search stage, coarse searching may be performed in a range of each area in which pX is between bvXMinsregionId and bvXMaxsregionId and pY is between bvYMinsregionId and bvYMaxsregionId, by using a step size greater than 1. For example, coarse searching is performed by using a step size 2, a best matching cost obtained by performing template matching is recoded as pDiff1_BEST, and a corresponding block vector BV is indicated by a best block vector BV1_BEST (pX1_BEST, pY1_BEST), that is, an initial block vector. A matching template corresponding to the initial block vector is an initial matching template. In this case, a search area in which the best matching search point is located is indicated by bestRegionId.

Subsequently, in the fine search stage, a search may be performed near the best block vector BV1_BEST (initial block vector) obtained by coarse search. That is, a search is performed in the first search area. Therefore, the refined search range TmpRefineRange needs to be determined first, that is, the first search area TmpRefineRange needs to be determined. The refined search range (the first search area TmpRefineRange) may be of a fixed size, or may be related to a current block size. For example, the refined search range may be set to min (nTbW, nTbH)/2, and then a position of a best matching reconstructed block obtained by coarse search is calculated as a reference position of the fine search area: BestPosX=xTbCmp+pX1_BEST, BestPosY=yTbCmp+pY1_BEST.

In embodiments of this application, calculated values of iVerMinbestRegionId, iVerMaxbestRegionId, iHorMinbestRegionId, and iHorMaxbestRegionId may be first obtained according to a value of bestRegionId, and then a new search range iVerMinrefine, iVerMaxrefine, iHorMinrefine, and iHorMaxrefine is obtained according to the location of the best matching block obtained by coarse search. An obtaining method is as follows:

$$iHorMinrefine = max ( iHorMinbestRegionId , BestPosX - TmpRefineRange ) \\ iHorMaxrefine = min ( iHorMaxbestRegionId , BestPosX + TmpRefineRange ) \\ iVerMinrefine = max ( iVerMinbestRegionId , BestPosY - TmpRefineRange ) \\ iVerMaxrefine = min ( iVerMaxbestRegionId , BestPosY + TmpRefineRange ) .$$

Then, the adjusted block vector BVbvXMins, bvXMaxs, bvYMins, and bvYMaxs may be calculated by using iVerMinrefine, iVerMaxrefine, iHorMinrefine, and iHorMaxrefine:

$$bvXMins = iHorMinrefine - xTbCmp ; \\ bvXMaxs = iHorMaxrefine - xTbCmp ; \\ bvYMins = iVerMinrefine - yTbCmp ; \\ bvYMaxs = iVerMaxrefine - yTbCmp .$$

The fine search is performed in a block vector range in which pX is between bvXMinsrefine and bvXMaxsrefine and pY is between bvYMinsrefine and bvYMaxsrefine. For example, a search is performed by using a step size 1, a best matching cost obtained by template matching is recoded as pDiff_BEST, and a corresponding block vector BV is indicated as a best block vector BV_BEST (pX_BEST, pY_BEST), that is, a finally determined block vector of the current block. A corresponding matching template is a candidate template of the current block.

After the foregoing operations are completed, the best block vector BV_BEST (pX_BEST, pY_BEST) may be obtained. In which, pX_BEST and pY_BEST respectively represent a horizontal direction offset and a vertical direction offset of the best matching template relative to the current encoding block template, and pX_BEST and pY_BEST also respectively represent a horizontal direction offset and a vertical direction offset of the best matching reconstructed block relative to the current encoding block.

It can be learned that, in embodiments of this application, the process of searching and determining one or more block vectors in a search area may be performed by using three types of search strategies: performing only coarse search, performing only fine search, and performing coarse search first and then fine search. Correspondingly, if the search policy is to perform only coarse search, N block vectors BV corresponding to the N matching templates are determined only in a coarse search process, and the corresponding N matching templates are used as the N candidate templates. If the search policy is to perform only fine search, only N block vectors BV corresponding to the N matching templates are determined in a fine search process, and the corresponding N matching templates are used as the N candidate templates. If the search policy is coarse search first and then fine search, K block vectors BV corresponding to K preliminary matching templates (initial matching templates) may be first determined in a coarse search process, where K is an integer greater than or equal to N. N block vectors BV corresponding to the final N matching templates are determined based on the K preliminary matching templates in the fine search process, and the corresponding N matching templates are used as N candidate templates.

Further, in embodiments of this application, when the search processing is performed, the search point in the sub-search area in the preset search area may be traversed according to the first search step size to determine an initial vector corresponding to the sub-search area and a second search area corresponding to the initial block vector. Multiple target sub-search areas are determined in the sub-search area according to the initial block vector and the second search area. Search points in the multiple target sub-search areas are traversed according to a second search step size, to determine a block vector and a candidate template. The first search step size is greater than the second search step size.

It may be understood that, in embodiments of this application, the process of determining the multiple target sub-search areas in the sub-search area according to the initial block vector and the second search area may include: determining multiple target sub-search areas to be used in a subsequent search process, according to a best block vector of each sub-search area, that is, the initial block vector, and a corresponding second search area.

In embodiments of this application, for a search policy of performing coarse search first and then fine search, a fine search may be performed across different search areas. After a coarse search process is completed, a method of crossing boundaries of different areas may be performed in a fine search process.

Exemplarily, in embodiments of this application, as shown by (a) in FIG. 7, the search area is divided into four sub-search areas. An implementation manner of the sub-search area is as follows:

When regionId is equal to 0, iVerMin, iVerMax, iHorMin, and iHorMax may be calculated as follows:

$${iHorMax}_{0} = min ( ( xTbCmp + searchRangeWidth ) << iBvShift , ( ( picWidth - nTbW ) << iBvShift ) )$$

$${iHorMin}_{0} = max ( ( iTemplateSizeW ) << iBvShift , ( xTbCmp - searchRangeWidth ) << iBvShift )$$

$${iVerMax}_{0} = ( yTbCmp - nTbH - offsetLCBY ) << iBvShift$$

$${iVerMin}_{0} = max ( ( ( iTemplateSizeH ) << iBvShift , ( ( yTbCmp - searchRangeHeight ) << iBvShift ) ) .$$

When regionId is equal to 1, iVerMin, iVerMax, iHorMin, and iHorMax may be calculated as follows:

$${iHorMin}_{1} = max ( ( iTemplateSizeW ) << iBvShift , ( xTbCmp - searchRangeWidth ) << iBvShift )$$

$${iHorMax}_{1} = ( xTbCmp - offsetLCBX - nTbW ) << iBvShift ;$$

$${iVerMin}_{1} = ( yTbCmp + 1 ) << iBvShift ;$$

$${iVerMax}_{1} = min ( picHeight - nTbH , ( yTbCmp - offsetLCBY + CtbSizeH - nTbH ) << iBvShift ) .$$

When regionId is equal to 2, iVerMin, iVerMax, iHorMin, and iHorMax may be calculated as follows:

$${iHorMax}_{2} = ( xTbCmp - nTbW ) << iBvShift ;$$

$${iHorMin}_{2} = max ( ( iTemplateSizeW ) << iBvShift , ( xTbCmp - searchRangeWidth ) << iBvShift ) ;$$

$${iVerMin}_{2} = max ( ( iTemplateSizeH ) << iBvShift ) , ( yTbCmp - nTbH ) << iBvShift ) ;$$

$${iVerMax}_{2} = ( yTbCmp ) << iBvShift .$$

When regionId is equal to 3, iVerMin, iVerMax, iHorMin, and iHorMax may be calculated as follows:

$${iHorMin}_{3} = max ( ( iTemplateSizeW ) << iBvShift , ( xTbCmp - searchRangeWidth ) << iBvShift ) ;$$

$${iHorMax}_{3} = ( xTbCmp ) << iBvShift ;$$

$${iVerMin}_{3} = max ( ( ( iTemplateSizeH ) << iBvShift ) , ( yTbCmp - offsetLCBY - nTbH + 1 ) << iBvShift ) ;$$

$${iVerMax}_{3} = ( yTbCmp - nTbH ) << iBvShift .$$

In actual applications, iHorMin_{regionId}, iHorMax_{regionId}, iVerMin_{regionId}, and iVerMax_{regionId} herein respectively represent left edges, right edges, upper edges, and lower edges of different sub-search areas.

To intuitively describe different sub-search areas corresponding to different regionIds, as shown by FIG. 14, R1, R2, R3, and R4 represent four different sub-search areas. It should be noted that FIG. 14 shows a sample range in which upper left corner samples of the block may be aligned.

In the fine search stage, a search may be performed near the block vector obtained by the coarse search: Further, a search may be performed near the best block vector BV1_BESTk obtained by the coarse search. Specifically, a refined search range TmpRefineRange is first determined, and the refined search range may be of a fixed size, or may be related to a size of the current block. For example, the refined search range may be set to min (nTbW, nTbH)/2. Then, a location of the best matching reconstructed block obtained by coarse search is calculated as a reference location of the fine search area: BestPosXk=xTbCmp+pX1_BESTk, BestPosYk=yTbCmp+pY1_BESTk.

In some embodiments, the fine search according to each BestPosXk may be performed across multiple areas, i.e., the fine search may be performed by crossing boundaries of different search areas. The value of bestRegionId that participates in the operation may be first determined. For regionId=0, 1, 2, and 3, the following determination is performed. If BestPosYk−TmpRefineRange>=iVerMinregionId, and BestPosYk−TmpRefineRange<=iVerMaxregionId.
or BestPosYk+TmpRefineRange>=iVerMinregionId, and BestPosYk+TmpRefineRange<=iVerMaxregionId,
or BestPosYk−TmpRefineRange<=iVerMinregionId, and BestPosYk+TmpRefineRange>=iVerMaxregionId,
the corresponding bestSearchFlagregionId to set to 1.

For a search area whose bestSearchFlagregionId value is 1, a regionId of the search area is set to bestRegionId, and the following fine search is performed. First, calculated values of iVerMinbestRegionId, iVerMaxbestRegionId, iHorMinbestRegionId, and iHorMaxbestRegionId are obtained according to a value of bestRegionId, and then a new search range iVerMinrefine, iVerMaxrefine, iHorMinrefine, and iHorMaxrefine is obtained according to a location of the best matching block obtained by coarse search. The obtaining method is as follows:

$$iHorMinrefine = max ( iHorMinbestRegionId , BestPosX - TmpRefineRange ) \\ iHorMaxrefine = min ( iHorMaxbestRegionId , BestPosX + TmpRefineRange ) \\ iVerMinrefine = max ( iVerMinbestRegionId , BestPosY - TmpRefineRange ) \\ iVerMaxrefine = min ( iVerMaxbestRegionId , BestPosY + TmpRefineRange ) .$$

Then, the adjusted block vector BVbvXMins, bvXMaxs, bvYMins, and bvYMaxs may be calculated by using iVerMinrefine, iVerMaxrefine, iHorMinrefine, and iHorMaxrefine:

$$bvXMins = iHorMinrefine - xTbCmp ; \\ bvXMaxs = iHorMaxrefine - xTbCmp ; \\ bvYMins = iVerMinrefine - yTbCmp ; \\ bvYMaxs = iVerMaxrefine - yTbCmp .$$

In this way, the fine search is performed in a block vector range in which pX is between bvXMinsrefine and bvXMaxsrefine and pY is between bvYMinsrefine and bvYMaxsrefine. For example, search is performed by using a step size 1, a beset matching cost obtained by template matching is recoded as pDiff_BEST, and a corresponding block vector BV is indicated as a best block vector BV_BEST (pX_BEST, pY_BEST).

A total best block vector for the multiple search areas is obtained.

After the foregoing search operation is completed, the best block vector BV_BEST (pX_BEST, pY_BEST) may be obtained. In which, pX_BEST and pY_BEST respectively represent a horizontal direction offset and a vertical direction offset of the best matching template relative to the current encoding block template, and pX_BEST and pY_BEST also respectively represent a horizontal direction offset and a vertical direction offset of the best matching reconstructed block relative to the current encoding block.

In step 203, one or more reference blocks of the current block are determined according to the one or more block vectors, and a predicted value of the current block is determined according to the one or more reference blocks.

In embodiments of this application, after the one or more block vectors corresponding to the current block are determined according to the first template, the one or more reference blocks of the current block may be further determined according to the one or more block vectors, and then the predicted value of the current block may be determined according to the one or more reference blocks.

It should be noted that in embodiments of this application, the one or more reference blocks of the current block may include a first reference block and/or a second reference block. Both the first reference block and the current block belong to the current picture, and the second reference block belongs to the reference picture of the current picture corresponding to the current block.

In embodiments of this application, the one or more reference blocks of the current block may include only a first reference block in the current picture obtained by performing intra prediction, or may include only a second reference block in the reference picture of the current picture obtained by performing inter prediction, or may include both the first reference block and the second reference block.

Correspondingly, in embodiments of this application, the process of obtaining the second reference block may include: determining one or more block vectors; and performing searching in the reference picture of the current picture to determine a second reference block corresponding to the one or more block vectors.

In embodiments of this application, template matching searching may be performed in the current picture by using an intra template matching manner to determine one or more reference blocks corresponding to the current block, that is, the first reference block. Alternatively, template matching search may be performed in one or more inter-frame reference pictures of the current picture by using an inter template matching manner to determine one or more reference blocks corresponding to the current block, that is, the second reference block. Alternatively, template matching search may be separately performed in the current picture and the one or more inter-frame reference pictures by using the intra template matching manner and the inter template matching manner, to determine one or more reference blocks corresponding to the current block, including the first reference block and the second reference block.

Further, in embodiments of this application, the process of determining the one or more reference blocks corresponding to the current block according to the one or more block vectors may include: determining one or more initial reconstructed blocks corresponding to the current block according to the one or more block vectors; and modifying one or more initial reconstructed blocks to determine the one or more reference blocks.

In embodiments of this application, N candidate reconstructed blocks (reference blocks) may be obtained in another manner. For example, the initial reconstructed block corresponding to the obtained candidate template is modified, and then a corresponding reference block is determined.

Correspondingly, after N candidate reconstructed blocks (reference blocks) are obtained by copying matching reconstructed blocks (initial reconstructed blocks) corresponding to N BVs, the N candidate reconstructed blocks may be directly weighted to obtain a predicted value of the current block. Alternatively, matching reconstructed blocks (initial reconstructed blocks) corresponding to N BVs are modified to obtain the candidate reconstructed blocks (reference blocks), and then weighting is performed on the candidate reconstructed blocks to obtain a predicted value of the current block.

Further, in embodiments of this application, the process of modifying the one or more initial reconstructed blocks to determine the one or more reference blocks may include: performing filtering processing on the one or more initial reconstructed blocks to determine the one or more reference blocks.

Further, in embodiments of this application, the process of modifying the one or more initial reconstructed blocks to determine the one or more reference blocks may include: determining one or more modification parameter vectors according to one or more candidate templates corresponding to the one or more block vectors; and modifying the one or more initial reconstructed blocks according to the one or more modification parameter vectors to determine the one or more reference blocks.

Further, in embodiments of this application, the process of determining one or more modification parameter vectors according to one or more candidate templates corresponding to the one or more block vectors may include: determining an autocorrelation matrix corresponding to the candidate template according to a sample value in the candidate template; determining a cross-correlation vector according to a sample value in the first template and the sample value in the candidate template; and determining the modification parameter vector according to the autocorrelation matrix and the cross-correlation vector.

It may be understood that, in embodiments of this application, the process of modifying the initial reconstructed block may include: directly performing filtering processing on the initial reconstructed block. A filtering method used in performing filtering processing may include: a conventional filtering method, such as bilateral filtering or mean filtering; or neural network-based filtering enhancement.

It may be understood that, in embodiments of this application, the process of modifying the initial reconstructed block may include: modifying the matching reconstructed block (initial reconstructed block) by using matching template information (candidate template).

For example, in embodiments of this application, the process of modifying the matching reconstructed block by using the matching template information may include: for each candidate template refTₙ and a corresponding candidate reconstructed block (initial reconstructed block) RefBlockₙ, calculating a modification parameter vector Cₙ by using the candidate template refTₙ and the current encoding block template (a first template of the current block) curT, performing weighted fusion on the modification parameter vector Cₙ and the candidate reconstructed block RefBlockₙ to obtain a finally modified reconstructed block RefBlock ′n, that is, obtaining the reference block RefBlock ′n of the current block.

In some embodiments, the modification parameter vector Cₙ may be derived by minimizing the MSE between the reconstructed value of the candidate template refTₙ and a sample value of a template to be predicted.

It may be understood that, in embodiments of this application, the modification parameter vector Cₙ may be considered as an L-tap filter.

In some embodiments, when the modification parameter vector Cₙ is calculated, for each candidate template refTₙ, n=0, 1 . . . , N−1, the process of minimizing the MSE may include: inputting an autocorrelation matrix of the candidate template sample refT, and a cross-correlation vector between the candidate template sample refT and an adjacent template sample curT of the current encoding block, to output the weight of the candidate reconstructed block corresponding to the current candidate template.

Schematically, in embodiments of this application, the MSE is calculated as follows:

$$MSE = \frac{1}{K} {\sum }_{k = 0}^{K - 1} {( {refpredT}_{k} - curT )}^{2} = \frac{1}{K} {\sum }_{k = 0}^{K - 1} {( {\sum }_{l = 0}^{L - 1} {c}_{l} \cdot {refT}_{k} - curT )}^{2} . \qquad ( 9 )$$

For convenience of representing the calculation formula of MSE, E represents mean squared error MSE, that is:

$$MSE = E [ {( {refpredT}_{k} - {curT}_{k} )}^{2} ] = E [ {( {\sum }_{l = 0}^{L - 1} {c}_{l} * {refT}_{k} - {curT}_{k} )}^{2} ] , k = 0 , 1 , … , K - 1 = l = 0 , 1 , … , L - 1. \qquad ( 10 )$$

where K represents a quantity of samples in the template.

In some embodiments, the process of deriving a weight C₁ of candidate reconstructed block corresponding to candidate template refT by minimizing the MSE may include the following steps:
(1) First, a partial derivative of C₁ is calculated and let the partial derivative to be 0:

$$\frac{\partial MSE}{\partial {c}_{l}} = E [ 2 ( {\sum }_{l = 0}^{L - 1} {c}_{l} * {refT}_{k} - {curT}_{k} ) * {refT}_{k} ] , l = 0 , 1 , … , L - 1 \qquad ( 11 )$$

$$E [ 2 ( {\sum }_{l = 0}^{L - 1} {c}_{l} * {refT}_{k} - {curT}_{k} ) * {refT}_{k} ] = 0 \qquad ( 12 )$$

the following formula (13) is obtained by induction from formulars (11) and (12):

$${\sum }_{l = 0}^{L - 1} {c}_{l} * E ( {refT}_{k} * {refT}_{k} ) = E ( {curT}_{k} * {refT}_{k} ) . \qquad ( 13 )$$

(2) After the candidate template area refTₙ is determined, the equation obtained in step (1) is expanded into a matrix form:

$$[ \begin{matrix}{\sum }_{k ∈ refT ( n )} ( refT [ k ] [ 0 ] \cdot refT [ k ] [ 0 ] ) & {\sum }_{k ∈ refT ( n )} ( refT [ k ] [ 1 ] \cdot refT [ k ] [ 0 ] ) & ⋯ & {\sum }_{k ∈ refT ( n )} ( refT [ k ] [ L - 1 ] \cdot refT [ k ] [ 0 ] ) \\ {\sum }_{k ∈ refT ( n )} ( refT [ k ] [ 0 ] \cdot refT [ k ] [ 1 ] ) & {\sum }_{k ∈ refT ( n )} ( refT [ k ] [ 1 ] \cdot refT [ k ] [ 1 ] ) & ⋯ & {\sum }_{k ∈ refT ( n )} ( refT [ k ] [ L - 1 ] \cdot refT [ k ] [ 1 ] ) \\ ⋮ & ⋮ & ⋱ & ⋮ \\ {\sum }_{k ∈ refT ( n )} ( refT [ k ] [ 0 ] \cdot refT [ k ] [ L - 1 ] ) & {\sum }_{k ∈ refT ( n )} ( refT [ k ] [ 1 ] \cdot refT [ k ] [ L - 1 ] ) & ⋯ & {\sum }_{k ∈ refT ( n )} ( refT [ k ] [ L - 1 ] \cdot refT [ k ] [ L - 1 ] )\end{matrix} ] \cdot [ \begin{matrix}{c}_{0} \\ {c}_{1} \\ ⋮ \\ {c}_{L - 1}\end{matrix} ] = [ \begin{matrix}{\sum }_{k ∈ refT ( n )} ( curT [ k ] \cdot refT [ k ] [ 0 ] ) \\ {\sum }_{k ∈ refT ( n )} ( curT [ k ] \cdot refT [ k ] [ 1 ] ) \\ ⋮ \\ {\sum }_{k ∈ refT ( n )} ( curT [ k ] \cdot refT [ k ] [ L - 1 ] )\end{matrix} ]$$

(3) Both the autocorrelation matrix and the cross-correlation vector in step (2) are known, and a weight coefficient c0, . . . c_{L-1} of the filter may be obtained by solving the linear equation set in step (2), that is, a filter coefficient of a candidate reconstructed block in the modification parameter vector Cₙ.

Correspondingly, for x=0, . . . , nTbW−1, y=0, . . . , nTbH−1, the modified candidate reconstructed block RefBlock ′n is:

$${RefBlock}_{n , x , y}^{′} = {\sum }_{l = 0}^{L - 1} {c}_{l} * {RefBlock}_{n , x , y} . \qquad ( 14 )$$

It should be noted that in embodiments of this application, after N block vectors BV corresponding to the N candidate templates of the current block are determined, N candidate reconstructed blocks (that is, N reference blocks) may be obtained by N BVs, and then weighted fusion is performed on the N candidate reconstructed blocks to obtain a predicted block (that is, a predicted value of the current block) of the current block. The process of generating a final prediction value may include: obtaining N candidate reconstructed blocks (N reference blocks), determining a corresponding weighted fusion weight (weight value), and performing weighted fusion processing to generate the predicted value of the current block.

It may be understood that, in embodiments of this application, the process of determining one or more reference blocks of the current block according to one or more block vectors may include: for N block vectors BVₙ corresponding to the N obtained candidate templates, obtaining N candidate reconstructed blocks (that is, reference blocks) RefBlockₙ from the current picture and/or the reference picture according to the BVₙ, where a horizontal offset of the BVₙ is pXₙ, and a vertical offset of the BVₙ is pYₙ, where n=0, 1, . . . , N−1.

For example, in embodiments of this application, the one or more reference blocks of the current block may be determined by simple translation and copying. A specific operation is as follows: for x=0, . . . , nTbW−1 and y=0, . . . , nTbH−1, a reconstructed sample of a current frame (that is, the reference block of the current block) is determined by using a formula:

$${RefBlock}_{n} [ x ] [ y ] = recSamples [ x + {pX}_{n} ] [ y + {pY}_{n} ] . \qquad ( 15 )$$

Further, in embodiments of this application, the process of determining the predicted values of the current block according to the one or more reference blocks may include: determining one or more weight values corresponding to the one or more reference blocks; and performing weighted fusion processing on the one or more reference blocks by using the one or more weight values to determine a predicted value of the current block.

It should be noted that in embodiments of this application, after the N candidate reconstructed blocks RefBlock (that is, the reference block of the current block) are obtained, weights W for weighted fusion of N candidate reconstructed blocks need to be calculated. The weight value corresponding to the reference block may be determined in multiple manners. For example, the weight may be a predefined value (such as a second preset value), or may be a value obtained by performing adaptive calculation by using a cost value, a sample value, or the like.

In an embodiment, one or more weight values may be determined according to a second preset value. The second preset value may include N values greater than 0. For different reference blocks of the N reference blocks, corresponding weight values may be the same, or may be different, which is not specifically limited in this application.

In an embodiment, one or more weight values may be determined according to one or more candidate templates corresponding to one or more block vectors. Specifically, an autocorrelation matrix corresponding to the candidate template may be determined according to a sample value in the candidate template. Then, a cross-correlation vector may be determined according to a sample value in the first template and the sample value in the candidate template. Further, the weight value may be determined according to the autocorrelation matrix and the cross-correlation vector.

In some embodiments, the weighted fusion weight (weight value) may be derived by minimizing the MSE between the reconstructed value of the candidate template refTₙ and a sample value of a template (first template) refpredTₙ to be predicted.

It should be noted that, to derive the weight more flexibly, a non-linear term and an offset term may be added to a process of deriving the weighted fusion weigh.

For example, in embodiments of this application, when the weighted fusion weight is derived, the nonlinear term NonLinearTerm_T is constructed based on a candidate template. One candidate template whose sequence number is 0 may be selected from the N candidate templates for construction. Correspondingly, for m=0, 1 . . . , and M−1, the nonlinear term is expressed by the following formula

$${NonLinearTerm\_T}_{n , m} = ( {refT}_{n , m} * {refT}_{n , m} + Mid Val ) >> \text{bitDepth.} \qquad ( 16 )$$

In which, n is 0, 1, . . . , or N−1, indicating any one of the N candidate templates; MidVal is 1<<(bitDepth−1), and bitDepth represents a picture bit depth.

For example, in embodiments of this application, for each of candidate reconstructed blocks (reference block) corresponding to the N candidate templates, when a weighted fusion weight is applied, the nonlinear term NonLinearTerm_Block is constructed based on the candidate reconstructed block. A candidate reconstructed block corresponding to a candidate template whose sequence number is 0 may be selected. Correspondingly, for x=0, 1 . . . , nTbW−1, and y=0, . . . , nTbH−1, the nonlinear term may be expressed in the following formula:

$${NonLinearTerm\_Block}_{n , x , y} = ( {refBlock}_{n , x , y} * {refBlock}_{n , x , y} + Mid Val ) >> \text{bitDepth.} \qquad ( 17 )$$

In which, n is 0, 1, . . . , or N−1, indicating a candidate reconstructed block (reference block) corresponding to any one of the N candidate templates.

The offset value Bias in the process of deriving weights and applying weights may be any constant in a picture sample range [0, (1<<bitDepth)−1], for example, Bias may be set to 1<<(bitDepth−1).

Because BiasTerm is a constant, in an actual calculation process, the BiasTerm needs to expanded in a form of matrix. Specifically,

For each of the N candidate templates:

$$for m = 0 , 1 … , and M - 1 : \qquad ( 18 )$$

$${BiasTerm}_{m} = Bias ;$$

for each candidate reconstructed block corresponding to the N candidate templates,

$$for x = 0 , 1 , … , nTbW - 1 , y = 0 , … , nT bH - 1 : \qquad ( 19 )$$

$${BiasTerm}_{x , y} = Bias .$$

It may be understood that, in embodiments of this application, after a non-linear term and an offset term are added, N+2 weights (weight values) need to be derived. For ease of description, a variable P is used to record a weight quantity, where P=N+2. A matching template sample/a non-linear term sample and an offset term sample are collectively referred to as matching reference samples refT_{N} and refT_{N+1}. Therefore, all reference quantities involved in an operation may be uniformly represented as refTₚ. Similarly, the reconstructed block corresponding to the matching template, the reconstructed block corresponding to the matching template involved in the non-linear term, and the offset term are collectively referred to as candidate reconstructed samples refBlockₚ, where p=0, 1, . . . , and P−1.

For example, in embodiments of this application, in a process of minimizing an MSE, an autocorrelation matrix of the first P matching reference samples refT, and a cross-correlation vector of the first P matching reference samples refT and an adjacent template sample curT of the current encoding block are used are inputted, to output a weight of the reconstructed block corresponding to each matching reference term.

The MSE calculation formula is as follows:

For a sample at a same position of each matching reference template, that is, for m=0, 1, . . . , and M−1:

$$MSE = \frac{1}{P} {\sum }_{p = 0}^{P - 1} {( {refpredT}_{p} - curT )}^{2} = \frac{1}{P} {\sum }_{p = 0}^{P - 1} {( {\sum }_{p = 0}^{P - 1} {w}_{p} * {refT}_{p} - curT )}^{2} . \qquad ( 20 )$$

For convenience of representing the calculation formula of MSE, E represents mean squared error MSE, that is:

$$MSE = E [ {( {refpredT}_{p} - curT )}^{2} ] = E [ {( {\sum }_{p = 0}^{P - 1} {w}_{p} \cdot {refT}_{p} - curT )}^{2} ] . \qquad ( 21 )$$

The process of deriving a weight Wₚ of a reconstructed block corresponding to each matching reference sample by minimizing the MSE includes the following steps:
(1) partial derivative on Wₚ is calculated and let the partial derivative to be 0:

$$\frac{\partial MSE}{\partial {w}_{m}} = E [ 2 ( {\sum }_{p = 0}^{P - 1} {w}_{p} \cdot {refT}_{p} - curT ) \cdot {refT}_{p} ] , m = 0 , 1 , … , P - 1 \qquad ( 22 )$$

$$E [ 2 ( {\sum }_{p = 0}^{P - 1} {w}_{p} \cdot {refT}_{p} - curT ) \cdot {refT}_{p} ] = 0 \qquad ( 23 )$$

the following formula (24) is obtained by induction from formulars (22) and (23):

$${\sum }_{p = 0}^{P - 1} {w}_{p} \cdot E ( {refT}_{p} \cdot {refT}_{p} ) = E ( curT \cdot {refT}_{p} ) . \qquad ( 24 )$$

(2) After the matching reference sample areas refT₀, refT₁, and . . . refTₚ₋₁ are determined, the equation obtained in step (1) is expanded into a matrix form:

$$[ \begin{matrix}{\sum }_{i ∈ {refT}_{0}} ( refT [ i ] [ 0 ] \cdot refT [ i ] [ 0 ] ) & {\sum }_{i ∈ {refT}_{0}} ( refT [ i ] [ 1 ] \cdot refT [ i ] [ 0 ] ) & ⋯ & {\sum }_{i ∈ {refT}_{0}} ( refT [ i ] [ P - 1 ] \cdot refT [ i ] [ 0 ] ) \\ {\sum }_{i ∈ {refT}_{1}} ( refT [ i ] [ 0 ] \cdot refT [ i ] [ 1 ] ) & {\sum }_{i ∈ {refT}_{1}} ( refT [ i ] [ 1 ] \cdot refT [ i ] [ 1 ] ) & ⋯ & {\sum }_{i ∈ {refT}_{1}} ( refT [ i ] [ P - 1 ] \cdot refT [ i ] [ 1 ] ) \\ ⋮ & ⋮ & ⋱ & ⋮ \\ {\sum }_{i ∈ {refT}_{P - 1}} ( refT [ i ] [ 0 ] \cdot refT [ i ] [ P - 1 ] ) & {\sum }_{i ∈ {refT}_{P - 1}} ( refT [ i ] [ 1 ] \cdot refT [ i ] [ P - 1 ] ) & ⋯ & {\sum }_{i ∈ {refT}_{P - 1}} ( refT [ i ] [ P - 1 ] \cdot refT [ i ] [ P - 1 ] )\end{matrix} ] \cdot [ \begin{matrix}{w}_{0} \\ {w}_{1} \\ ⋮ \\ {w}_{P - 1}\end{matrix} ] = [ \begin{matrix}{\sum }_{i ∈ {refT}_{0}} ( curT \cdot refT [ i ] [ 0 ] ) \\ {\sum }_{i ∈ {refT}_{1}} ( curT \cdot refT [ i ] [ 1 ] ) \\ ⋮ \\ {\sum }_{i ∈ {refT}_{P - 1}} ( curT \cdot refT [ i ] [ P - 1 ] )\end{matrix} ]$$

(3) The autocorrelation matrix and the cross-correlation vector in step (2) are known, and weights w0, . . . , w_{P-1} of a reconstructed sample (reference block) corresponding to each matching reference term may be calculated by solving the linear equation set in step (2).

In embodiments of this application, the process of determining one or more weight values according to one or more candidate templates corresponding to one or more block vectors may include: determining a matching cost value between the first template and the candidate template; and determining the weight value according to the matching cost value.

Further, in embodiments of this application, the weights may also be calculated in another manner. For example, a corresponding weight wₙ may be allocated to each candidate reconstructed block (reference block) RefBlockₙ by using a nonlinear weight model according to costs of N matching candidate templates.

It should be noted that, in embodiments of this application, the weight model may include but is not limited to a non-linear normalization function, a non-linear exponential normalization function, and the like.

Schematically, in embodiments of this application, a weight of each candidate reconstructed block (reference block) may be calculated by using the following nonlinear function. In which, input of the weight model is a matching cost between the current encoding block template curT and the candidate template refTₙ. The matching cost includes but is not limited to SAD (refTₙ), MAD (refTₙ), or a correlation coefficient R (refTₙ) between the current encoding block template curT and the candidate template refTₙ.

In some embodiments, a calculation formula of the weight model is as follows:

$${w}_{n} = \frac{\frac{1}{{MAD}_{{refT}_{n}} + offset}}{{\sum }_{n = 0}^{N - 1} \frac{1}{{MAD}_{{refT}_{n}} + offset}} , n = 0 , 1 , ... , N - 1. \qquad ( 25 )$$

In which, offset represents a preset value, for example, offset is 1.

In some embodiments, when the matching cost is normalized correlation coefficient R (refTₙ), the calculation formula of the weight model is as follows:

$${w}_{n} = \frac{{R}_{{refT}_{n}}}{{\sum }_{n = 0}^{N - 1} {R}_{{refT}_{n}}} , n = 0 , 1 , ... , N - 1. \qquad ( 26 )$$

In some embodiments, the Softmax function may also be used as a weight model, and a calculation formula is as follows:

$${w}_{n} = \frac{{e}^{\frac{- {MAD}_{{refT}_{n}}}{S}}}{{\sum }_{n = 0}^{N - 1} {e}^{\frac{- {MAD}_{{refT}_{n}}}{S}}} , n = 0 , 1 , ... , N - 1. \qquad ( 27 )$$

S is a model control parameter. In a certain condition, the parameter S may be adjusted, so as to adjust the weight model. For example, the parameter S may be related to the current block size or the template type

In some embodiments, in addition to the foregoing nonlinear weight model, a weight of each candidate reconstructed block may also be directly set to an average value, for example:

$${w}_{n} = \frac{1}{N} , n = 0 , 1 , ... , N - 1. \qquad ( 28 )$$

In some embodiments, the weighted fusion weight (weight value) may also be derived by minimizing the MSE between the reconstructed value of the candidate template refTₙ and the sample value of the template (first template) refpredTₙ to be predicted, without adding a nonlinear term and an offset term.

Schematically, in embodiments of this application, if a non-linear term and an offset term are not added, only N weighted (weight values) need to be derived. In a process of minimizing the MSE, an autocorrelation matrix of the first N candidate template samples refT, and the cross-correlation vector between the first P candidate template samples refT and an adjacent template sample curT of the current encoding block are inputted, to output the weight of the candidate reconstructed block corresponding to each candidate template.

In some embodiments, for samples at the same position of each candidate template, that is, for m=0, 1, . . . , M−1, the MSE calculation formula is as follows:

$$MSE = \frac{1}{N} {\sum }_{n = 0}^{N - 1} {( {refpredT}_{n} - curT )}^{2} = \frac{1}{N} {\sum }_{n = 0}^{N - 1} {( {\sum }_{n = 0}^{N - 1} {w}_{n} \cdot {refT}_{n} - curT )}^{2} . \qquad ( 29 )$$

For convenience of representing the calculation formula of MSE, E represents mean squared error MSE, that is:

$$MSE = E [ {( {refpredT}_{n} - curT )}^{2} ] = E [ {( {\sum }_{n = 0}^{N - 1} {w}_{n} \cdot {refT}_{n} - curT )}^{2} ] . \qquad ( 30 )$$

The process of deriving the weight Wₙ of the candidate reconstructed block corresponding to each candidate template by minimizing the MSE includes the following steps:
(1) partial derivative on Wₚ is calculated and let the partial derivative to be 0:

$$\frac{\partial MSE}{\partial {w}_{m}} = E [ 2 ( {\sum }_{n = 0}^{N - 1} {w}_{n} \cdot {refT}_{n} - curT ) \cdot {refT}_{n} ] , m = 0 , 1 , … , N - 1 \qquad ( 31 )$$

$$E [ 2 ( {\sum }_{n = 0}^{N - 1} {w}_{n} \cdot {refT}_{n} - curT ) \cdot {refT}_{n} ] = 0 \qquad ( 32 )$$

the following formular (33) is obtained by induction from formulars (31) and (32):

$${\sum }_{n = 0}^{N - 1} {w}_{n} \cdot E ( {refT}_{n} \cdot {refT}_{n} ) = E ( curT \cdot {refT}_{n} ) . \qquad ( 33 )$$

(2) After the candidate template areas refT₀, refT₁, and . . . refT_{N-1} are determined, the equation obtained in (1) is expanded into a matrix form:

$$[ \begin{matrix}{\sum }_{i ∈ {refT}_{0}} ( refT [ i ] [ 0 ] \cdot & {\sum }_{i ∈ {refT}_{0}} ( refT [ i ] [ 1 ] \cdot & … & {\sum }_{i ∈ {refT}_{0}} ( refT [ i ] [ N - 1 ] \cdot \\ refT [ i ] [ 0 ] ) & refT [ i ] [ 0 ] ) & & refT [ i ] [ 0 ] ) \\ {\sum }_{i ∈ {refT}_{1}} ( refT [ i ] [ 0 ] \cdot & {\sum }_{i ∈ {refT}_{1}} ( refT [ i ] [ 1 ] \cdot & … & {\sum }_{i ∈ {refT}_{1}} ( refT [ i ] [ N - 1 ] \cdot \\ refT [ i ] [ 1 ] ) & refT [ i ] [ 1 ] ) & & refT [ i ] [ 1 ] ) \\ ⋮ & ⋮ & ⋱ & ⋮ \\ {\sum }_{i ∈ {refT}_{N - 1}} ( refT [ i ] [ 0 ] \cdot & {\sum }_{i ∈ {refT}_{N - 1}} ( refT [ i ] [ 1 ] \cdot & … & {\sum }_{i ∈ {refT}_{N - 1}} ( refT [ i ] [ N - 1 ] \cdot \\ refT [ i ] [ N - 1 ] ) & refT [ i ] [ N - 1 ] ) & & refT [ i ] [ N - 1 ] )\end{matrix} ] \cdot [ \begin{matrix}{w}_{0} \\ {w}_{1} \\ ⋮ \\ {w}_{N - 1}\end{matrix} ] = [ \begin{matrix}{\sum }_{i ∈ {refT}_{0}} ( curT \cdot refT [ i ] [ 0 ] ) \\ {\sum }_{i ∈ {refT}_{1}} ( curT \cdot refT [ i ] [ 1 ] ) \\ ⋮ \\ {\sum }_{i ∈ {refT}_{N - 1}} ( curT \cdot refT [ i ] [ N - 1 ] )\end{matrix} ]$$

(3) The autocorrelation matrix and the cross-correlation vector in step (2) are known, and weights w0, . . . , w_{N-1} of the reconstructed sample corresponding to each candidate template may be calculated by solving the linear equation set in step (2).

In some embodiments, the weighted fusion weight (weight value) may also be derived by minimizing the MSE between the reconstructed value of the candidate template refTₙ and the sample value of the template (first template) refpredTₙ to be predicted, by adding only the offset term and not adding non-linear term.

Schematically, in embodiments of this application, if only an offset item is added and no non-linear item is added, N+1 weights (weight values) need to be derived. For ease of description, a variable P is used to record a quantity of weights, where P=N+1. A candidate template sample/offset item sample is collectively referred to as a matching reference sample refT_{N} and refT_{N+1}. Therefore, all reference terms involved in the operation may be uniformly represented as refTₚ. Similarly, a candidate reconstructed block corresponding to the candidate template and an offset term are collectively referred to as candidate reconstructed samples refBlockₚ, where p=0, 1, . . . , and P−1.

In some embodiments, in the process of minimizing the MSE, an autocorrelation matrix of the first P matching reference samples refT, and a cross-correlation vector between the first P matching reference samples refT and an adjacent template sample curT of the current encoding block are inputted, to output the weight of the reconstructed block corresponding to each matching reference term.

In some embodiments, for samples at the same position of each candidate template, that is, for m=0, 1 . . . , M−1, the MSE calculation formula is as follows:

$$MSE = \frac{1}{P} {\sum }_{p = 0}^{P - 1} {( {refpredT}_{p} - curT )}^{2} = \frac{1}{P} {\sum }_{p = 0}^{P - 1} {( {\sum }_{p = 0}^{P - 1} {w}_{p} \cdot {refT}_{p} - curT )}^{2} . \qquad ( 34 )$$

For convenience of representing the calculation formula of MSE, E represents mean squared error MSE, that is:

$$MSE = E [ {( {refpredT}_{p} - curT )}^{2} ] = E [ {( {\sum }_{p = 0}^{P - 1} {w}_{p} \cdot {refT}_{p} - curT )}^{2} ] . \qquad ( 35 )$$

The process of deriving the weight Wₚ of the reconstructed block corresponding to each matching reference sample by minimizing the MSE includes the following steps
(1) partial derivative on Wₚ is calculated and let the partial derivative to be 0:

$$\frac{\partial MSE}{\partial {w}_{m}} = E [ 2 ( {\sum }_{p = 0}^{P - 1} {w}_{p} \cdot {refT}_{p} - curT ) \cdot {refT}_{p} ] , m = 0 , 1 , … , P - 1 \qquad ( 36 )$$

$$E [ 2 ( {\sum }_{p = 0}^{P - 1} {w}_{p} \cdot {refT}_{p} - curT ) \cdot {refT}_{p} ] = 0 \qquad ( 37 )$$

the following formular (38) is obtained by induction from formulars (36) and (37):

$${\sum }_{p = 0}^{P - 1} {w}_{p} \cdot E ( {refT}_{p} \cdot {refT}_{p} ) = E ( curT \cdot {refT}_{p} ) . \qquad ( 38 )$$

(2) After the matching reference template areas refT₀, refT₁, and . . . refTₚ₋₁ are determined, the equation obtained in (1) is expanded into a matrix form:

$$[ \begin{matrix}{\sum }_{i ∈ {refT}_{0}} ( refT [ i ] [ 0 ] \cdot & {\sum }_{i ∈ {refT}_{0}} ( refT [ i ] [ 1 ] \cdot & … & {\sum }_{i ∈ {refT}_{0}} ( refT [ i ] [ P - 1 ] \cdot \\ refT [ i ] [ 0 ] ) & refT [ i ] [ 0 ] ) & & refT [ i ] [ 0 ] ) \\ {\sum }_{i ∈ {refT}_{1}} ( refT [ i ] [ 0 ] \cdot & {\sum }_{i ∈ {refT}_{1}} ( refT [ i ] [ 1 ] \cdot & … & {\sum }_{i ∈ {refT}_{1}} ( refT [ i ] [ P - 1 ] \cdot \\ refT [ i ] [ 1 ] ) & refT [ i ] [ 1 ] ) & & refT [ i ] [ 1 ] ) \\ ⋮ & ⋮ & ⋱ & ⋮ \\ {\sum }_{i ∈ {refT}_{P - 1}} ( refT [ i ] [ 0 ] \cdot & {\sum }_{i ∈ {refT}_{P - 1}} ( refT [ i ] [ 1 ] \cdot & … & {\sum }_{i ∈ {refT}_{P - 1}} ( refT [ i ] [ P - 1 ] \cdot \\ refT [ i ] [ P - 1 ] ) & refT [ i ] [ P - 1 ] ) & & refT [ i ] [ P - 1 ] )\end{matrix} ] \cdot [ \begin{matrix}{w}_{0} \\ {w}_{1} \\ ⋮ \\ {w}_{P - 1}\end{matrix} ] = [ \begin{matrix}{\sum }_{i ∈ {refT}_{0}} ( curT \cdot refT [ i ] [ 0 ] ) \\ {\sum }_{i ∈ {refT}_{1}} ( curT \cdot refT [ i ] [ 1 ] ) \\ ⋮ \\ {\sum }_{i ∈ {refT}_{P - 1}} ( curT \cdot refT [ i ] [ P - 1 ] )\end{matrix} ]$$

(3) The autocorrelation matrix and the cross-correlation vector in step (2) are known, and weights w0, . . . , wₚ₋₁ of the reconstructed sample corresponding to each matching reference term may be calculated by solving the linear equation set in step (2).

In embodiments of this application, after the one or more reference blocks of the current block are determined according to the one or more block vectors, and the predicted value of the current block is determined according to the one or more reference blocks, a prediction difference (residual) of the current block may be further determined according to the predicted value of the current block, and the residual is written into a bitstream. In this way, the decoding side may determine the residual of the current block by decoding the bitstream, and then determine a reconstructed value of the current block according to the residual and the predicted value.

In conclusion, the foregoing encoding method proposed in step 201 to step 204 performs improvement and optimizing on a common Intra TMP technology; and an Intra TMP Fusion prediction manner is proposed by using weighted fusion. In a process of searching for in the search area and determining the block vector BV, at least one block vector of the current block may be determined, that is, multiple block vectors may be determined. In addition, in a process of generating the predicted value, weighted fusion processing is performed on at least one reference block corresponding to the at least one block vector to obtain the predicted value of the current block, thereby determining a reconstructed value of the current block.

That is, embodiments of this application propose an Intra TMP Fusion technology. After N block vectors BV corresponding to the N candidate matching templates with a minimum matching cost are found in a predefined range by using a current encoding block template (a first template of the current block), N candidate reconstructed block (N reference blocks) corresponding to the N candidate matching templates (the N candidate templates) are found by using N BVs, and then weighted fusion is performed on the N candidate reconstructed blocks by using specific weights to obtain a weighting result. The weighting result serves as a predicted block (predicted value) of the current block.

It may be understood that the Intra TMP Fusion method provided in embodiments of this application can improve prediction value accuracy. After N block vectors BV corresponding to the N candidate matching templates with a minimum matching cost are found in a predefined range by using the current encoding block template (the first template of the current block), the N candidate reconstructed blocks (the N reference blocks) corresponding to the N candidate matching templates (the N candidate templates) are found by using the N BVs; and weighted fusion is performed on the candidate reconstructed blocks by using specific weights to obtain a weighting result. The weighting result serves as the predicted block of the current block. In one aspect, reconstructed block information corresponding to different matching templates in a search process is fully considered, instead of merely considering the reconstructed block corresponding to a template with a minimum matching cost. On the other hand, weights are adaptively assigned to candidate reconstructed blocks by matching template information, so that the importance of different reconstructed block information for predicting the current block is fully considered.

It may be understood that in the Intra TMP Fusion method provided in embodiments of this application, candidate reconstructed block information corresponding to different matching templates can be fully utilized in a process of searching for a matching template. In one aspect, reconstructed block information corresponding to different matching templates in a search process is fully utilized, instead of merely considering reconstructed block information corresponding to a template with a minimum matching cost. On the other hand, weights are adaptively assigned to the candidate reconstructed blocks by fully utilizing the matching template information, so that different importance of different reconstructed block information for predicting the current block is fully considered.

It can be learned that the Intra TMP Fusion method provided in embodiments of this application can prevent, to some extent, a decrease in prediction accuracy caused by inaccurate template matching basis or directly copying the reconstructed block as the predicted block.

Compared with a common coding technology, in the Intra TMP Fusion method provided in embodiments of this application, test is conducted in All Intra condition at an interval of 24 frames, a BD-rate change of −0.29%, −0.30%, and −0.39% (that is, an average bit rate change under a same psnr) can be respectively achieved on Y, Cb, and Cr.

Embodiments of this application provide an encoding method. The encoder determines a first template corresponding to the current block; determines, according to the first template, one or more block vectors corresponding to the current block; determines one or more reference blocks of the current block according to the one or more block vectors, and determines predicted values of the current block according to the one or more reference blocks. It can be learned that, in embodiments of this application, an Intra TMP Fusion prediction manner is proposed. In which, at least one block vector of the current block may be determined, and the predicted value of the current block may be obtained by using at least one reference block corresponding to the at least one block vector. Therefore, according to the coding method proposed in embodiments of this application, the current block is predicted according to different importance of reconstructed block information corresponding to different matching templates in a search process, so that prediction accuracy can be improved, thereby obtaining an optimal prediction effect.

In still another embodiment of this application, FIG. 16 shows a schematic structural diagram of an encoder according to an embodiment of this application. As shown in FIG. 16, the encoder 180 may include a first determining unit 1801.

The first determining unit 1801 is configured to determine a first template corresponding to a current block; determine, according to the first template, one or more block vectors corresponding to the current block; and determine one or more reference blocks of the current block according to the one or more block vectors, and determine predicted values of the current block according to the one or more reference blocks.

It may be understood that, in embodiments of this application, the term “unit” may be a partial circuit, a partial processor, a partial program or software, or the like. Certainly, the term “unit” may be a module or may be in a non-modular form. In addition, component parts in embodiments may be integrated into one processing unit, or each of the units may exist alone physically, or two or more units may be integrated into one unit. The integrated unit may be implemented in a form of hardware, or may be implemented in a form of a software functional module.

When the integrated unit is implemented in a form of a software functional module and not sold or used as an independent product, the integrated unit may be stored in a computer-readable storage medium. Based on such an understanding, the technical solutions of embodiments essentially, or the part contributing to the conventional technology, or all or a part of the technical solutions may be implemented in a form of a software product. The computer software product is stored in a storage medium and includes several instructions for instructing a computer device (which may be a personal computer, a server, or a network device) or a processor (processor) to execute all or a part of the steps of the methods described in the embodiments. The foregoing storage medium includes various media that may store a program code, such as a USB flash drive, a removable hard disk, a read-only memory (Read-only Memory, ROM), a random access memory (Random Access Memory, RAM), a magnetic disk, or an optical disk.

Therefore, an embodiment of this application provides a computer readable storage medium, which is applied to an encoder 180. The computer readable storage medium stores a computer program. When being executed by a first processor, the computer program implements the method in any one of the foregoing embodiments.

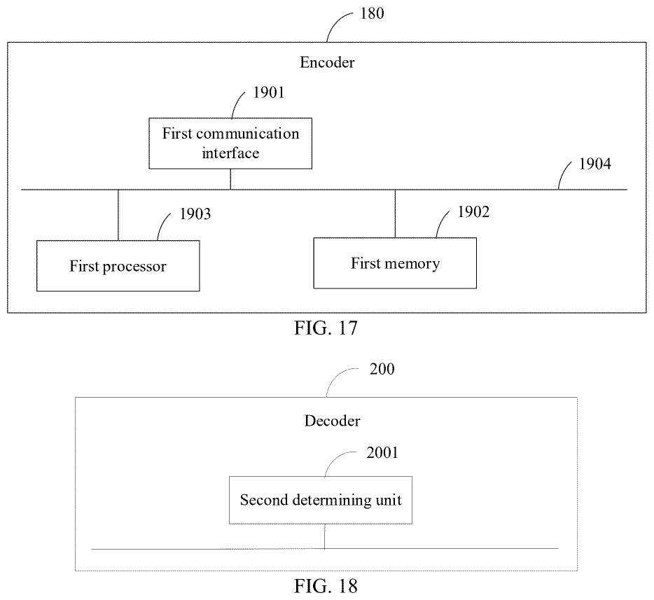

Based on a composition of the encoder 180 and a computer readable storage medium, FIG. 17 shows a schematic structural diagram of hardware of the encoder 180 according to an embodiment of this application. As shown in FIG. 17, the encoder 180 may include: a first communications interface 1901, a first memory 1902, and a first processor 1903. All components are coupled together by using the first bus system 1904. It may be understood that the first bus system 1904 is configured to implement connection and communication between these components. In addition to a data bus, the first bus system 1904 further includes a power bus, a control bus, and a status signal bus. However, for clear description, various buses in FIG. 17 are marked as the first bus system 1904.

The first communications interface 1901 is configured to receive and transmit a signal in a process of transmitting and receiving information with another external network element.

The first memory 1902 is configured to store a computer program that is runnable on the first processor 1903.

The first processor 1903 is configured to run the computer program to perform the following operations:
determining a first template corresponding to a current block;
determining, according to the first template, one or more block vectors corresponding to the current block; and
determining one or more reference blocks of the current block according to the one or more block vectors, and determining predicted values of the current block according to the one or more reference blocks.

It may be understood that in embodiments of this application, the first memory 1902 may be a volatile memory or a non-volatile memory, or may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), and is used as an external cache. By way of example rather than limitative description, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synchlink DRAM, SLDRAM), and a direct Rambus random access memory (Direct Rambus RAM, DRRAM). The first memory 1902 in the systems and the methods described in this application includes but is not limited to these and any memory of another appropriate type.

The first processor 1903 may be an integrated circuit chip and has a signal processing capability. In an implementation process, steps in the foregoing method can be implemented by using a hardware integrated logical circuit in the first processor 1903, or by using instructions in a form of software. The first processor 1903 may be a general-purpose processor, a digital signal processor (Digital Signal Processor, DSP), an application-specific integrated circuit (Application Specific Integrated Circuit, ASIC), a field programmable gate array (Field Programmable Gate Array, FPGA) or another programmable logic device, a discrete gate or a transistor logic device, or a discrete hardware component. The processor may implement or execute the methods, steps, and logical block diagrams disclosed in embodiments of this application. The general-purpose processor may be a microprocessor, or the processor may be any conventional processor or the like. The steps of the methods disclosed with reference to embodiments of this application may be directly implemented by a hardware decoding processor, or may be implemented by a combination of hardware and software modules in a decoding processor. The software module may be located in a mature storage medium in the art, for example, a random access memory, a flash memory, a read-only memory, a programmable read-only memory, an erasable programmable memory, or a register. The storage medium is located in the first memory 1902, and the first processor 1903 reads information in the first memory 1902 and completes the steps of the foregoing methods in combination with hardware of the first processor.

It may be understood that these embodiments described in this application may be implemented by hardware, software, firmware, middleware, microcode, or a combination thereof. For hardware implementation, the processing unit may be implemented in one or more application-specific integrated circuits (Application Specific Integrated Circuits, ASIC), digital signal processors (Digital Signal Processing, DSP), digital signal processing devices (DSP Device, DSPD), programmable logic devices (Programmable Logic Device, PLD), field programmable gate arrays (Field-Programmable Gate Array, FPGA), general-purpose processors, controllers, microcontrollers, microprocessors, and other electronic units configured to perform the functions described in this application, or a combination thereof. For software implementation, the techniques described in this application can be implemented by modules (e.g., processes, functions, etc.) that perform the functions described in this application. Software code may be stored in a memory and executed by a processor. The memory can be implemented in or outside the processor.

Optionally, in another embodiment, the first processor 1903 is further configured to run the computer program to perform the method according to any one of the foregoing embodiments.

In still another embodiment of this application, FIG. 18 shows a schematic structural diagram of a decoder according to an embodiment of this application. As shown in FIG. 18, the decoder 200 may include a second determining unit 2001.

The second determining unit 2001 is configured to: determine a first template corresponding to a current block; determine, according to the first template, one or more block vectors corresponding to the current block; determine one or more reference blocks of the current block according to the one or more block vectors, and determine predicted values of the current block according to the one or more reference blocks; and determine a reconstructed value of the current block according to the predicted value of the current block.

It may be understood that in embodiments, the term “unit” may be a partial circuit, a partial processor, a partial program or software, or the like. Certainly, the term “unit” may be a module or may be in a non-modular form. In addition, component parts in embodiments may be integrated into one processing unit, or each of the units may exist alone physically, or two or more units may be integrated into one unit. The integrated unit may be implemented in a form of hardware, or may be implemented in a form of a software functional module.

When the integrated unit is implemented in the form of a software functional module and not sold or used as an independent product, the integrated unit may be stored in a computer-readable storage medium. Based on such an understanding, an embodiment of this application provides a computer-readable storage medium, applied to a decoder 200. The computer-readable storage medium stores a computer program, and the computer program is executed by a second processor to implement the method according to any one of the foregoing embodiments.

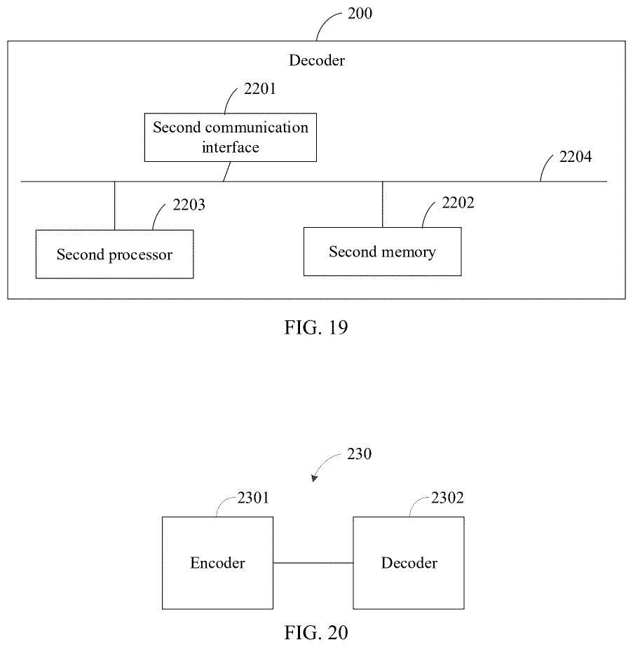

Based on the composition of the decoder 200 and the computer-readable storage medium, FIG. 19 is a schematic diagram of a structure of specific hardware of the decoder 200 according to an embodiment of this application. As shown in FIG. 19, the decoder 200 may include a second communications interface 2201, a second memory 2202, and a second processor 2203. The components are coupled together by using a second bus system 2204. It may be understood that the second bus system 2204 is configured to implement connection and communication between these components. The second bus system 2204 may further include a power bus, a control bus, a status signal bus, and the like, in addition to a data bus. However, for clarity of description, various buses are marked as the second bus system 2204 in FIG. 19.

The second communications interface 2201 is configured to receive and transmit a signal in a process of transmitting and receiving information with another external network element.

The second memory 2202 is configured to store a computer program that is runnable on the first processor 2203.

The second processor 2203 is configured to run the computer program to perform the following operations:
determining a first template corresponding to a current block;
determining, according to the first template, one or more block vectors corresponding to the current block;
determining one or more reference blocks of the current block according to the one or more block vectors, and determining predicted values of the current block according to the one or more reference blocks; and
determining a reconstructed value of the current block according to the predicted value of the current block.

Optionally, in another embodiment, the second processor 2203 is further configured to run the computer program to perform the method in any one of the foregoing embodiments.

It may be understood that a hardware function of the second memory 2202 is similar to that of the first memory 1902, and a hardware function of the second processor 2203 is similar to that of the first processor 1903. Details are not described herein.

Embodiments of this application provide an encoder. The encoder determines a first template corresponding to the current block; determines, according to the first template, one or more block vectors corresponding to the current block; determines one or more reference blocks of the current block according to the one or more block vectors, and determines predicted values of the current block according to the one or more reference blocks; and determines a reconstructed value of the current block according to the predicted value of the current block. The decoder determines a first template corresponding to the current block; determines, according to the first template, one or more block vectors corresponding to the current block; determines one or more reference blocks of the current block according to the one or more block vectors, and determines predicted values of the current block according to the one or more reference blocks. It can be learned that, in embodiments of this application, an Intra TMP Fusion prediction manner is proposed. In which, at least one block vector of the current block may be determined, and the predicted value of the current block may be obtained by using at least one reference block corresponding to the at least one block vector. Therefore, according to the coding method proposed in embodiments of this application, the current block is predicted according to different importance of reconstructed block information corresponding to different matching templates in a search process, so that prediction accuracy can be improved, thereby obtaining an optimal prediction effect.

In still another embodiment of this application, FIG. 20 shows a schematic structural diagram of a coding system according to an embodiment of this application. As shown in FIG. 20, the decode system 230 may include an encoder 2301 and a decoder 2302.

In embodiments of this application, the encoder 2301 may be the encoder in any one of the foregoing embodiments, and the decoder 2302 may be the decoder in any one of the foregoing embodiments.

Further, an embodiment of this application further provides a bitstream, where the bitstream is generated by performing bit encoding on to-be-encoded information. The to-be-encoded information includes at least one of: a prediction difference of the current block, a preset quantity N, or one or more block vectors.

It should be noted that in this application, the terminology “include”, “comprise” or any other variant is intended to cover non-exclusive inclusion, so that a process, a method, an object or an apparatus that includes a series of elements not only includes those elements, but also includes other elements that are not explicitly listed, or includes inherent elements of the process, method, object or apparatus. In the absence of further restrictions, the element limited by the sentence “including a . . . ” does not exclude the existence of other identical elements in the process, method, item or device including this element.

The sequence numbers of the embodiments of this application are only for description, and do not represent superiority or inferiority of the embodiments.

The disclosed methods provided in the several method embodiments of this application may be randomly combined with each other in the case of no conflicts, to obtain new method embodiments.

The disclosed features provided in the several product embodiments of this application may be randomly combined with each other in the case of no conflicts, to obtain new product embodiments.

The disclosed features provided in the several method or device embodiments of this application may be randomly combined with each other in the case of no conflicts, to obtain new method embodiments or device embodiments.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

### INDUSTRIAL APPLICABILITY

Embodiments of this application provides a coding method, an encoder, a decoder, and a storage medium. The encoder determines a first template corresponding to a current block; determines, according to the first template, one or more block vectors corresponding to the current block; determines one or more reference blocks of the current block according to the one or more block vectors, and determines predicted values of the current block according to the one or more reference blocks; and determines a reconstructed value of the current block according to the predicted value of the current block. The decoder determines a first template corresponding to the current block; determines, according to the first template, one or more block vectors corresponding to the current block; determines one or more reference blocks of the current block according to the one or more block vectors, and determines predicted values of the current block according to the one or more reference blocks. It can be learned that, in embodiments of this application, an Intra TMP Fusion prediction manner is proposed. In which, at least one block vector of the current block may be determined, and the predicted value of the current block may be obtained by using at least one reference block corresponding to the at least one block vector. Therefore, according to the coding method proposed in embodiments of this application, the current block is predicted according to different importance of reconstruction block information corresponding to different matching templates in a search process, so that prediction accuracy can be improved, thereby obtaining an optimal prediction effect.

What is claimed is:

1. A decoding method, applied to a decoder, wherein the method comprises:
determining a first template corresponding to a current block; and
determining, according to the first template, one or more block vectors corresponding to the current block;
determining one or more reference blocks of the current block according to the one or more block vectors, and determining predicted values of the current block according to the one or more reference blocks; and
determining reconstructed values of the current block according to the predicted values of the current block.

2. The method according to claim 1, wherein the determining, according to the first template, one or more block vectors corresponding to the current block comprises:
determining a preset search area according to the first template; and
performing a search in the preset search area to determine the one or more block vectors.

3. The method according to claim 2, wherein the performing a search in the preset search area to determine the one or more block vectors comprises:
traversing search points in the preset search area, and determining, according to a preset matching criterion, matching cost values between matching templates corresponding to the search points in the preset search area and the first template; and
determining, according to the matching cost values, the one or more block vectors.

4. The method according to claim 3, wherein the determining, according to the matching cost values, the one or more block vectors comprises:
determining a quantity N of candidate templates, wherein N is an integer greater than 0; and
determining N block vectors according to the matching cost values.

5. The method according to claim 4, wherein the determining N block vectors according to the matching cost values comprises:
determining N minimum matching cost values from the matching cost values between the matching templates corresponding to the search points in the preset search area and the first template; and
determining the N block vectors that correspond to the N minimum matching cost values.

6. The method according to claim 4, wherein the preset matching criterion comprises any one of: sum of absolute difference SAD, sum of absolute transformed difference SATD, sum of squared error SSE, mean absolute derivation MAD, mean absolute error MAE, mean square error MSE, and normalized correlation coefficient NCC.

7. The method according to claim 3, further comprising:
traversing the search points in the preset search area according to a first search step size, and determining the block vectors.

8. The method according to claim 3, further comprising:
traversing the search points in the preset search area according to a first search step size, and determining initial block vectors and initial matching templates corresponding to the initial vector blocks;
determining a first search area according to the initial matching templates, wherein the first search area is less than the preset search area; and
traversing search points in the first search area according to a second search step size, and determining the block vectors, wherein the first search step size is greater than the second search step size.

9. The method according to claim 1, wherein the determining predicted values of the current block according to the one or more reference blocks comprises:
determining one or more weight values corresponding to the one or more reference blocks; and
performing weighted fusion processing on the one or more reference blocks by using the one or more weight values, to determine predicted values of the current block.

10. The method according to claim 9, wherein the determining the one or more weight values corresponding to the one or more reference blocks comprises:
determining the one or more weight values according to one or more candidate templates corresponding to the one or more block vectors.

11. The method according to claim 10, wherein the determining the one or more weight values according to the one or more candidate templates corresponding to the one or more block vectors comprises:
determining, according to sample values in the candidate template, an autocorrelation matrix corresponding to the candidate template;
determining a cross-correlation vector according to sample values in the first template and the sample values in the candidate template; and
determining the weight value according to the autocorrelation matrix and the cross-correlation vector.

12. The method according to claim 10, wherein the determining the one or more weight values according to the one or more candidate templates corresponding to the one or more block vectors comprises:
determining the one or more weight values according to matching cost values between the first template and one or more candidate templates corresponding to the one or more block vectors.

13. The method according to claim 1, wherein the determining the first template corresponding to the current block comprises:
determining a template type corresponding to the current block, and determining the first template corresponding to the current block according to the template type;
wherein the determining the template type corresponding to the current block comprises:
determining the template type of the current block according to a reference sample of the current block,
wherein the reference sample of the current block comprises at least one of: a left adjacent reference sample of the current block, an upper adjacent reference sample of the current block, an upper left adjacent reference sample of the current block, a lower left adjacent reference sample of the current block, and an upper right adjacent reference sample of the current block.

14. An encoding method, applied to an encoder, wherein the method comprises:
determining a first template corresponding to a current block;
determining, according to the first template, one or more block vectors corresponding to the current block; and
determining one or more reference blocks of the current block according to the one or more block vectors, and determining predicted values of the current block according to the one or more reference blocks.

15. The method according to claim 14, wherein the determining, according to the first template, the one or more block vectors corresponding to the current block comprises:
determining a preset search area according to the first template; and
performing a search in the preset search area to determine the one or more block vectors.

16. The method according to claim 14, wherein the performing a search in the preset search area to determine the one or more block vectors comprises:
traversing search points in the preset search area, and determining, according to a preset matching criterion, matching cost values between matching templates corresponding to the search points in the preset search area and the first template; and
determining, according to the matching cost values, the one or more block vectors.

17. The method according to claim 16, wherein the determining, according to the matching cost values, the one or more block vectors comprises:
determining a quantity N of candidate templates, wherein N is an integer greater than 0; and
determining N block vectors according to the matching cost values.

18. The method according to claim 14, wherein the determining predicted values of the current block according to the one or more reference blocks comprises:
determining one or more weight values corresponding to the one or more reference blocks; and
performing weighted fusion processing on the one or more reference blocks by using the one or more weight values, to determine the predicted value of the current block.

19. The method according to claim 18, wherein the determining one or more weight values corresponding to the one or more reference blocks comprises:
determining the one or more weight values according to one or more candidate templates corresponding to the one or more block vectors.

20. A computer readable storage medium storing a bitstream, wherein the bitstream is generated by using an encoding method comprising:
determining a first template corresponding to a current block;
determining, according to the first template, one or more block vectors corresponding to the current block; and
determining one or more reference blocks of the current block according to the one or more block vectors, and determining predicted values of the current block according to the one or more reference blocks.
